(19) United States
(12) Patent Application Publication
(10) Pub. No.: US 2009/0122237 A1
(43) Pub. Date: May 14, 2009

(54) POLYMER FILM, METHOD FOR PRODUCING POLYMER FILM, OPTICAL FILM AND POLARIZING PLATE AND LIQUID CRYSTAL DISPLAY DEVICE USING THE SAME

(75) Inventors: Nobutaka Fukagawa, Kanagawa (JP); Shigeki Uehira, Kanagawa (JP); Yutaka Nozoe, Kanagawa (JP); Mamoru Sakurazawa, Kanagawa (JP); Susumu Sugiyama, Kanagawa (JP); Teruki Niori, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/091,541

(22) PCT Filed: Nov. 2, 2006
(86) PCT No.: PCT/JP2006/322412

§ 371 Date: Apr. 25, 2008

(30) Foreign Application Priority Data
Nov. 7, 2005 (JP) 2005-322295
Feb. 16, 2006 (JP) 2006-039603

(51) Int. Cl. G02F 1/1335; G02B 1/08; B32B 5/16; B29C 55/00

(52) U.S. Cl. 349/96; 359/500; 428/327; 428/326; 264/291

(57) ABSTRACT

A polymer film, which comprises: organic compound fine particles containing a retardation developer and having an average particle size of from 1 nm to 1,000 nm; a method for producing a polymer film, which comprises: casting a dope containing a polymer, a solvent for dissolving the polymer, a retardation developer and an additive other than the retardation developer on a support; peeling off; drying; and stretching, wherein the retardation developer is uniformly dissolved in the dope, and between the casting and the stretching, organic compound fine particles containing the retardation developer are formed within a film; and an optical film, which comprises: at least one compound represented by formula (I) as defined in the specification; and at least one Rth raising agent.

### TECHNICAL FIELD

The present invention relates to a polymer film, to a method for producing a polymer film and to a phase contrast film, a polarizing plate and a liquid crystal display device using the same.

The present invention also relates to an optical film and to a polarizing plate and a liquid crystal display device using the same. More particularly, it relates to an optical film, polarizing plate and liquid crystal display device where depending on viewing angle is little and visibility with high quality is able to be achieved.

### BACKGROUND ART

As a space-saving image display device with little electricity consumptions, use of a liquid crystal display device has been expanding year by year. Up to now, it has been a big disadvantage of a liquid crystal display device that its dependency of image on viewing angle is big but, in recent years, a liquid crystal mode of high viewing angle such as VA mode and IPS mode has been putting to practical use whereby, even in the market where high visual angle is demanded such as television, demand for liquid crystal display device has been rapidly increasing.

As a result, it has been also demanded to express wider range of retardation for optically compensatory film which is used for liquid crystal display device. A method in which retardation is developed in cellulose acylate film and both two functions of polarizing plate-protective film and phase contrast film are bestowed thereon together is able to greatly simplify the manufacturing steps of polarizing plate equipped with optically compensatory film and, therefore, various methods have been investigated.

With regard to a method for bestowing the retardation on cellulose acylate film, there have been known a method where cellulose acylate having a low acetylation degree is used, a method where an organic compound having a specific structure is added, etc. Particularly, the latter method is able to adjust the retardation only by means of adding amount of the additive and, therefore, it has an advantage that films having different retardation are able to be easily prepared separately. In Japanese Patent L aid-Open No. 2003/344,655 A, a method where a discotic compound is added is disclosed while, in Japanese Patent Laid-Open No. 2002/363,343 A, a method where a rod-shaped compound is added is disclosed.

However, although those methods have some effects, addition of much amount is necessary when higher retardation is demanded and it has been difficult that both development of retardation and suppression of bleeding are satisfied. Moreover, in the above-mentioned methods, both in-plane retardation in the film (hereinafter, it will be referred to as Re) and retardation in a thickness direction (hereinafter, it will be referred to as Rth) are developed and there has been a problem that it is difficult to selectively develop one of them.

In Japanese Patent Laid-Open No. 2005/156,864 A, a method where fine particles comprising mineral or ceramic in a specific shape are added to a transparent resin film is disclosed. However, in this method, there is a problem of an increase in the haze of film due to aggregation of the fine particles in the film manufacturing step and improvement therefor has been demanded.

A liquid crystal display device is usually constituted from liquid crystal cell, optically compensatory sheet and polarizer. The optically compensatory sheet is used for solving the coloration of image and for expanding the viewing angle and a stretched double refractive film and a film where liquid crystal is applied onto a transparent film are used therefor. For example, in Japanese Patent No. 3,027,805, there is a disclosure for an art where discotic liquid crystals are applied on a triacetyl cellulose film, aligned and solidified and the resulting optically compensatory sheet is applied to liquid crystal cell of a TN mode so as to expand a viewing angle. However, in a liquid crystal display device to be used for television which is in a big screen and is expected to see from various angles, demand for dependency on viewing angle is very severe and even the above-mentioned means does not satisfy the demand. Therefore, liquid crystal display device in a mode being different from TN mode such as IPS (in-plane switching) mode, OCB (optically compensatory bend) mode and VA (vertically aligned) mode have been studied.

Particularly, VA mode has a high contrast and yield in the manufacture is relatively high and, accordingly, it has been receiving public attention as a liquid crystal display device for TV. However, in the VA mode, although nearly complete black display is possible in the normal line direction of panel, there is a problem that leakage of light is generated when the panel is observed from an oblique direction and viewing angle becomes narrow. In order to solve such a problem, there has been proposed a method where the first phase contrast plate having a positive refractive index anisotropy of nx>ny=nz and the second contrast plate having a negative refractive index anisotropy of nx=ny>nz are used together so as to reduce the leakage of light (e.g., Japanese Patent No. 3,027,805). There has been also proposed a method where optically biaxial phase contrast plate where nx>ny>nz is used whereby viewing angle characteristic of the liquid crystal display device of VA mode is enhanced (e.g., Japanese Patent No. 3,330,574). Here, nx, ny and nz are refractive indexes of the above phase contrast plate in the directions of X axis, Y axis and Z axis, respectively. The direction of X axis is an axial direction showing the highest refractive index in an in-plane direction of the above phase contrast plate, the direction of Y axis is an axial direction which is vertical to the above X axis direction in the above plane and the direction of Z axis is a thickness direction which is vertical to the above mentioned directions of X axis and Y axis.

On the other hand, in each of the liquid crystal systems including IPS system and OCB system, its display system has been enhanced as an increase in consumption of liquid crystal televisions in recent years.

However, in those methods, leakage of light only to some wavelength regions (such as green light near 550 nm) is reduced and no consideration has been done in light leakage in other wavelengths (such as blue light near 450 nm and red light near 650 nm). Therefore, when a black display is done and that is observed from an oblique direction, problems of the so-called color shifts coloring in blue and red have not been solved.

Accordingly, as a means for improving the viewing angle contrast in black display and leakage of light, there has been a demand for optimizing the in-plane slow axis and retardation for blue, green and red lights of optically compensatory films.

### DISCLOSURE OF THE INVENTION

A first object of the present invention is to provide a polymer film having a uniform and high retardation without a surficial trouble such as bleeding.

A second object of the present invention is to provide a polymer film having a high ratio of Rth to Re without a surficial trouble such as bleeding.

A third object of the present invention is to provide a liquid crystal display device having wide viewing angle and high display quality using a polarizing plate in which the above-mentioned polymer film is used.

The present inventors have carried out intensive investigations and, as a result, they have found that a miscible state of polymer and other additives with a retardation developer in the film is a governing factor for the development of retardation. Thus, under such a state that a retardation developer is miscible with polymer and other additive such as a plasticize, development of the retardation developer becomes low while, when a retardation developer is subjected to a phase separation to make into an aggregated state or into fine crystals, developing property of retardation is significantly improved. It has been also found that the above-mentioned aggregated state or an oriented state of retardation developer molecules in fine crystalline state is able to be controlled by the type of the polymer used, by a stretching operation or the like.

Up to now, when a retardation developer having a low miscibility with polymer and other additive such as a plasticizer is added to film, bleeding is generated in the manufacture of the film and step pollution, surficial trouble, etc. have been problems. About that, the present inventors have found that, when a retardation developer having a high solubility in solvent and having a low miscibility with polymer and other additive such as a plasticizer is used and the film after drying the solvent is subjected to a thermal treatment at the temperature of not lower than a glass transition temperature, the retardation developer is able to be effectively subjected to a phase separation in the film without causing a bleeding whereupon the present invention has been achieved.

Thus, the present invention achieving the first to third objects of the invention relates to a polymer film mentioned in the following (1), (2), (11) and (12); to a method for producing the same mentioned in the following (3) to (10); and to a polarizer and a liquid crystal display device mentioned in the following (13) to (15).

(1) A polymer film, which comprises:

organic compound fine particles containing a retardation developer and having an average particle size of from 1 nm to 1,000 nm.

(2) The polymer film as described in (1) above, which is a cellulose acylate film.

(3) A method for producing a polymer film, which comprises:

casting a dope containing a polymer, a solvent for dissolving the polymer, a retardation developer and an additive other than the retardation developer on a support;

peeling off;

drying; and

stretching,

wherein the retardation developer is uniformly dissolved in the dope, and

between the casting and the stretching, organic compound fine particles containing the retardation developer are formed within a film.

(4) The method for producing a polymer film as described in (3) above,

wherein a solubility of the retardation developer with respect to the additive other than the retardation developer at 25° C. is less than 40% by mass.

(5) The method for producing a polymer film as described in (3) or (4) above,

wherein the retardation developer satisfying formula (2) in which ΔTg is expressed by formula (1) is utilized:

ΔTg=(Glass transition temperature (° C.) of polymer film produced without addition of a retardation developer)−(Glass transition temperature (° C.) of polymer film produced by addition of a (% by mass) of a retardation developer) Formula (1)

ΔTg/a<2 Formula (2)

wherein a (% by mass) is the maximum adding amount of the retardation developer when the retardation developer is added to the polymer film within such an extent that haze does not exceed 1.0.

(6) The method for producing a polymer film as described in any one of (3) to (5) above,

wherein a solubility at 25° C. of the retardation developer in the solvent for dissolving the polymer is not less than 1% by mass.

(7) The method for producing a polymer film as described in any one of (3) to (6) above,

wherein the retardation developer shows a liquid crystallinity.

(8) The method for producing a polymer film as described in any one of (3) to (7) above,

wherein the polymer is a cellulose acylate.

(9) The method for producing a polymer film as described in any one of (3) to (8) above,

wherein the polymer is a cellulose acetate where a degree of acetylation is not more than 2.85.

(10) The method for producing a polymer film as described in any one of (3) to (9) above, which comprises, after peeling-off, subjecting the obtained film to a thermal treatment at a temperature of not lower than Tg.

(11) A polymer film, which is produced by a production method as described in any one of (3) to (10) above.

(12) The polymer film as described in (1) or (2) above, which is produced by a production method as described in any one of (3) to (10) above.

(13) A polarizing plate, which comprises:

a polarizer; and

at least two protective films adhered on both sides of the polarizer,

wherein at least one of the at least two protective films is a polymer film as described any one of (1), (2), (11) and (12) above.

(14) The polarizing plate as described in (13) above, which further comprises an optically anisotropic layer at least on one side of the protective film.

(15) A liquid crystals display device, which comprises:

a liquid crystal cell; and

at least two polarizing plates located on both sides of the liquid crystal cell,

wherein at least one of the at least two polarizing plates is a polarizing plate as described in (13) or (14) above.

A fourth object of the present invention is to provide an optical film where a black display is not colored even when observed from an oblique direction and a high display quality is possible and also to provide a polarizing plate and a liquid crystal display device using the same.

The fourth object of the present invention has been achieved by the following means.

(16) An optical film, which comprises:

at least one compound represented by formula (1); and

at least one Rth raising agent:

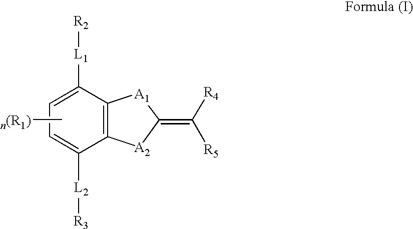

wherein L₁ and L₂ each independently represents a single bond or a divalent connecting group;

A₁ and A₂ each independently represents a group selected from the group consisting of —O—, —NR— in which R represents a hydrogen atom or a substituent, —S— and —CO—;

R₁, R₂, R₃, R₄ and R₅ each independently represents a substituent; and

n represents an integer from 0 to 2.

(17) An optical film, which comprises:

at least one compound represented by formula (1); and

at least one compound selected from the group consisting of compounds represented by formulae (II), (III), (IV) and (V):

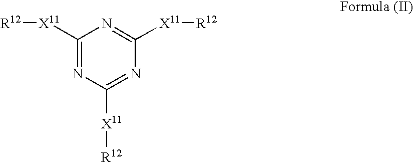

wherein each of R¹²'s independently represents an aromatic ring or a hetero ring having a substituent at least at any of ortho-, meta- and para-positions; and

each of X¹¹'s independently represents a single bond or —NR¹³— in which R¹³ represents a hydrogen atom, a substituted or unsubstituted alkyl group, an alkenyl group, an aryl group or a heterocyclic group:

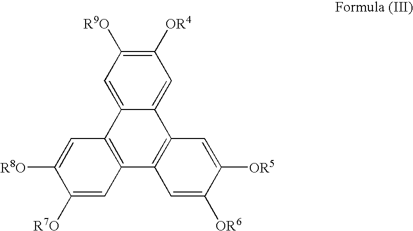

wherein R⁴, R⁵, R⁶, R⁷, R⁸ and R⁹ each independently represents a hydrogen atom or a substituent:

Q⁷¹-Q⁷²-OH Formula (IV)

wherein Q⁷¹ represents a nitrogen-containing aromatic hetero ring; and

Q⁷² represents an aromatic ring:

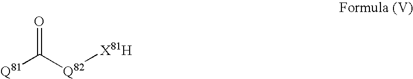

wherein Q⁸¹ and Q⁸² each independently represents an aromatic ring; and

X⁸¹ represents NR⁸¹ in which R⁸¹ represents a hydrogen atom or a substituent, an oxygen atom or a sulfur atom.

(18) The optical film as described in (16) or (17) above,

wherein at least one of the at least one compound represented by formula (1) and the at least one Rth raising agent is a liquid crystal phase at a temperature range of from 100° C. to 300° C.

(19) The optical film as described in any of (16) to (18) above, which satisfies formulae (A) to (D):

0.1<Re(450)/Re(550)<0.95 (A)

1.03<Re(650)/Re(550)<1.93 (B)

0.4<Re/Rth(450))/(Re/Rth(550))<0.95 (C)

1.05<(Re/Rth(650)/(Re/Rth(550))<1.9 (D)

wherein Re (λ) is an in-plane retardation value of the optical film to a light of λ nm wavelength;

Rth (λ) is a retardation value in a thickness direction of the optical film to a light of λ wavelength; and

Re/Rth (λ) is a ratio of an in-plane retardation value to a retardation value in a thickness direction of the optical film to a light of λ wavelength (unit: nm).

(20) The optical film as described in any of (16) to (19) above, which is produced by a method comprising a stretching step of stretching a film and a shrinking step of shrinking a film.

(21) The optical film as described in any of (16) to (20) above, which comprises a cellulose acylate.

(22) The optical film as described in (21) above, wherein an acyl substituent substantially comprises only acetyl group, and a total degree of the substitution is 2.56 to 3.00.

(23) The optical film as described in (21) or (22) above, which satisfies formulae (1) and (II):

2.0≦(DS2+DS3+DS6)≦3.0 Formula (I)

DS6/(DS2+DS3+DS6)≧0.315 Formula (II)

wherein DS2 is a degree of substitution of a hydroxyl group at 2-position of a glucose unit of the cellulose acylate with an acyl group;

DS3 is a degree of substitution of a hydroxyl group at 3-position with an acyl group; and

DS6 is a degree of substitution of a hydroxyl group at 6-position with an acyl group.

(24) The optical film as described in any of (21) to (23) above,

wherein an acyl substituent comprises substantially at least two groups selected from an acetyl group, a propionyl group and a butanoyl group, and a total degree of substitution is 2.50 to 3.00.

(25) A method for producing an optical film as described in any of (16) to (24) above, which comprises:

a stretching step of stretching a film; and

a shrinking step of shrinking a film.

(26) A polarizing plate, which comprises:

a polarization film; and

a pair of protective films sandwiching the polarization film,

wherein at least one of the pair of protective films is an optical film as described in any of (16) to (24) above.

(27) A liquid crystal display device, which comprises an optical film as described in (16) to (24) above or a polarizing plate as described in (26) above.

(28) A liquid crystal display device, which comprises:

a liquid crystal cell; and

a pair of polarizing plates aligned on both sides of the liquid crystal cell,

wherein at least one of the pair of polarizing plates is a polarizing plate as described in (27) above, and

the liquid crystal display device is of IPS, OCB or VA mode.

(29) A liquid crystal display device, which comprises a polarizing plate as described in (27) above on a backlight side, and is of VA mode.

Incidentally, in the present specification, “45°”, “parallel” or “orthogonal” means (precise angle)±(less than 5°). Margin of error is preferably less than 4° and, more preferably, less than 3°. With regard to the angle, “+” means a clockwise direction while “−” means an anti-clockwise direction. “Slow axis” means a direction where the refractive index becomes the highest. “Visible light region” means 380 nm to 780 nm. Unless otherwise mentioned, wavelength for the measurement of refractive index is λ=550 nm which is a visible light region.

Unless otherwise mentioned, “polarizing plate” in the present invention is used including both of a polarized plate in a long size and a polarized plate which is cut into a size which is able to be installed in a liquid crystal display device (in the present invention, the term “to cut” also means “to perforate”, “to cut out”, etc.). Although “polarization film” and “polarizing plate” are used in different meanings, “polarizing plate” shall mean a layered product having a transparent protective film which protects a polarization film at least on one side of the “polarization film”.

In the present specification, Re(λ) and Rth(λ) stand for in-plane retardation and retardation in the film thickness direction at the wavelength of λ, respectively. Re(λ) is measured using an automatic double refractometer such as Kobra 21 ADH (manufactured by Oji Keisoku Kiki K. K.) by incidence of light of λ nm wavelength into a normal line direction of the film. Rth(λ) is calculated by an automatic double refractometer such as Kobra 21ADH on the basis of a retardation value measured in three directions in total, i.e. the above-mentioned Rex, a retardation value measured by incidence of light of wavelength of λ nm from the direction inclined at +40° to the normal line direction of the film using a slow axis (judged by an automatic double refractometer such as Kobra WR) as an inclination axis and a retardation value measured by incidence of light of wavelength of λ nm from the direction inclined at −40° to the normal line direction of the film using a slow axis as an inclination axis.

Here, with regard the presumed value for average refractive index, data in “Polymer Handbook” (John Wiley & Sons, Inc.) and catalogs of various optical films may be used. In case data of average refractive index have not been known, measurement by Abbe's refractometer may be carried out. Data of average refractive index for main optical films will be exemplified as follows: cellulose acylate (1.48), cycloolefin polymer (1.52), polycarbonate (1.59), polymethyl methacrylate (1.49) and polystyrene (1.59).

When the presumed value of the average refractive index as such and film thickness are inputted, nx, ny and nz are calculated by an automatic double refractive index meter such as Kobra 21ADH. From those nx, ny and nz calculated as such, Nz=(nx−Nz)/(nx−ny) is further calculated.

In the optical film according to the present invention, polarized plate using the same and liquid crystal display device being installed therewith, it is now possible to achieve an image having little coloration and high display quality when a black display is seen from an oblique direction.

### BRIEF DESCRIPTION OF THE DRAWING

FIGS. 1A and 1B are examples of the constitution where the polarizing plate of the present invention and a functional optical film are compounded;

FIG. 2 is an example of a liquid crystal display device where the polarizing plate of the present invention is used; and

FIG. 3 is a schematic drawing which shows an example of the liquid crystal display device of the present invention,

wherein 1, 1a, 1b represent protective films; 2 represents a polarizer; 3 represents a functional optical film; 4 represents an adhesive layer; 5 represents a polarizing plate; 6 represents an upper polarizing plate; 7 represents an absorptive axis for upper polarizing plate; 8 represents an upper optically anisotropic layer; 9 represents a controlling direction for alignment of upper optically anisotropic layer; 10 represents an upper electrode substrate for liquid crystal cell; 11 represents a controlling direction for alignment of upper substrate; 12 represents a liquid crystal molecules; 13 represents a lower electrode substrate of liquid crystal cell; 14 represents a controlling direction for alignment of lower substrate; 15 represents a lower optically anisotropic layer; 16 represents a controlling direction for alignment of lower optically anisotropic layer; 17 represents a lower polarizing plate; and 18 represents an absorptive axis for lower polarizing plate

### BEST MODE FOR CARRYING OUT THE INVENTION

The present invention achieving the first to third objects of the invention is described hereafter.

The present invention relates to a polymer film which is characterized in containing fine particles of an organic compound (hereafter also called “organic compound fine particles”) which contain a retardation developer and have an average particle size of from 1 nm to 1,000 nm.

[Formation of Fine Particles of Organic Compound]

In the polymer film of the present invention, it is preferred that, in any of the steps from casting to stretching, fine particles of an organic compound containing a retardation developer are formed in the film. As a result, developing property of any of Re and Rth is able to be selectively improved.

Average particle size of the fine particles of an organic compound contained in the polymer film of the present invention is able to be determined by an observation under a transmission electron microscope. The particle size (corresponding to diameter of circle) is defined as diameter of a circle having the same projected area of the observed particle. One hundred particles are observed in different places and their mean value is defined as an average particle size.

Average particle size of the fine particles of the organic compound contained in the polymer film of the present invention is 1 nm to 1,000 nm, more preferably 3 nm to 300 nm and, most preferably, 10 nm to 100 nm. When the particle size is controlled to such a range, it is now possible to enhance the retardation developing property without an increase in the haze of the film.

Formation of fine particles of the organic compound according to the present invention may be carried out in any of the steps from casting to stretching. When amount of the residual solvent in the steps after peeling is small and diffusion of the retardation developer in the polymer film is restricted, a thermal treatment which will be mentioned later is conducted so that the polymer and the retardation developer are effectively subjected to a phase separation whereby the fine particles is able to be formed.

### <Retardation Developer>

Firstly, a retardation developer used in the present invention will be illustrated.

With regard to the retardation developer of the present invention, there may be used substances having a low miscibility with cellulose acylate, having a low solubility in other additive such as a plasticizer and having a high solubility in a solvent among the compounds mentioned, for example, in Japanese Patent Laid-Open Nos. 2000/111,914 A, 2000/275,434 A, 2001/166,144 A, 2002/090,541 A, 2002/363,343 A and 2003/344,655 A.

Adding amount of the retardation developer of the present invention to the polymer is preferably 0.1 to 30% by mass, more preferably 0.5 to 20% by mass and, particularly preferably, 1 to 10% by mass. When two or more developers are used, it is preferred that their total amount satisfies the above-mentioned range. (In this specification, mass ratio is equal to weight ratio.)

### <Method for Production of Polymer Film>

The polymer film of the present invention is able to be produced by a method for producing a polymer film including steps where a dope containing the polymer, solvent for dissolving the polymer, a retardation developer and an additive other than the retardation developer is cast on a support, peeled off and dried which is characterized in that, in the dope, the retardation developer is uniformly dissolved and, between the steps of casting and stretching, fine particles of an organic compound containing the retardation developer are formed within a film.

Thus, in the above-mentioned production method, a solvent which well dissolves the retardation developer is used as a solvent for dissolving the polymer whereby a uniform dissolving of the retardation developer in a dope is able to be achieved and, on the other hand, as additive or polymer used for the production, that having a low miscibility with the retardation developer is used whereby formation of fine particles of organic compound having a desired particle size containing the retardation developer is able to be achieved.

It is preferred that solubility of the retardation developer of the present invention in a solvent used for dissolving the polymer is in a certain level or higher. That is to achieve a uniform dissolving of the retardation developer in a dope as mentioned already. Solubility of the retardation developer in a solvent used for dissolving the polymer is preferably not less than 1% by mass, more preferably not less than 2% by mass and, most preferably, not less than 5% by mass.

With regard to a solvent for dissolving the polymer, methylene chloride, chloroform, acetone, methyl acetate, methanol, ethanol, n-butanol, toluene and a mixed solvent thereof may be used for example. Preferred one is a mixed solvent of methylene chloride with an alcohol, more preferred one is a mixed solvent of methylene chloride with methanol and the most preferred one is a mixed solvent of methylene chloride with methanol in which their mixing ratio by mass is from 99/1 to 70/30.

When, for example, a mixed solvent of methylene chloride and methanol in a ratio of 87/13 by mass is used as a solvent for dissolving the polymer, solubility at 25° C. of the retardation developer in the above mixed solvent is preferably not less than 1% by mass, more preferably not less than 2% by mass and, most preferably, not less than 5% by mass.

### (Method of Measurement of Solubility—I)

To be more specific, solubility may be able to be calculated by, for example, the following formula based on W1 and W2 obtained by the following procedures 1 to 5. However, in the measurement of the solubility defined by the present specification, it is not limited to the following method but other methods may be used as well.

Solubility=(W2/W1)×100 (%)

1. A retardation developer is added to a test tube and a solvent for dissolving a polymer is added thereto. The test tube is heated using a constant-temperature vessel where the temperature is set at 65° C. and the retardation developer is completely dissolved therein.

2. The above is allowed to stand in a constant-temperature vessel set at 25° C. After separation of crystals is observed by naked eye, it is allowed to stand in a constant-temperature vessel for about one week more.

3. After that, only a solution moiety in the sample is taken out, filtered through a filter and taken in a weighing bottle and weight of the solution is measured (W1 (g)).

4. Then the resulting solution is warmed so that the solvent is evaporated to dryness and weight of the resulting retardation developer is measured (W2 (g)).

5. When boiling point of the solvent is high and is hardly evaporated to dryness, it is also possible that weight of the crystals separated in the above 2 is measured and the resulting value is subtracted from the weight of the initially added retardation developer to give W2 (g).

Further, in a method for the production of the polymer film, it is preferred as a combination of a retardation developer with a polymer to use that in which ΔTg expressed by the following formula (1) satisfies the following relation formula (2).

ΔTg=(Glass transition temperature of polymer film produced without addition of a retardation developer)−(Glass transition temperature of polymer film produced by addition of a % by mass of a retardation developer) Formula (1)

ΔTg/a<2 Formula (2)

In the formulae, a (% by weight) is the maximum adding amount of the retardation developer when the retardation developer is added to a polymer film within such a range that the haze does not exceed 1.0.

More preferably, the value of the left-hand side of the above formula (2) is less than 1 and, most preferably, it is less than 0.5.

A preferred relation between the retardation developer and the polymer expressed by the above formula (2) has been found as a result of intensive investigations in miscibility of the retardation developer with the polymer on the way of thinking that the retardation developer and the polymer uniformly dissolved in the presence of a dope solvent are subjected to a phase separation by evaporation of the solvent.

Tg of the film is able to be determined by measurement of dynamic viscoelasticity. Thus, after a film sample is subjected to a moisture adjustment at 25° C. and 60% relatively humidity for not shorter than 2 hours, measurement is conducted using an apparatus for measurement of dynamic viscoelasticity (Vibron DVA-225 (manufactured by IT Keisoku Seigyo K. K.) where distance between gripped areas is 20 mm, temperature raising speed is 2° C./minute, measuring temperature range is 30° C. to 200° C. and frequency is 1 Hz. The resulting data are plotted where an ordinate is storage elastic modulus in terms of logarithmic axis while an abscissa is temperature (° C.) in terms of linear axis and when a straight line 1 is drawn in a solid region for a quick decrease of storage elastic modulus noted when the storage elastic modulus is transferred from the solid region to the glass transition region while another straight line 2 is drawn in a glass transition region, the crossing point of the straight line 1 and the straight line 2 is defined as a glass transition temperature Tg.

Due to the same reason as mentioned above, it is preferred that solubility of the retardation developer of the present invention with respect to an additive other than the retardation developer is in a certain level or not more than that.

Solubility at 25° C. of the retardation developer of the present invention with respect to an additive other than the retardation developer is preferably 0.01 to 50% by mass, more preferably 0.01 to 30% by mass and, most preferably, 0.01 to 10% by mass.

As to the solubility of the retardation developer with respect to an additive other than the retardation developer, it is also possible to use other methods than the above-mentioned method for measuring the solubility including that.

Particularly with regard to the solubility of a retardation developer in an additive other than the retardation developer, the following method may be also used when the measurement is difficult due to the reason in terms of the measurement.

### (Method for Measurement of Solubility—2)

Thus, a predetermined amount of a retardation developer and an additive other than the retardation developer are dissolved in a solvent such as methylene chloride, dropped onto a glass dry plate and allowed to stand in an atmosphere of 40° C. for 1 hour to evaporate the solvent and then observation is conducted whether crystals of the retardation developer are separated out so that dissolving of said retardation concentration is judged.

In that case, the adding retardation developer is gradually increased and the above operation is carried out for each and, on the basis of the weight of the retardation developer immediately before separation of crystals is observed, solubility is calculated.

<Additive Other than a Retardation Developer>

The additive other than a retardation developer in the present invention means another additive used for the manufacture of said polymer film. Particularly according to the gist of the present invention, other additive other than the above retardation developer preferably means a plasticizer in a particularly high adding amount.

A plasticizer is usually an additive which is used for making the film soft and, in the technical field of the present invention, a phosphate or a phthalate may be used for example.

With regard to the additive used in the present invention other than the retardation developer, the following compounds are used particularly preferably.

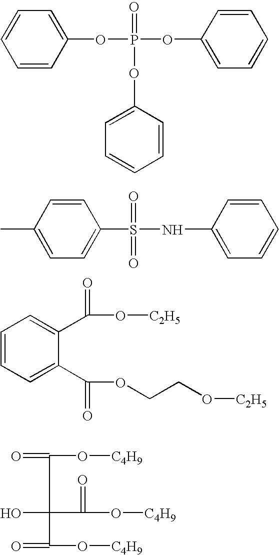

### <Polymers>

With regard to a polymer used for the polymer film of the present invention, norbornene resin, polyethylene terephthalate, polyethylene naphthalate, polycarbonate, polystyrene, polyallylate, polysulfone, cellulose acylate, etc. are able to be used preferably.

Among the above, polymers having both positive intrinsic double refractive component and negative intrinsic double refractive component are particularly preferred since they are easily able to bestow a wavelength dispersing property which becomes small when Re is in shorter wavelength. Here, the positive intrinsic double refractive component means a partial structure in which, when a polymer film is stretched, polarizability anisotropy in a parallel direction to a stretched direction becomes the highest. On the other hand, the positive intrinsic double refractive component means a partial structure in which, when a polymer film is stretched, polarizability anisotropy in a vertical direction to a stretched direction becomes the highest.

Examples of the polymer having both of the above positive intrinsic polarizability component and negative intrinsic polarizability component are cellulose acylate, modified polycarbonates disclosed in Japanese Patent Laid-Open Nos. 2004/062,023 A and 2004/037,837 A, cycloolefin polymers disclosed in Japanese Patent Laid-Open Nos. 2005/010,615 a and 2005/036,201 A and polymers having imide side chain and nitrile side chain disclosed in Japanese Patent Laid-Open No. 2004/004,641 A.

Among them, cellulose acylate is particularly preferred since it is able to easily bestow a close adhesion on polyvinyl alcohol used for a polarizer, has an appropriate water permeating property and is able to be used as a protective film for a polarizing plate as well as a phase contrast film.

As hereunder, cellulose acylate which is preferably used in the present invention will be illustrated in detail.

### [Cellulose Acylate]

Degree of substitution of cellulose acylate means the acylated rate of three hydroxyl groups existing in a constituting unit of cellulose (glucose in a β1→4-glucose bond). The degree of substitution is able to be calculated by measuring the bonded fatty acid amount per unit weight of the constituting unit of cellulose. Method for the measurement is carried out in accordance with ASTM D817-91.

With regard to the cellulose acylate of the present invention, a cellulose acylate where acetylating degree is 2.4 to 2.90 is preferred. The acylating degree is more preferably 2.6 to 2.85.

In another preferred cellulose acylate of the present invention, acylating degree is 2 to 2.9 and it is a mixed fatty acid ester having acetyl group and acyl group where carbon numbers are 3 to 4. The acylating degree is more preferably 2.2 to 2.80 and, most preferably, 2.5 to 2.75. With regard to acetylating degree, it is preferably less than 2.5 and, more preferably, less than 1.9.

When a cellulose acylate having the degree of substitution within the above-mentioned range is used, it is now possible to form fine particles containing a retardation developer without a surficial trouble such as bleeding during the film formation. Thus, when degree of acylation is too low, miscibility between a retardation developer and a cellulose acylate becomes insufficient and bleeding is generated. On the other hand, when it is too high, miscibility between a retardation developer and a cellulose acylate becomes too high whereupon fine particles are hardly formed.

Rate of the acylating degree of 6-position to the total acylating degree is preferably not less than 0.25 and, more preferably, not less than 0.3.

Cellulose acylate used in the present invention is preferred to have a weight-average degree of polymerization of 350 to 800 and, more preferably, to have a weight-average degree of polymerization of 370 to 600. Cellulose acylate used in the present invention is preferred to have a number-average molecular weight of 70,000 to 230,000, more preferably to have a number-average molecular weight of 75,000 to 230,000 and, most preferably, to have a number-average molecular weight of 78,000 to 120,000.

The cellulose acylate used in the present invention is able to be synthesized using an acid anhydride or an acid chloride as an acylating agent. When an acylating agent is an acid anhydride, organic acid (such as acetic acid) or methylene chloride is used as a reaction solvent. As to a catalyst, a protonic catalyst such as sulfuric acid is used. When an acylating agent is an acid chloride, a basic compound is used as a catalyst. In the most common industrial synthetic method, cellulose is esterified with a mixed organic acid component containing an organic acid (such as acetic acid, propionic acid or butyric acid) or an acid anhydride thereof (such as acetic anhydride, propionic anhydride and butyric anhydride) corresponding to an acetyl group and other acyl groups so that cellulose ester is synthesized.

In such a method, there are many cases where cellulose such as cotton linter or wood pulp is subjected to an activating treatment with an organic acid such as acetic acid and then esterified using a mixed solution of the organic components as mentioned above. Generally, the organic acid anhydride component is used in an excessive amount to the amount of hydroxyl group existing in cellulose. In this esterifying treatment, a hydrolyzing reaction (depolymerization reaction) of main chain of cellulose (β1→4-glycoside bond) proceeds in addition to an esterifying reaction. When the hydrolyzing reaction of the main chain proceeds, degree of polymerization of the cellulose ester lowers and properties of the cellulose ester film to be manufactured are deteriorated. Therefore, it is preferred that the reaction condition such as reaction temperature is decided by taking degree of polymerization and molecular weight of the resulting cellulose ester into consideration.

In order to prepare a cellulose ester having a high degree of polymerization (high molecular weight), it is important that the highest temperature in the esterifying reaction step is adjusted to not higher than 50° C. The highest temperature is adjusted preferably to 35 to 50° C. and, more preferably, to 37 to 47° C. When the reaction temperature is 35° C. or higher, the esterifying reaction proceeds smoothly whereby that is preferred. When the reaction temperature is 50° C. or lower, no inconvenience such as lowering of degree of polymerization of cellulose ester happens whereby that is preferred.

When the reaction is stopped together with suppression of a rise in temperature after the esterifying reaction, further lowering of degree of polymerization is able to be suppressed and cellulose ester of high degree of polymerization is able to be synthesized. Thus, when a reaction stopping agent (such as water and acetic acid) is added after completion of the reaction, an excessive acid anhydride which did not participate in the esterifying reaction is hydrolyzed whereby the corresponding organic acid is by-produced. This hydrolyzing reaction is accompanied with a vigorous heat generation and the temperature in the reactor rises. When the adding speed of the reaction stopping agent is not too high, there is no problem such as that a sudden heat generation happens beyond the cooling ability of the reactor whereby the hydrolyzing reaction of the main chain of cellulose significantly proceeds and degree of polymerization of the resulting cellulose ester lowers. During the esterifying reaction, a part of the catalyst is bonded to cellulose and most of it is released from cellulose during the addition of the reaction stopping agent. When the adding speed of the reaction stopping agent is not too high, a sufficient reaction time for releasing the catalyst is ensured and a problem such as that a part of the catalyst remains in a state of being bond to cellulose does not happen. Cellulose ester in which a catalyst which is a strong acid is partly bonded has a very bad stability and is easily decomposed by heating upon drying of the product whereby degree of polymerization lowers. Due to those reasons, it is desirable that, after the esterifying reaction, a reaction stopping agent is added during preferably not shorter than 4 minutes and, more preferably, 4 to 30 minutes to stop the reaction. Incidentally, when the adding time of the reaction stopping agent is 30 minutes or shorter, no problem such as lowering of industrial productivity happens and that is preferred.

With regard to the reaction stopping agent, water or alcohol which decomposes the acid anhydride has been generally used. In the present invention however, a mixture of water with an organic acid is preferably used as a reaction stopping agent so that a triester having a low solubility in various kinds of organic solvents is not separated out. When the esterifying reaction is carried out under the above-mentioned conditions, cellulose ester with a high molecular weight where a weight-average degree of polymerization is not less than 500 is able to be easily synthesized.

### [Ultraviolet Absorber]

The cellulose acylate film of the present invention may contain an ultraviolet (UV) absorber in addition to the above-mentioned retardation developer.

Examples of the ultraviolet absorber are oxybenzophenone compounds, benzotriazole compounds, salicylate compounds, benzophenone compounds, cyanoacrylate compounds and nickel complex compounds in which benzotriazole compounds having little coloration are preferred. The ultraviolet absorbers mentioned in Japanese Patent Laid-Open Nos. 10/182,621 A and 08/337,574 A and high-molecular ultraviolet absorbers mentioned in Japanese Patent Laid-Open No. 06/148,430 A are preferably used as well. When the cellulose acylate film of the present invention is used as a protective film for a polarizing plate, an ultraviolet absorber where absorbing ability for ultraviolet ray of wavelength of not longer than 370 nm is good is preferred in view of prevention of deterioration of polarizer and liquid crystals and, in view of a liquid crystal display property, an ultraviolet absorber where absorption of visible light of wavelength of not shorter that 400 nm is preferred.

Specific examples of the ultraviolet absorbers of a benzotriazole type useful in the present invention are 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl)benzotriazole, 2,2-methylenebis[4-(1,1,3,3-tetramethylbutyl)-6-(2H-benzotriazol-2-yl)phenyl], 2-(2′-hydroxy-3′-tert-butyl-5′-methylphenyl)-5-chlorobenzotriazole, 2-(2H-benzotriazol-2-yl)-6-(linear and branched dodecyl)-4-methylphenol and a mixture of octyl 3-[3-tert-butyl-4-hydroxy-5-(chloro-2H-benzotriazol-2-yl)-phenyl]propionate and 2-ethylhexyl 3-[3-tert-butyl-4-hydroxy-5-(5-chloro-2H-benzotriazol-2-yl)-phenyl] propionate although the present invention is not limited thereto.

Further, commercially available products such as Tinuvin 109, Tinuvin 171, Tinuvin 326 and Tinuvin 328 (all manufactured by Ciba Specialty Chemicals K. K.) are also able to be used preferably.

Adding amount of an ultraviolet absorber to cellulose acylate is preferred to be 0.1% by mass to 10% by mass.

### [Manufacture of Cellulose Acylate Film]

The cellulose acylate film of the present invention is able to be manufactured by a solvent cast method. In the solvent cast method, film is manufactured using a solution (dope) where cellulose acylate is dissolved in an organic solvent.

It is preferred that the organic solvent contains a solvent selected from an ether having 3 to 12 carbon atoms, a ketone having 3 to 12 carbon atoms, an ester having 3 to 12 carbon atoms and a halogenated hydrocarbon having 1 to 6 carbon atom(s).

The ether, ketone and ester may have a cyclic structure. A compound having two or more of any functional group of ether, ketone and ester (i.e., —O—, —CO— and —COO—) may also be used as an organic solvent. The organic solvent may have another functional group such as an alcoholic hydroxyl group. In the case of an organic solvent having two or more kinds of functional groups, carbon atom numbers thereof are preferred to be within the above-mentioned preferred carbon atom number range of the solvent having any functional group.

Examples of the ether having 3 to 12 carbon atoms include diisopropyl ether, dimethoxymethane, dimethoxyethane, 1,4-dioxane, 1,3-dioxolane, tetrahydrofuran, anisole and phenetole.

Examples of the ketone having 3 to 12 carbon atoms include acetone, methyl ethyl ketone, diethyl ketone, diisobutyl ketone, cyclohexanone and methylcyclohexanone.

Examples of the ester having 3 to 12 carbon atoms include ethyl formate, propyl formate, pentyl formate, methyl acetate, ethyl acetate and pentyl acetate.

Examples of the organic solvent having two or more functional groups are 2-ethoxyethyl acetate, 2-methoxyethanol and 2-butoxyethanol.

Carbon atom number(s) of the halogenated hydrocarbon is/are preferred to be 1 or 2 and, most preferably, 1. Halogen of the halogenated hydrocarbon is preferred to be chlorine. Rate of substitution of hydrogen atoms of the halogenated hydrocarbon with halogen is preferably 25 to 75 molar %, more preferably 30 to 70 molar %, still more preferably 35 to 65 molar % and, most preferably, 40 to 60 molar %. Methylene chloride is the representative halogenated hydrocarbon.

Two or more kinds of organic solvents may be mixed and used.

A cellulose acylate solution is able to be prepared by a common method comprising a treatment at the temperature of not lower than 0° C. (ambient temperature or high temperature). Preparation of the solution is able to be conducted using a method and apparatus for the preparation of dope in the conventional solvent cast method. Incidentally, in the case of common method, it is preferred to use halogenated hydrocarbon (particularly, methylene chloride) as an organic solvent.

Amount of cellulose acylate is adjusted so that it is contained in 10 to 40% by mass in the resulting solution. Amount of cellulose acylate is more preferred to be 10 to 30% by mass. In the organic solvent (main solvent), any additive which will be mentioned later may be previously added thereto.

The solution is able to be prepared by stirring of cellulose acylate and an organic solvent at ambient temperature (0 to 40° C.). The solution in a high concentration may be stirred under a pressurized and heated condition. To be more specific, cellulose acylate and organic solvent are placed in a pressurizing container, tightly closed and stirred with heating, with pressurization, within such a range of the temperature of not higher than the boiling point of the solvent at ambient temperature and also the solvent is not boiled. Temperature of the heating is usually not higher than 40° C., preferably 60 to 200° C., and more preferably 80 to 110° C.

Each of the components may be placed in a container after a previous mixing. Alternatively, they may be poured into the container successively. It is necessary that the container is constituted in such a manner that it is able to be stirred. It is possible to pressurize the container by introduction of inert gas such as nitrogen gas. A rise in vapor pressure of the solvent upon heating may be utilized as well. Alternatively, after the container is tightly closed, each of the components may be added under pressurization.

When heating is conducted, it is preferred to heat from outside of the container. For example, a heating apparatus of a jacket type may be used. Alternatively, a whole container is able to be heated by such a means that a plate heater is installed outside the container followed by piping so that the liquid is circulated.

It is preferred that the stirring is conducted using a stirring blade installed in the container. The stirring blade is preferred to be in such a length that it reaches near the wall of the container. At the end of the stirring blade, it is preferred to install a scraping blade for renewal of the liquid film of wall of the container.

The container may be equipped with instruments such as pressure gauge and thermometer. In the container, each component is dissolved in a solvent. The prepared dope is taken out from the container after cooling or, after taking out, it is cooled using a heat exchanger or the like.

It is also possible to prepare the solution by a cooling and dissolving method. In the cooling and dissolving method, cellulose acylate is able to be dissolved even in an organic solvent in which it is unable to be dissolved by a common method. Even in the case of a solvent into which cellulose acylate is able to be dissolved by a common method, there is an advantage that a uniform solution is able to be prepared quickly by means of a cooling and dissolving method.

In a cooling and dissolving method, cellulose acylate is firstly added gradually to an organic solvent at room temperature with stirring. It is preferred that the amount of cellulose acylate is adjusted so as to be contained in 10 to 40% by mass in the mixture. Amount of cellulose acylate is more preferred to be 10 to 30% by mass. Further, any additive which will be mentioned later may be also added in the mixture.

After that, the mixture is cooled at −100 to −10° C. (preferably, −80 to −10° C., more preferably −50 to −20° C. and, most preferably, −50 to −30° C.). Cooling may be conducted, for example, in a dry ice-methanol bath (−75° C.) or in a cooled diethylene glycol solution (−30 to −20° C.). As a result of cooling, a mixture of cellulose acylate and organic solvent is solidified.

Speed for the cooling is preferably not lower than 4° C./minute, more preferably not lower than 8° C./minute and, most preferably, not lower than 12° C./minute. With regard to the cooling speed, the quicker, the better although 10,000° C./minute is the theoretical upper limit, 1,000° C./minute is the technical upper limit and 100° C./minute is the practical limit. Incidentally, a cooling speed is a value obtained by dividing the difference between the temperature when cooling is started and the final cooling temperature by the time from the start of the cooling until reaching the final cooling temperature.

When it is further heated at 0 to 200° C. (preferably 0 to 150° C., more preferably 0 to 120° C. and, most preferably, 0 to 50° C.), cellulose acylate is dissolved in the organic solvent. Raising of the temperature may be done by merely being allowed to stand at room temperature or may be done by heating in a heating bath. Heating speed is preferably not lower than 4° C./minute, more preferably not lower than 8° C./minute and, most preferably, not lower than 12° C./minute. With regard to the heating speed, the quicker, the better although 10,000° C./minute is the theoretical upper limit, 1,000° C./minute is the technical upper limit and 100° C./minute is the practical upper limit. Incidentally, a heating speed is a value obtained by dividing the difference between the temperature when heating is started and the final heating temperature by the time from the start of the heating until reaching the final heating temperature.

As a result of the above, a uniform solution is prepared. Incidentally, when dissolving is insufficient, operations of cooling and heating may be repeated. The fact whether the dissolving is sufficient or not is able to be judged only by observing the appearance of the solution by naked eye.

In a cooling and dissolving method, it is preferred to use a tightly closed container in order to avoid the contamination of moisture due to dew condensation during cooling. When pressurization is conducted during cooling and vacuation is conducted during heating in the cooling and heating operation, time for dissolving is able to be made short. In order to carry out the pressurization and vacuation, it is preferred to use a heat-resisting container.

In a 20% by mass solution of cellulose acetate (degree of acetylation: 60.9%; viscosity-average degree of polymerization: 299) in methyl acetate by means of a cooling and dissolving method, a pseudo phase transition point for sol state and gel state exists at about 33° C. according to the measurement by a differential scanning calorimeter (DSC) and, at the temperature which is not higher than that, a uniform gel state is resulted. Accordingly, it is preferred that this solution is kept at not lower than the pseudo phase transition temperature or, preferably, at the temperature of a gel phase transition temperature plus about 10° C. However, this pseudo phase transition temperature varies depending upon degree of acetylation and viscosity-average degree of polymerization of cellulose acetate, concentration of the solution and an organic solvent used therefor.

A cellulose acetate film is manufactured from the cellulose acylate solution (dope) prepared hereinabove by a solvent cast method. It is preferred that a retardation developer is added to the dope. The dope is cast onto a drum or a band and the solvent is evaporated therefrom to form a film. It is preferred that concentration of the dope before casting is adjusted so as to make the solid amount 18 to 35%. Surface of the drum or the band is preferred to be made into a state of a mirror plane. The dope is preferred to cast onto the drum or band where surficial temperature is not higher than 10° C.

A drying method in a solvent cast method is mentioned in U.S. Pat. Nos. 2,336,310, 2,367,603, 2,492,078, 2,492,977, 2,492,978, 2,607,704, 2,739,069 and 2,739,070, British Patent Nos. 640,731 and 736,892, Japanese Patent Publication Nos. 45/004,554 B and 49/005,614 B and Japanese Patent Laid-Open Nos. 60/176,834 A, 60/203,430 A and 62/115,035 A. Drying on the band or drum is able to be conducted by ventilation of inert gas such as air and nitrogen.

It is also possible that the resulting film is peeled off from the drum or band and dried with a high-temperature air where temperature is successively varied from 100° C. to 160° C. so that the residual solvent is evaporated. Such a method is mentioned in Japanese Patent Publication No. 05/017,844 B. According to the method as such, time from casting to peeling is able to be made short. In carrying out this method, it is necessary that the dope is made into gel at the surficial temperature of the drum or band upon casting.

It is also possible that casting of two or more layers is conducted using a prepared cellulose acylate solution (dope). In that case, it is preferred to prepare a cellulose acylate film by a solvent cast method. The dope is cast on the drum or band and the solvent is evaporated to form a film. It is preferred that concentration of the dope before casting is adjusted so as to make the solid amount 10 to 40% by mass. Surface of the drum or the band is preferred to be made into a state of a mirror plane.

In the casting of plural cellulose acylate solutions in two or more layers, it is possible that plural cellulose acylate solutions are cast and it is also possible that each of the solutions containing cellulose acylate is cast from plural casting openings installed with intervals in the moving direction of the support followed by layering to form a film. For example, methods mentioned in Japanese Patent Laid-Open Nos. 61/158,414 A, 01/122,491 A and 11/198,285 A may be used. It is also possible that cellulose acylate solutions are cast from two casting openings to prepare a film. For example, methods mentioned in Japanese Patent Publication No. 60/027,562 B and Japanese Patent Laid-Open Nos. 61/094,724 A, 61/947,245 A, 61/104,813 A, 61/158,413 A and 06/134,933 A may be used. It is further possible to use a casting method for cellulose acylate film mentioned in Japanese Patent Laid-Open No. 56/162,617 A that flow of a highly viscous cellulose acylate solution is enclosed with a lowly viscous cellulose acylate solution and the highly and lowly viscous cellulose acylate solutions are extruded at the same time.

It is furthermore possible that two casting openings are used and a film formed on a support by the first casting opening is peeled off and the second casting is conducted to the side adjacent to the support surface whereupon a film is prepared. For example, a method mentioned in Japanese Patent Publication No. 44/020,235 B may be exemplified.

With regard to the cellulose acylate solutions to be cast, the same one may be used or different cellulose acylate solution may be used. In order to give functions to plural cellulose acylate layers, a cellulose acylate solution corresponding to the function is extruded from each casting opening. It is also possible that the cellulose acylate solution of the present invention is cast together with other functional layers (such as adhesive layer, dye layer, antistatic layer, anti-halation layer, ultraviolet absorptive layer or polarization layer).

In the conventional single layer solution, it is necessary for giving film of a necessary thickness to extrude a cellulose acylate solution of high concentration and high viscosity. In that case, there have been many cases where problems have happened that stability of the cellulose acylate solution is bad to generate solid causing trouble of the product or making the planar property poor. When plural cellulose acylate solutions are cast from casting openings as a means for solving the above problems, the outcome is not only that highly viscous solutions are able to be extruded onto a support at the same time whereby planar property becomes good and film having an excellent surficial property is able to be prepared but also that reduction of drying load is able to be achieved by the use of concentrated cellulose acylate solutions whereby production speed of the film is able to be enhanced.

A preventer for deterioration (such as antioxidant, decomposing agent for peroxides, radical forbidding agent, inactivating agent for metals, acid scavenger and amine) may also be added to the cellulose acylate film. Preventers for deterioration are mentioned in Japanese Patent Laid-Open Nos. 03/199,201 A, 05/1,907,073 A, 05/194,789 A, 05/271,471 A and 06/107,854 A. Adding amount of the deterioration preventer to the solution (dope) to be prepared is preferably 0.01 to 1% by mass and, more preferably, 0.01 to 0.2% by mass. When the adding amount is less than 0.01% by mass, it is preferred since the effect of the deterioration preventer is well achieved while, when the adding amount is less than 1% by mass, it is preferred since bleeding (oozing-out) of the deterioration preventer onto the surface of the film is hardly resulted. Examples of the particularly preferred preventers for deterioration are butylated hydroxytoluene (BHT) and tribenzylamine (TBA).

Those steps from casting and after-drying may be carried out in an atmosphere of air or in an atmosphere of inert gas such as nitrogen gas. With regard to a rolling machine used for the manufacture of the cellulose acylate film of the present invention, commonly-used ones may be used and it is possible to roll by a rolling method such as a constant tension method, a constant torque method, a taper tension method and a programmed tension control method where the inner tension is constant.

### [Thermal Treatment]

In the production method for the polymer film of the present invention, it is preferred to conduct a thermal treatment after peeling so that the polymer and the retardation developer are subjected to a phase separation and formation of fine particles is efficiently carried out. Temperature for the thermal treatment is preferably from (Tg−10° C.) to (Tg+60° C.) and, more preferably, from (Tg+10° C.) to (Tg+40° C.). When a thermal treatment is carried out within the above temperature range, it is possible to adjust to the particle size by which scattering of the retardation developer causes practically no problem and also to convey the film in a stable manner in the manufacture of the film in a rolled form.

The thermal treatment of the present invention may be carried out in any of the steps provided that it is done after peeling and, if it is done in the following stretching step, alignment of the retardation developer is able to be effectively controlled and that is preferred.

### [Stretching Treatment]

The polymer film of the present invention is preferred to be that which is subjected to a stretching treatment. As a result of the stretching treatment, alignment of the retardation developer is able to be effectively controlled and a desired retardation is able to be bestowed on the polymer film. Stretching direction of the polymer film may be any of a width direction and a longitudinal direction.

Methods for stretching in a width direction are mentioned, for example, in Japanese Patent Laid-Open Nos. 62/115,035 A, 04/152,125 A, 04/284,211 A, 04/298,310 A and 11/048,271 A.

Stretching temperature of the film is preferably from (Tg−10° C.) to (Tg+60° C.) and, more preferably, from (Tg+10° C.) to (Tg+40° C.).

When the retardation developer is a liquid crystal compound, it is preferred that stretching is carried out at not lower than the transition temperature between the states of crystals and liquid crystals of the retardation developer and that the film is held at a constant stretching rate until the transition temperature between crystals and liquid crystals is resulted whereby tension to the film is maintained. When the film is stretched under the above-mentioned condition, it is now possible to enhance the orientation degree of the retardation developer and to achieve a high retardation developing efficiency.

In the case of stretching in the longitudinal direction, the film is stretched when, for example, the speed of the conveying roller for the film is adjusted so as to make the rolling speed of the film quicker than the peeling speed of the film. In the case of stretching in the width direction, the film is able to be stretched by such a means that, for example, conveyance is done where width of the film is held by a tenter and the width of the tenter is gradually made wide. It is also possible to stretch using a stretching machine after drying of the film (preferably by a uniaxial stretching using a long stretching machine).

Stretching rate of the film (elongation rate to the film before stretching) is preferably from 3% to 200% and, more preferably, from 5% to 150%.

<Various Properties of Polymer Film>

### [Retardation of Film]

In the present specification, Re_{λ} and Rth_{λ} stand for in-plane retardation and retardation in the thickness direction at the wavelength of λ, respectively. Re_{λ} is measured using an automatic double refractometer such as Kobra WR (manufactured by Oji Keisoku Kiki K. K.) by incidence of light of λ nm wavelength into a normal line direction of the film. Rth_{λ} is calculated by an automatic double refractometer such as Kobra WR on the basis of a retardation value measured in three directions in total, i.e. the above-mentioned Rex, a retardation value measured by incidence of light of wavelength of λ nm from the direction inclined at +40° to the normal line direction of the film using a slow axis (judged by an automatic double refractometer such as Kobra WR) as an inclination axis (rotation axis) and a retardation value measured by incidence of light of wavelength of λ nm from the direction inclined at −40° to the normal line direction of the film using a slow axis as an inclination axis (rotation axis).

Here, with regard the presumed value for average refractive index, data in “Polymer Handbook” (John Wiley & Sons, Inc.) and catalogs of various optical films may be used. In case data of average refractive index have not been known, measurement by Abbe's refractometer may be carried out.

Data of average refractive index for main optical films will be exemplified as follows.

Thus, cellulose acylate (1.48), cycloolefin polymer (1.52), polycarbonate (1.59), polymethyl methacrylate (1.49) and polystyrene (1.59). When the presumed value of the average refractive index as such and film thickness are inputted, nₓ (refractive index in the direction of film production), n_{y} (refractive index in the width direction) and n_{z} (refractive index in the thickness direction) are calculated by Kobra WR.

It is preferred that retardation of the polymer film of the present invention satisfies the following relations of (1) to (2).

0 nm<Re(589)<150 nm (1)

50 nm<Rth(589)<400 nm (2)

The formulae (1) and (2) are more preferably expressed by the following formulae.

10 nm<Re(589)<135 nm

80 nm<Rth(589)<350 nm

When retardation characteristics of the polymer film are controlled within the above-mentioned range, it is possible to prepare a phase contrast film in which changes in contrast by visual angle and compensation effect to changes in tint in the liquid crystal display device are big.

In a mode for OCB and a mode for TN, an optically anisotropic layer is applied on a polymer film having the above-mentioned retardation values and the product is able to be used as an optically-compensatory film.

### [Thickness of Polymer Film]

Thickness of the polymer film of the present invention is preferably from 10 Jim to 200 μm, more preferably from 20 μm to 150 μm and, most preferably, from 30 μm to 100 μm.

### [Moisture Content of Polymer Film]

Moisture content of the polymer film is able to be evaluated by measurement of an equilibrium moisture content at predetermined temperature and humidity. The equilibrium moisture content is calculated by such a manner that the film is allowed to stand for 24 hours under predetermined temperature and humidity, water amount of the sample reaching the equilibrium is measured by a Karl-Fischer method and the water amount (g) is divided by sample weight (g).

The moisture content of the polymer film of the present invention at 25° C. and 80% RH is preferably not more than 5.0% by mass, more preferably not more than 4.3% by mass and, most preferably, not more than 3.8% by mass.

### [Moisture Transmittance]

Moisture transmittance is calculated in accordance with the method mentioned in JIS Z-0208 by the following manner that moisture transmittance of each sample is measured and calculated as a water amount (g) evaporated per 1 m² area during 24 hours. Moisture transmittance is a film characteristic which is closely related to durability of the polarizing plate and, when moisture transmittance is lowered, durability of polarizing plate is able to be improved. In the polymer film of the present invention, moisture transmittance at 60° C. and 95% RH within 24 hours is preferably from 200 g/m² to 1,700 g/m² and, more preferably, from 500 g/m² to 1,400 g/m².

### [Optical Elasticity of Polymer Film]

Optical elasticity coefficient of the polymer film of the present invention is preferably not more than 60×10⁻⁸ cm²/N and, more preferably, 20×10⁻⁸ cm².

### <Polarizing Plate>

### [Constitution of Polarizing Plate]

Firstly, protective film and polarizer constituting the polarizing plate of the present invention will be illustrated.

The polarizing plate of the present invention may have an adhesive layer, a separate film or a protective film as a constituting element other than polarizing plate and protective film.

(1) Protective Film

The polarizing plate of the present invention has each one protective film on both sides of a polarizer whereby being two in total. The protective film for a polarizing plate is preferably a polymer film manufactured from norbornene resin, polyethylene terephthalate, polyethylene naphthalate, polycarbonate, polystyrene, polyallylate, polysulfone, cellulose acylate, etc.

Among the above, cellulose acylate film is particularly preferred since it is able to easily bestow a closely adhesive property to polyvinyl alcohol used for a polarizer and also has an appropriate moisture transmittance. When the polarizing plate of the present invention is used for a liquid crystal display device, it is preferred that at least one of the two polarizing plates aligned on both sides of liquid cell is the polarizing plate of the present invention.

### [Saponifying Treatment]

When the cellulose acylate film of the present invention is subjected to a saponifying treatment with alkali to bestow a closely adhering property to polyvinyl alcohol, it is able to be used as a protective film for a polarizing plate.

It is preferred that a saponifying treatment of the cellulose acylate film with alkali is carried out in such a cycle that surface of the film is dipped in an alkali solution, neutralized with an acidic solution, washed and dried. Examples of the alkali solution are a potassium hydroxide solution and a sodium hydroxide solution. Concentration of a hydroxide ion is preferably within a range of 0.1 to 5.0 mol/L and, more preferably, within a range of 0.5 to 4.0 mol/L. Temperature of the alkali solution is preferably within a range of room temperature to 90° C. and, more preferably, within a range of 40 to 70° C.

### (2) Polarizer

Although the polarizer used in the present invention is preferred to be constituted from polyvinyl alcohol (PVA) and a dichromatic molecule, it is also possible that, as mentioned in Japanese Patent Laid-Open No. 11/248,937 A, polyvinyl chloride is dehydrated and dechlorinated and a polarizer of a polyvinylene type prepared by alignment of the resulting polyene structure is used.

PVA is a polymer material prepared by saponification of polyvinyl acetate and it may further contain a component which is able to be copolymerized with vinyl acetate such as unsaturated carboxylic acid, unsaturated sulfonic acid, olefins and vinyl ethers. It is also possible to use a modified PVA containing acetoacetyl group, sulfonic acid group, carboxyl group, oxyalkylene group, etc.

Although there is no particular limitation for the degree of saponification of PVA, it is preferably 80 to 100 molar % and, particularly preferably, 90 to 100 molar % in view of solubility, etc. Although there is no particular limitation for the degree of polymerization of PVA, it is preferably 1,000 to 10,000 and, particularly preferably, 1,500 to 5,000.

As mentioned in Japanese Patent No. 2,978,219, syndiotacticity of PVA is preferably not less than 55% in order to improve the durability although 45 to 52.5% mentioned in Japanese Patent No. 3,317,494 may be preferably used as well.

It is preferred that, after PVA is made into a film, a dichromatic molecule is introduced therein to constitute a polarizer. With regard to a method for the manufacture of PVA film, a method where an original liquid in which PVA resin is dissolved in water or an organic solvent is stretched to give a film is usually used preferably. Concentration of the resin of a polyvinyl alcohol type in the original liquid is usually 5 to 20% by weight and, when the original liquid is made into a film by a stretching method, a PVA film having a film thickness of 10 to 20 μm is able to be manufactured. Manufacture of the PVA film is able to be carried out by referring to Japanese Patent No. 3,342,516 and Japanese Patent Laid-Open Nos. 09/328,593 A, 2001/302,817 A and 2002/144,401 A.

Although there is no particular limitation for the degree of crystallization of the PVA film, it is possible to use a PVA film of an average degree of crystallization (X_{c}) of 50 to 75% by mass mentioned in Japanese Patent No. 3,251,073 or to use a PVA film of degree of crystallization of not higher than 38% mentioned in Japanese Patent Laid-Open No. 2002/236,214 A for reducing the in-plane imbalance of color phase.

With regard to double refraction (Δn) of the PVA film, it is preferred to be small and a PVA film where double refraction is not higher than 1.0×10⁻³ mentioned in Japanese Patent No. 3,342,516 may be used preferably. It is also possible that, as mentioned in Japanese Patent Laid-Open No. 2002/228,835 A, double refraction of the PVA film is made 0.02 to 0.01 so as to achieve a high polarizing degree together with avoiding the breakage of the PVA film upon stretching and it is also possible that, as mentioned in Japanese Patent Laid-Open No. 2002/060,505 A, the value of (nₓ+n_{y})/2−n_{z} is made 0.0003 to 0.01. Retardation (in-plane) of the PVA film is preferably 0 nm to 100 nm and, more preferably, 0 nm to 50 nm. Rth (in the direction of film thickness) of the PVA film is preferably 0 nm to 500 nm and, more preferably, 0 nm to 300 nm.

In addition to the above, the polarizing plate of the present invention is also able to preferably use a PVA film where a 1,2-glycol bonding amount is not more than 1.5 molar % as mentioned in Japanese Patent No. 3,021,494; a PVA film where optical foreign substances of not smaller than 5 μm are contained not more than 500 part 100 cm² as mentioned in Japanese Patent Laid-Open No. 2001/316,492 A; a PVA film where hot water breakage temperature spot in the TD direction of the film is not more than 1.5° C. as mentioned in Japanese Patent Laid-Open No. 2002/030,163 A; and a PVA film containing 1 to 100 part(s) by mass of tri- to hexahydric alcohol such as glycerol or a PVA film formed from a solution where a plasticizer mentioned in Japanese Patent Laid-Open No. 06/289,225 A is contained in not less than 15% by mass.

Although there is no particular limitation for the film thickness of a PVA film before stretching, it is preferably 1 μm to 1 mm and, particularly preferably, 20 to 200 μm in view of stability of holding the film and of homogeneity of stretching. It is also possible to use a thin PVA film where tension generated in stretching in water from 4- to 6-fold is not more than 10N as mentioned in Japanese Patent Laid-Open No. 2002/236,212 A.

With regard to the dichromatic molecule, a dichromatic dye or iodine ion of higher order such as I₃⁻ and I₅⁻ may be used particularly preferably. In the present invention, iodine ion of a higher order is used particularly preferably. As mentioned in “Application of Polarizing Plate” edited by Ryo Nagata (CMC Shuppan) and Kogyo Zairyo, vol. 28, no. 7, pages 39 to 45, the iodine ion of a higher order is able to be produced in a state of being adsorbed with and aligned to PVA by dipping of PVA with a solution where iodine is dissolved in an aqueous solution of potassium iodide or and/or with an aqueous solution of boric acid.

When a dichromatic dye is used as the dichromatic molecule, dye of an azo type is preferred and dyes of a bisazo type and a trisazo type are particularly preferred. With regard to the dichromatic dye, a water-soluble one is preferred. For such a purpose a hydrophilic substituent group such as sulfonic acid group, amino group or hydroxyl group is introduced into a dichromatic dye and the dye as a free acid or as a salt such as alkali metal salt, ammonium salt or amine salt is preferably used.

Specific examples of the dichromatic dye as such are that of a benzidine type such as C. I. Direct Red 37, Congo Red (C. I. Direct Red 28), C. I. Direct Violet 12, C. I. Direct Blue 90, C. I. Direct Blue 22, C. I. Direct Blue 1, C. I. Direct Blue 151 and C. I. Direct Green 1; that of a diphenylurea type such as C. I. Direct Yellow 44, C. I. Direct Red 23 and C. I. Direct Red 79; that of a stilbene type such as C. I. Direct Yellow 12; that of a dinaphthylamine type such as C. I. Direct Red 31; and that of a J acid type such as C. I. Direct Red 81, C. I. Direct Violet 9 and C. I. Direct Blue 78.

Besides the above, it is also preferred to use C. I. Direct Yellow 8, C. I. Direct Yellow 28, C. I. Direct Yellow 86, C. I. Direct Yellow 87, C. I. Direct Yellow 142, C. I. Direct Orange 26, C. I. Direct Orange 39, C. I. Direct Orange 72, C. I. Direct Orange 106, C. I. Direct Orange 107, C. I. Direct Red 2, C. I. Direct Red 39, C. I. Direct Red 83, C. I. Direct Red 89, C. I. Direct Red 240, C. I. Direct Red 242, C. I. Direct Red 247, C. I. Direct Violet 48, C. I. Direct Violet 51, C. I. Direct Violet 98, C. I. Direct Blue 15, C. I. Direct Blue 67, C. I. Direct Blue 71, C. I. Direct Blue 98, C. I. Direct Blue 168, C. I. Direct Blue 202, C. I. Direct Blue 236, C. I. Direct 249, C. I. Direct Blue 270, C. I. Direct Green 59, C. I. Direct Green 85, C. I. Direct Brown 44, C. I. Direct Brown 106, C. I. Direct Brown 195, C. I. Direct Brown 210, C. I. Direct Brown 223, C. I. Direct Brown 224, C. I. Direct Black 1, C. I. Direct Black 17, C. I. Direct Black 19, C. I. Direct Black 54, etc. and dichromatic dyes mentioned in Japanese Patent Laid-Open Nos. 62/070,802 A, 01/161,202 A, 01/172,906 A, 01/172,907 A, 01/183,602 A, 01/248,105 A, 01/265,105 A and 07/261,024 A as well. In order to manufacture dichromatic molecules having various kinds of hue, two or more of those dichromatic dyes may be compounded. When a dichromatic dye is used, adsorbed thickness may be 4 μm or more as mentioned in Japanese Patent Laid-Open No. 2002/082,222 A.

Content of the above-mentioned dichromatic molecule to the polyvinyl alcohol polymer constituting the matrix of the film is usually adjusted to a range of 0.01% by mass to 5% by mass. When the content of the dichromatic molecule is more than said lower limit, a good polarization degree is achieved and, when it is less than said upper limit, trouble such as lowering of transmittance of single plate does not happen whereby that is preferred.

Film thickness of the polarizer is preferably 5 μm to 40 μm and, more preferably, 10 μm to 30 μm. It is also preferred that the ratio of the thickness of the polarizer to the thickness of the protective film which will be mentioned later is made as follows as mentioned in Japanese Patent Laid-Open 2002/174,727 A.

0.1≦D_{A}(film thickness of polarizer)/D_{B}(film thickness of protective film)≦0.16

Although a crossing angle of the slow axis of the protective film to the absorptive axis of the polarizer may be any value, it is preferred to be parallel or an azimuth angle of 45±20°.

### [Manufacturing Steps For Polarizing Plate]

Now the steps for the manufacture of the polarizing plate of the present invention will be illustrated.

Steps for the manufacture of the polarizing plate in the present invention are preferred to be constituted from a swelling step for PVA film, a dyeing step, a film hardening step, a stretching step, a drying step, an adhering step for protective film and a drying step after adhesion. Order of the dyeing step, the film hardening step and the stretching step may be changed freely and some steps may be combined and conducted at the same time. Further, as mentioned in Japanese Patent No. 3,331,615, washing with water after the film hardening step may be preferably carried out.

In the present invention, it is particularly preferred that a swelling step for PVA film, a dyeing step, a film hardening step, a stretching step, a drying step, an adhering step for protective film and a drying step after adhesion are successively carried out in the order mentioned here. It is also possible to conduct a step for on-line test of surficial state during or after the above steps.

Although the swelling step of PVA film is preferred to be conducted by water only, it is also possible that, as mentioned in Japanese Patent Laid-Open 10/153,709 A, a polarizer substrate is swollen by an aqueous solution of boric acid in order to stabilize the optical properties and to avoid the generation of wrinkles in polarizer substrate in the manufacturing line whereby the degree of swelling of the polarizer substrate is able to be controlled.

Although temperature and time for the swelling step may be freely set, it is preferred to be at 10° C. to 60° C. for 5 seconds to 2,000 seconds.

A dyeing step for PVA film may use a method mentioned in Japanese Patent Laid-Open No. 2002/086,554 A. With regard to a dyeing method, not only dipping but also any means such as application or spraying of iodine or a dye solution may be used. It is also possible that, as mentioned in Japanese Patent Laid-Open No. 2002/290,025 A, dyeing is carried out together with concentration of iodine, temperature of dyeing bath, stretching degree in the bath and stirring of the bath solution in the bath.

When iodine ion of a higher order is used as a dichromatic molecule, it is preferred in a dyeing step to use a solution where iodine is dissolved in an aqueous solution of potassium iodide in order to prepare a high-contrast polarizing plate. In that case, a preferred range for iodine in the iodine-aqueous potassium iodide solution is 0.05 to 20 g/L and, more preferably, 0.5 to 2 g/L; and for mass ratio of iodine:potassium iodide, it is 1:1 to 2,000 and, more preferably, 1:30 to 120. Time for dyeing is preferably 10 to 1,200 seconds and, more preferably, 30 to 600 seconds while temperature of liquid is preferably 10 to 60° C. and, more preferably, 20 to 50° C.

It is also possible that, as mentioned in Japanese Patent No. 3,145,747, a boron compound such as boric acid or borax is added to a dyeing liquid.

In the film hardening process for PVA film, it is preferred that PVA film is dipped in a solution of a cross-linking agent or that a solution of a cross-linking agent is applied to said film so that the cross-linking agent is contained therein. It is further possible that, as mentioned in Japanese Patent Laid-Open No. 11/052,130 A, the film hardening step may be conducted separately in several times.

With regard to a cross-linking agent, that which is mentioned in U.S. Reissue Pat. No. 232,897 may be used. Although it is possible that, as mentioned in Japanese Patent No. 3,357,109, a polyvalent aldehyde may be used as a cross-linking agent for improving the dimensional stability, boric acids are most preferably used. When boric acid is used as a cross-linking agent in a film hardening step, metal ion may be added to an aqueous solution of potassium iodide-boric acid. With regard to the metal ion, zinc chloride is preferred and it is also possible to use a zinc halide such as zinc iodide and a zinc salt such as zinc sulfate and zinc acetate instead of zinc chloride.

In the present invention, it is preferably carried out that aqueous solution of potassium iodide-boric acid to which zinc chloride is added is prepared and then PVA film is dipped thereinto to conduct hardening of the film. Boric acid is preferably 1 to 100 g/L and, more preferably, 10 to 80 g/L; potassium iodide is preferably 1 to 120 g/L and, more preferably, 5 to 100 g/L; zinc chloride is preferably 0.01 to 10 g/L and, more preferably 0.02 to 8 g/L; time for hardening the film is preferably 10 to 1,200 seconds and, more preferably 30 to 600 seconds; and temperature of the liquid is preferably 10 to 60° C. and, more preferably 20 to 50° C.

With regard to a stretching step for PVA film, a longitudinal uniaxial stretching method mentioned, for example, in U.S. Pat. No. 2,454,515 or a tenter method mentioned in Japanese Patent Laid-Open No. 2002/086,554 A may be preferably used. Preferred stretching magnification is 2-fold to 12-fold and, more preferably, 3-fold to 10-fold. With regard to the relation among stretching magnification, original thickness and polarizer thickness, it may be preferred to make as follows as mentioned in Japanese Patent Laid-Open No. 2002/040,256 A.

(Polarizer film thickness after adhesion of protective film/Original film thickness)×(Total stretching magnification)>0.17

With regard to the relation between the width of polarizer upon coming out from the final bath and the width of polarizer upon adhesion of protective film, it is may be preferred to make as follows as mentioned in Japanese Patent Laid-Open No. 2002/040,247 A.

0.80≦(Polarizer width upon adhesion of protective film)/(Polarizer width upon coming out from the final bath).

With regard to a drying step for PVA film, a method which has been known by Japanese Patent Laid-Open No. 2002/086,554 A may be used where the preferred temperature range is 30° C. to 100° C. and the preferred drying time is 30 seconds to 60 minutes. It is also able to preferably adopt a method where thermal treatment is conducted so that a color fading temperature in water (temperature for complete fading when temperature is raised at a constant speed in a state of being dipped in water) is made 50° C. or higher as mentioned in Japanese Patent No. 3,148,513 or a method where aging is carried out in an atmosphere where humidity and temperature are controlled as mentioned in Japanese Patent Laid-Open No. 07/325,215 A.

A step for adhesion of protective film is a step where both sides of the above-mentioned polarizer coming out from a drying step are adhered with two sheets of protective film. A method where an adhesive solution is supplied immediately before adhesion and adhesion is conducted using a pair of rolls so as to layer the polarizer and the protective film is preferably used. It is also preferred that, as mentioned in Japanese Patent Laid-Open Nos. 2001/296,426 A and 2002/086,554 A, moisture content of the polarizer upon adhesion is adjusted so that groovy unevenness of the record caused by stretching of a polarizer is suppressed. In the present invention, moisture content of 0.1% by mass to 30% by mass is preferably used.

Although there is no particular limitation for an adhesive for the polarizer and the protective film, resin of a PVA type (including PVA modified with acetoacetyl group, sulfonic acid group, carboxyl group, oxyalkylene group, etc.) and an aqueous solution of boron compound are exemplified and, among them, resin of a PVA type is preferred. Thickness of the adhesive layer after drying is preferably 0.01 to 5 μm and, particularly preferably, 0.05 to 3 μm.

It is also carried out preferably that the protective film is subjected to a surficial treatment to make hydrophilic and is then adhered to enhance the adhesive force between the polarizer and the protective film. Although there is no particular limitation for a method of surficial treatment, publicly known methods such as a method where saponification is conducted using an alkali solution and a corona treating method may be used. It is also possible to form an easily adhering layer such as a gelatin undercoat layer after the surficial treatment. As mentioned in Japanese Patent Laid-Open No. 2002/267,839 A, a contact angle to water of surface of the protective film is not more than 50°.

Condition for the drying after the adhesion follows a method mentioned in Japanese Patent Laid-Open No. 2002/086,554 A and the preferred temperature range is 30° C. to 100° C. and the preferred drying time is 30 seconds to 60 minutes. It is also preferred to conduct an aging in an atmosphere where temperature and humidity are controlled as mentioned in Japanese Patent Laid-Open No. 07/325,220 A.

Contents of elements in the polarizer are preferred to be 0.1 to 3.0 g/m² of iodine, 0.1 t0 5.0 g/m² of boron, 0.1 to 2.00 g/m² of potassium and 0 to 2.00 g/m² of zinc. With regard to the content of potassium, it may be 0.2% by mass or less as mentioned in Japanese Patent Laid-Open No. 2001/166,143 A and, with regard to the content of zinc in a polarizer, it may be made 0.04% by mass to 0.5% by mass as mentioned in Japanese Patent Laid-Open No. 2000/045,512 A.

As mentioned in Japanese Patent No. 3,323,255, it is also possible that, in order to enhance the dimensional stability of the polarizing plate, an organotitanium compound and/or an organozirconium compound are/is added and used in any of the dyeing step, the stretching step and the film hardening step so that at least one compound selected from an organotitanium compound and an organozirconium compound is contained therein. It is also possible to add a dichromatic dye to adjust the hue of the polarizing plate.

### [Characteristics of Polarizing Plate]

(1) Transmittance and Polarization Degree

Preferred transmittance of single board of the polarizing plate of the present invention defined by the following formula (3) is 42.5% to 49.5% and, more preferably, 42.8% to 49.0%. Preferred range of the polarization degree defined by the following formula (4) is 99.900% to 99.999% and, more preferably, 99.940% to 99.995%. Preferred range of the parallel transmittance is 36% to 42% and preferred range of the orthogonal transmittance is 0.001% to 0.05%. Preferred range of the dichromatic ratio defined by the following formula (5) is 48 to 1,215 and, more preferably, 53 to 525.

The above-mentioned transmittance is defined by the following formula (3) on the basis of JIS Z-8710.

T=K∫S(λ)y(λ)τ(λ)dλ Formula (3)

In the formula, K, S(λ), y(λ) and τ(λ) are as follows.

$$K = \frac{100}{\int S ( λ ) y ( λ ) d λ}$$

S(λ): spectral distribution of standard light used for indication of color

y(λ): isochromatic function in XYZ color model (CIE 1931 color model)

τ(λ): spectral transmittance

Polarization degree of the polarizing plate of the present invention is defined by the following formula (4).

Polarizing degree (%)=100×√[(Parallel transmittance)−(Orthogonal transmittance)]/[(Parallel transmittance)+(Orthogonal transmittance)] Formula (4)

A dichromatic ratio (Rd) of the polarizing plate of the present invention is defined by the following formula (5).

Dichromatic ratio (Rd)={log [((Single plate transmittance)/100)(1−((Polarization degree)/100))]}/{log [((Single plate transmittance)/100)(1+((Polarization degree)/100))]} Formula (5)

Concentration of iodine and single plate transmittance may be within a range which is mentioned in Japanese Patent Laid-Open No. 2002/258,051 A.

Dependency of parallel transmittance on wavelength may be little as mentioned in Japanese Patent Laid-Open Nos. 2001/083,328 A and 2002/022,950 A. Optical characteristics when a polarizing plate is aligned in a cross nicol may be within a range as mentioned in Japanese Patent Laid-Open No. 2001/091,736 A and the relation between parallel transmittance and orthogonal transmittance may be within a range as mentioned in Japanese Patent Laid-Open No. 2002/174,728 A.

As mentioned in Japanese Patent Laid-Open No. 2002/221,618 A, standard deviation of parallel transmittance every 10 nm when wavelength of light is within 420 to 700 nm may be 3 or less and the minimum value of (parallel transmittance/orthogonal transmittance) every 10 nm when wavelength of light is within 420 to 720 nm may be 300 or more.

It may be also preferably carried out that parallel transmittance and orthogonal transmittance of polarizing plate at 440 nm wavelength, parallel transmittance and orthogonal transmittance thereof at 550 nm wavelength and parallel transmittance and orthogonal transmittance thereof at 610 μm wavelength are made within a range as mentioned in Japanese Patent Laid-Open Nos. 2002/258,042 A and 2002/258,043 A.

### (2) Hue

Hue of the polarizing plate of the present invention is preferably evaluated using a lightness index L* and chromaticness indexes a* and b* in a L*a*b* color model which has been recommended as a CIE uniform sensory space.

L*, a* and b* are defined by the formula (6) using X, Y and Z in the above-mentioned XYZ color model.

$${L}^{*} = 116 {( Y \text{/} {Y}_{0} )}^{\frac{1}{3}} - 16 \\ {a}^{*} = 500 [ {( x \text{/} {x}_{0} )}^{\frac{1}{3}} - {( Y \text{/} {Y}_{0} )}^{\frac{1}{3}} ] \\ {b}^{*} = 200 [ {( Y \text{/} {Y}_{0} )}^{\frac{1}{3}} - {( Z \text{/} {Z}_{0} )}^{\frac{1}{3}} ] \qquad Formula ( 6 )$$

In the formulae, X₀, Y₀ and Z₀ are three stimulus values of illumination light source and, in the case of standard light C, X₀=98.072, Y₀=100 and Z₀=118.225 while, in the case of standard light D, X₀=95.045, Y₀=100 and Z₀=108.892.

Preferred range of a* of a single polarizing plate is −2.5 to 0.2 and, more preferably, −2.0 to 0. Preferred range of b* of a single polarizing plate is 1.5 to 5 and, more preferably, 2 to 4.5. Preferred range of a* of parallel transmitted light of two polarizing plates is −4.0 to 0 and, more preferably, −3.5 to −0.5. Preferred range of b* of parallel transmitted light of two polarizing plates is 2.0 to 8 and, more preferably, 2.5 to 7. Preferred range of a* of orthogonal transmitted light of two polarizing plates is −0.5 to 1.0 and, more preferably, 0 to 2. Preferred range of b* of orthogonal transmitted light of two polarizing plates is −2.0 to 2 and, more preferably, −1.5 to 0.5.

Hue may also be evaluated by chromaticity coordinates (x, y) calculated from the above-mentioned X, Y and Z. For example, it may be preferably done that chromaticity (xₚ, yₚ) of parallel transmitted light and chromaticity (x_{c}, y_{c}) of orthogonal transmitted light of two polarizing plates are made within a range mentioned in Japanese Patent Laid-Open Nos. 2002/214,436 A, 2001/166,136 A and 2002/169,024 A and that the relation between hue and absorbance is made within a range mentioned in Japanese Patent Laid-Open No. 2001/311,827 A.

### (3) Visual Angle Characteristics

When polarizing plate is placed in a cross nicol and light of incidence of 550 nm wavelength is applied, it is also preferred that transmittance ratio and xy chromaticity are made within a range mentioned in Japanese Patent Laid-Open Nos. 2001/166,135 and 2001/166,137 in incidence of a vertical light and in incidence at the angle of 40° to a normal line from the direction of 45° to a polarizing axis. It is also preferred that the ratio of T₆₀/T₀ of a layered polarizing plates subjected to a cross nicol arrangement where T₀ is a light transmittance in a vertical direction while T₆₀ is a light transmittance in a direction of 60° inclination from a normal line of the layered product is made not more than 10,000 as mentioned in Japanese Patent Laid-Open No. 10/068,817 A; that, when natural light is introduced into a polarizing plate in any angle within a normal line and an angle of elevation of up to 80°, difference in transmission of the transmitted light within a wavelength region of 20 nm for a wavelength range of 520 to 640 nm of the transmission spectrum is made not more than 6% as mentioned in Japanese Patent Laid-Open No. 2002/139,625 A; and that difference in luminance of the transmitted light at any place on the film being apart 1 m as mentioned in Japanese Patent Laid-Open No. 08/248,201 A is made within 30%.

### (4) Durability

(4-1) Durability Against Humid Heat

As mentioned in Japanese Patent Laid-Open No. 2001/116,922 A, when being allowed to stand in an atmosphere of 60° C. and 90% RH for 500 hours, a changing rate of light transmittance and polarization before and after that is preferred to be not more than 3% on the basis of the absolute value. Particularly, changes in light transmission are preferred to be not more than 2% and changes in polarization are preferably to be not more than 1.0% and, more preferably, not more than 0.1% on the basis of the absolute value. As mentioned in Japanese Patent Laid-Open No. 07/077,608 A, it is also preferred that polarization and single plate transmittance after being allowed to stand at 80° C. and 90% RH for 500 hours are not less than 95% and not less than 38%, respectively.

(4-2) Dry Durability

It is also preferred that changing rates in light transmittance and in polarization after being allowed to stand at 80° C. and a dry atmosphere for 500 hours are not less than 3% on the basis of the absolute value. It is particularly preferred that a changing rate in light transmittance is not more than 2% and that a changing rate in polarization on the basis of the absolute value is not more than 1.0% and, still more preferably, not more than 0.1%.

(4-3) Other Durability

It is also able to be preferably carried out that, as mentioned in Japanese Patent Laid-Open No. 06167,611 A, shrinking rate after being allowed to stand at 80° C. for 2 hours is made not more than 0.5%; x value and y value of chromaticity after the layered polarizing plates subjected to a cross nicol alignment on both sides of a glass plate are allowed to stand at the atmosphere of 69° C. for 750 hours are made within a range mentioned in Japanese Patent Laid-Open No. 10/068,818 A; and changes in spectral intensity ratio at 105 cm⁻¹ and 157 cm⁻¹ by a Raman spectroscopy after being allowed to stand in an atmosphere of 80° C. and 90% RH for 200 hours are made within a range as mentioned in Japanese Patent Laid-Open Nos. 08/094,834 A and 09/197,127 A.

### (5) Degree of Alignment

In PVA, although the higher the degree of alignment, the better polarizing property, it is a preferred range that the order parameter value calculated by means of a polarizing Raman scattering, a polarization FT-I, etc. is 0.2 to 1.0. It is also able to be preferably carried out that, as mentioned in Japanese Patent Laid-Open No. 59/133,509 A, difference between aligning coefficient of high-molecular segment in all non-crystalline regions of polarizer and aligning coefficient of dye molecule (not more than 0.75) is made at least 0.15 and that, as mentioned in Japanese Patent Laid-Open No. 04/204,907 A, aligning coefficient of non-crystalline region of a polarizer is made 0.65 to 0.85 or degree of alignment of iodine of higher order such as I₃⁻ and I₅⁻ is made 0.8 to 1.0 as an order parameter value.

### (6) Other Characteristics

It is also able to be preferably carried out that, as mentioned in Japanese Patent Laid-Open No. 2002/006,133 A, shrinking force in the absorptive axis direction per unit width when heated at 80° C. for 30 minutes is made not more than 4.0 N/cm; that, as mentioned in Japanese Patent Laid-Open No. 2002/236,213 A, both size changing rates in the absorptive axis direction and the polarizing axis direction of the polarizing plate when the polarizing plate is allowed to stand in a heating condition of 70° C. for 120 hours are made not more than ±0.6%; and that, as mentioned in Japanese Patent Laid-Open 2002/090,546 A, moisture content of the polarizing plate is made not more than 3% by mass. It is further possible to preferably carry out that, as mentioned in Japanese Patent Laid-Open No. 2000/249,832 A, surface roughness in the vertical direction to a stretching axis on the basis of average roughness of central line is made not more than 0.04 μm; that, as mentioned in Japanese Patent Laid-Open No. 10/268,294 A, refractive index no in the transmitting axis direction is made more than 1.6; and that the relation between thickness of the polarizing plate and thickness of the protective film is made within the range as mentioned in Japanese Patent Laid-Open No. 10/111,411 A.

### [Functionalization of Polarizing Plate]

The polarizing plate of the present invention is able to be used preferably as functionalized polarizing plate compounded with the things such as a film for expanding the viewing angle of an LCD, a phase contrast film such as λ/4 plate for applying to an LCD of a reflective type, a reflection-preventive film for enhancing the visibility of display, a film where luminance is enhanced and an optical film having functional layers such as hard-coated layer, forward scattering layer and anti-glare layer.

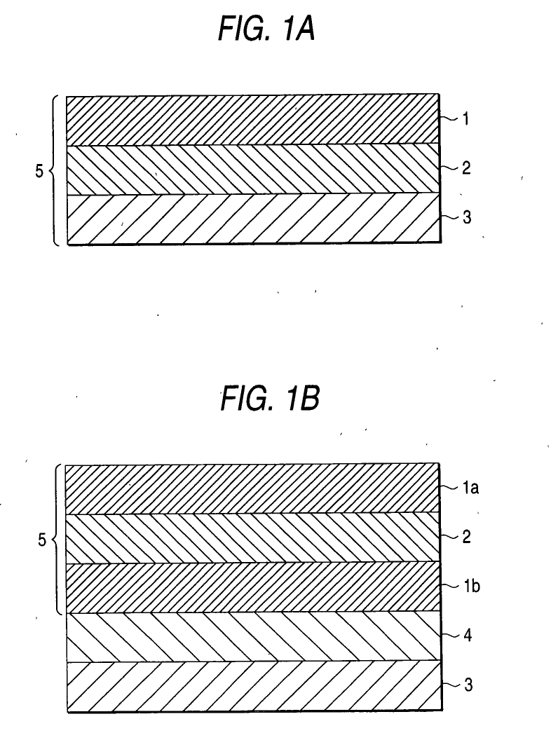

Examples of the constitution where the polarizing plate of the present invention is compounded with the above-mentioned functional optical film are shown in FIGS. 1A and 1B.

As a protective film on one side of the polarizing plate 5, a functional optical film 3 may be adhered to a polarizer 2 via an adhesive layer (not shown) (FIG. 1A) or a functional optical film 3 may be adhered via an adhesive layer 4 on a polarizing plate 5 where protective films 1a, 1b are formed on both sides of the polarizer 2 (FIG. 1B). In the former case, it is also preferred that any protective film is used as one of the protective films 1 and, with regard to another sandwiching the polarizer 2, an optical functional layer is adhered to the cellulose acylate film of the present invention via an adhesive layer to give a constitution of FIG. 1A as a functional optical film 3. It is also preferred that the peeling strength between various layers such as functional layer and protective layer is made not less than 4.0 N/25 mm as mentioned in Japanese Patent Laid-Open No. 2002/311,238 A. It is preferably carried out that the functional optical film is aligned at the liquid crystal module side or at the opposite side, i.e. at the display side or a backlight side depending upon the aimed function.

Now, a functional optical film which is used by compounding with the polarizing plate of the present invention will be illustrated.

### (1) Film for Expanding the Viewing Angle

The polarizing plate of the present invention is able to be used in combination with a film for expansion of viewing angle which has been proposed for a display mode such as TN (twisted nematic), IPS (in-plate sandwiching), OCB (optically compensatory bend), VA (vertically aligned) and ECB (electrically controlled birefringence).

With regard to a film for expansion of viewing angle for TN mode, a WV film (manufactured by Fuji Photo Film) mentioned, for example, in Nippon Insatsu Gassaishi, vol. 36, no. 3 (1999) pages 40-44, Gekkan Display, issue of August (2002), pages 20 to 24 and Japanese Patent Laid-Open Nos. 04/229,828 A, 06/075,115 A, 06/214,116 A and 08/050,206 A may be preferably combined and used.

Preferred constitution of the film for TN mode where viewing angle is expanded is that, on a transparent polymer film, an aligned layer and an optically anisotropic layer are placed in this order. Although the film where viewing angle is expanded may be adhered to a polarizing plate via an adhesive, it is particularly preferred to be also used as one of the protective film for the above-mentioned polarizer in view of making the product thin as mentioned in “SID '00 Dig.”, page 551 (2000).

An orientation layer is able to be formed by a means such as a rubbing treatment of an organic compound (preferably, a polymer), an oblique vapor deposition of an inorganic compound and formation of a layer having microgrooves. It has been also known of an aligned layer where an aligning function is achieved by bestowing of electric field, bestowing of magnetic field or irradiation of light and an aligning layer formed by a rubbing treatment of a polymer is particularly preferred. The rubbing treatment is able to be preferably carried out by rubbing the surface of a polymer layer with paper or cloth in a predetermined direction for several times. It is preferred that the absorptive axis direction of the polarizer and the rubbing direction are substantially in parallel. With regard to the type of the polymer used for the aligning layer, polyimide, polyvinyl alcohol, polymer having a polymerizing group mentioned in Japanese Patent Laid-Open No. 09/152,509 A, etc. may be preferably used. Thickness of the aligning layer is preferably 0.01 to 5 μM and, more preferably, 0.05 to 2 μm.

The optically anisotropic layer is preferred to have a liquid crystalline compound. The liquid crystalline compound used in the present invention is particularly preferred to have a discotic compound (discotic liquid crystal). Discotic liquid crystal molecule has a disk-shaped core part like a triphenylene derivative and has such a structure that side chains are radically extended therefrom. It is also preferably carried out that a group which reacts by heat, light, etc. is further introduced thereinto so as to bestow stability with lapse of time. Preferred examples of the above-mentioned discotic liquid crystal are mentioned in Japanese Patent Laid-Open No. 08/050,206 A.

Examples of the discotic liquid crystal molecule are as follows.

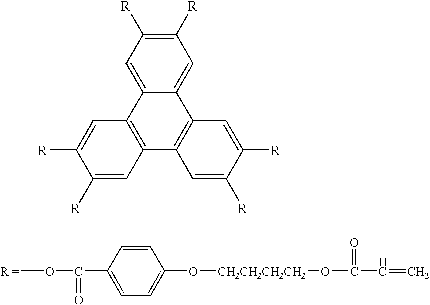

Near an aligning layer, discotic liquid crystal molecules are aligned nearly in parallel to the film surface with a pre-tilted angle in a rubbing direction while, on the opposite air side, the discotic liquid crystal molecules are aligned in a standing-up state nearly vertically to the surface. The discotic liquid crystal layer has a hybrid alignment as a whole and, due to the layer structure as such, expansion of viewing angle of TFT-LCD of a TN mode is able to be achieved.

The above optically anisotropic layer is able to be usually prepared in such a manner that a discotic compound and other compound (and, further, polymerizable monomer, optical polymerization initiator, etc.) are dissolved in a solvent and the resulting solution is applied on an aligning layer, dried, heated up to the temperature by which a discotic nematic phase is able to be formed, polymerized by irradiation of ultraviolet ray or the like and cooled. Temperature for transfer from discotic nematic liquid crystal phase to solid phase of the discotic liquid crystalline compound used in the present invention is preferably 70 to 300° C. and, particularly preferably, 70 to 170° C.

With regard to a compound other than a discotic compound to be added to the above-mentioned optically anisotropic layer, any compound may be used so far as it is miscible with a discotic compound and is able to give a preferred change in inclination angle to a liquid crystalline discotic compound or does not inhibit the alignment. Examples thereof are an additive for control of alignment at the side of interface with air such as a polymerizable monomer (a compound having vinyl group, vinyloxy group, acryloyl group, methacryloyl group, etc.) and a fluorine-containing triazine compound and a polymer such as cellulose acetate, cellulose acetate propionate, hydroxypropyl cellulose and cellulose acetate butyrate. Usually, such a compound is used in an adding amount of 0.1 to 50% by mass and, preferably, 0.1 to 30% by mass to the discotic compound.

Thickness of the optically anisotropic layer is preferably 0.1 to 10 μm and, more preferably, 0.5 to 5 μm.

Preferred embodiment of the film having an expanded viewing angle is that which is constituted of a cellulose acylate film as a transparent substrate film, an aligning layer formed thereon and an optically anisotropic layer comprising discotic liquid crystals formed on said aligning layer in which the optically anisotropic layer is cross-linked by irradiation of ultraviolet ray.

Besides the above, it is also able to be preferably carried out in combining the film having an expanded viewing angle with the polarizing plate of the present invention that, for example, it is layered to a phase contrast plate showing anisotropy to double refractivity having an optical axis in the crossing direction to the plate surface as mentioned in Japanese Patent Laid-Open No. 07/198,942 A or that size changing rates of the protective film and the optically anisotropic layer are made substantially same as shown in Japanese Patent Laid-Open No. 12/258,632 A. It is further able to be preferably carried out that moisture content of the polarizing plate adhered to the film having an expanded viewing angle is made not more than 2.4% as shown in Japanese Patent Laid-Open No. 12/258,632 A or that angle of contact with water on the film having expanded visual field angle is made not more than 70° as mentioned in Japanese Patent Laid-Open No. 2002/267,839 A.

Film having an expanded viewing angle for an IPS mode liquid crystal cell is used for enhancing an optical compensation of liquid crystal molecules aligned in parallel to the substrate surface and viewing angle characteristic of orthogonal transmittance of the polarizing plate in a stage of black display at the state to where no electric field is applied. In an IPS mode, display becomes black under a state where no electric field is applied and transmitting axes of a pair of upper and lower polarizing plates are orthogonally crossed. However, when observation is carried out from an oblique side, the crossing angle of the transmitting axes is not 90° and leakage of light is resulted whereby the contrast lowers. When the polarizing plate of the present invention is used for a liquid crystal cell of an IPS mode, it is used preferably by combining with a film having an expanded viewing angle where phase contrast in the plane is near 0 and phase contrast is available in the thickness direction for decreasing the leaked light as mentioned in Japanese Patent Laid-Open No. 10/054,982 A.

When a film having an expanded viewing angle for liquid cell of an OCB type is aligned to a vertical way at the central part of liquid crystal layer when electric field is applied and is used for conducting an optical compensation of liquid crystal layer obliquely aligned near the substrate interface and for improving the viewing angle characteristic of black display. When the polarizing plate of the present invention is used for liquid crystal cell of an OCB mode, the discotic liquid crystal compound mentioned in U.S. Pat. No. 5,805,253 is preferably used by combining with a film having an expanded viewing angle and being subjected to a hybrid orientation.

A film having an expanded viewing angle for liquid crystal of a VA mode improves the viewing angle characteristic of black display in such a state that liquid crystal molecules are vertically aligned to the substrate plate where no electric field is applied. With regard to a film having an expanded viewing angle as such, that which is mentioned in Japanese Patent No. 2,866,372 such as a film where in-plane phase contrast is near 0 and phase contrast is available in the thickness direction, a film where discotic compounds are aligned in parallel to the substrate, a film where a stretched film having the same in-plane retardation value is layered to as to make the slow axis orthogonal or a film composed of a rod-shaped compound such as liquid crystal molecule for prevention of deterioration of orthogonal transmission in an oblique direction of polarized plate is preferably used by layering followed by combining.

### (2) Phase Contrast Film

It is preferred that the polarizing plate of the present invention has a phase contrast layer. With regard to the phase contrast layer in the present invention, a λ/4 plate is preferred and, when the polarizing plate of the present invention is layered with the λ/4 plate, it is able to be used as a circular polarizing plate. The circular polarizing plate has a function that the light of incidence is converted to a circular polarized light and is preferably used as a liquid crystal display device of a reflection type, a liquid crystal display device of a semi-transparent type, an organic EL element, etc.

The λ/4 plate used in the present invention is preferred to be a phase contrast film having a retardation (Re) of about ¼ of wavelength within a range of wavelength of visible light in order to achieve a nearly complete circular polarization within a range of visible light wavelength. The term “retardation of about ¼ of wavelength within a range of wavelength of visible light” means a range which satisfies the relation that, at the wavelength of 400 to 700 nm, retardation is bigger as the wavelength is longer, a retardation value measured at the wavelength of 450 nm (Re₄₅₀) is 80 to 125 nm and the retardation value measured at the wavelength of 590 nm (Re₅₉₀ is 120 to 160 nm. Re₅₉₀−Re₄₅₀ is more preferably not less than 5 nm and, particularly preferably, not less than 10 nm.

There is no particular limitation for the λ/4 plate used in the present invention so far as it satisfies the above conditions and there may be used known λ/4 plates such as, for example, λ/4 plates where plural polymer films are layered as mentioned in Japanese Patent Laid-Open Nos. 05/027,118 A, 10/068,816 A and 10/090,521 A; λ/4 plates where one polymer film is stretched as mentioned in WO 00/65384 and WO 00/26705; and λ/4 plates where at least one optically anisotropic layer is formed on a polymer film as mentioned in Japanese Patent Laid-Open Nos. 2000/284,126 A and 2002/031,717 A. It is also possible that the direction of a slow axis of polymer film and the aligning direction of optically anisotropic layer may be aligned in any direction depending upon the liquid crystal cell.

In a circular polarizing plate, although a slow axis of λ/4 plate and a transmitting axis of the above-mentioned polarizer may be crossed in any angle, it is preferred to be crossed within a range of 45°±20°. However, the slow axis of λ/4 plate and the transmitting axis of the above-mentioned polarizer may be crossed in an angle other than the above-mentioned range.

When λ/4 plate is constituted by layering of λ/4 plate and λ/2 plate, it is preferred that adhesion is conducted so as to make the angle between an in-plane slow axis of λ/4 plate and λ/2 plate and a transmitting axis of the polarizing plate substantially 75° and 15°, respectively, as mentioned in Japanese Patent No. 3,236,304 and Japanese Patent Laid-Open No. 10/068,816 A.

### (3) Antireflection Film

The polarizing plate of the present invention is able to be used by combining with a antireflection film. With regard to the antireflection film, any of a film which has a reflectivity of about 1.5% where only a single layer of a material having a low refractive index such as a fluorine polymer is applied or a film which has a reflectivity of not more than 1% where a multilayer interference of thin films is able to be utilized.

In the present invention, a constitution where a low refractive index layer and at least one layer having higher refractive index than a low refractive index layer (i.e., high refractive index layer and middle refractive index layer) are layered is preferably used. A reflection preventive film mentioned, for example, in Nitto Giho, vol. 38, no. 1 (issued of May) (2000), pages 26 to 28 and Japanese Patent Laid-Open No. 2002/301,783 A may be preferably used as well.

Refractive index in each layer satisfies the following relations.

(Refractive index of high refractive index layer)>(Refractive index of middle refractive index layer)>(Refractive index of transparent support)>(Refractive index of low refractive index layer)

With regard to a transparent support used for the antireflection film, a polymer film used as a protective film for the above polarizer may be preferably used.

### (Low Refractive Index Layer)

Refractive index of a low refractive index layer is 1.20 to 1.55 and, preferably, 1.30 to 1.50. The low refractive index layer is preferred to be used as an outermost layer having an anti-scratching property and a pollution preventive property. In order to enhance the anti-scratching property, it is also conducted preferably that a material having silicone group or fluorine is used to bestow a lubricity on the surface.

With regard to the fluorine-containing compound, a compound mentioned, for example, in paragraphs [0018] to [0026] of Japanese Patent Laid-Open No. 09/222,503 A, paragraphs [0019] to [0030] of Japanese Patent Laid-Open No. 11/038,202 A, paragraphs to [0028] of Japanese Patent Laid-Open No. 2001/040,284 A and Japanese Patent Laid-Open No. 2000/284,102 A may be preferably used.

With regard to the silicone-containing compound, although a compound having a polysiloxane structure is preferred, it is also possible to use a reactive silicone [such as “Silaplane” (manufactured by Chisso K. K.)], polysiloxane having silanol groups at both ends (Japanese Patent Laid-Open No. 11/258,403 A), etc. It is further possible that a silane coupling agent, etc. such as a silane coupling agent containing a specific fluorine-containing hydrocarbon group and an organometallic compound are hardened by a condensation reaction in the presence of a catalyst (compounds mentioned, for example, in Japanese Patent Laid-Open Nos. 58/142,958 A, 58/147,483 A, 147,484 A, 09/157,582 A, 11/106,704 A, 2000/117,902 A, 2001/048,590 A and 2002/053,804 A).

As an additive other than the above-mentioned ones, the low refractive index layer may also preferably contain a low refractive index inorganic compound having a primary average particle size of 1 to 150 nm such as a filler (e.g., silicon dioxide (silica) and fluorine-containing particles (magnesium fluoride, calcium fluoride and barium fluoride), organic fine particles mentioned in paragraphs [0020] to [0038] of Japanese Patent Laid-Open No. 11/003,820 A, a silane coupling agent, a lubricant, a surfactant, etc.

Although a low refractive index layer may be formed by a gas phase method (such as vacuum vapor deposition method, sputtering method, ion plating method and plasma CVD method), it is preferred to be formed by an application method in view of being able to be manufactured at a low cost. With regard to a method for application, a dip coat method, an air knife coat method, a curtain coat method, a roller coat method, a wire bar coat method, a gravure coat method and a micro gravure method may be used preferably.

Film thickness of the low refractive index layer is preferably 30 to 200 nm, more preferably 50 to 150 nm and, most preferably, 60 to 120 nm.

### (Middle Refractive Index Layer and High Refractive Index Layer)

It is preferred that a middle refractive index layer and a high refractive index layer are made in such a constitution that superfine particles of an inorganic compound having a high refractive index where an average particle size is not more than 100 nm is dispersed in a material for matrix. With regard to an inorganic compound of a high refractive index in fine particles, an inorganic compound where refractive index is not less than 1.65 such as oxides of Ti, Zn, Sb, Sn, Zr, Ce, Ta, La and In as well as compounded oxides containing the metal atom as such may be preferably used.

Such superfine particles may be used in such an embodiment that particle surface is treated with a surface treating agent (such as a silane coupling agent mentioned in Japanese Patent Laid-Open Nos. 11/295,503 A, 11/153,703 A and 2000/009,908 A and an anionic compound or an organometallic coupling agent mentioned in Japanese Patent Laid-Open No. 2001/166,104 A), that core-shell structure where highly refractive particles comprise a core is formed (such as Japanese Patent Laid-Open No. 2001/310,432 A), that a specific dispersing agent is used together (such as Japanese Patent Laid-Open No. 11/153,704 A, U.S. Pat. No. 6,210,858 and Japanese Patent Laid-Open No. 2002/2,776,069 A), etc.

With regard to a material for matrix, conventionally known thermoplastic resin, hardening resin film, etc. may be used and it is also possible to use a multifunctional material mentioned, for example, in Japanese Patent Laid-Open Nos. 2000/047,004 A, 2001/315,242 A, 2001/031,871 A and 2001/296,401 A and a hardening film prepared from a metal alkoxide composition mentioned, for example, in Japanese Patent Laid-Open No. 2001/293,818 A.

Refractive index of the high refractive index layer is preferred to be 1.70 to 2.20. Thickness of the high refractive index layer is preferably 5 nm to 10 μm and, more preferably, 10 nm to 1 μm.

Refractive index of the middle refractive index layer is adjusted so as to give a value between the refractive index of a low refractive index layer and the refractive index of a high refractive index layer. Refractive index of the middle refractive index layer is preferred to be 1.50 to 1.70.

Haze of the reflection preventive film is preferably not more than 5% and, more preferably, not more than 3%. Hardness of the film by means of a pencil hardness test in accordance with JIS K-5400 is preferably not softer than 2H and, most preferably, not softer than 3H.

### (4) Luminance Enhancing Film

The polarizing plate of the present invention is able to be used in combination with a luminance enhancing film. The luminance enhancing film has a separating function for circular polarization or linear polarization and is placed between a polarizing plate and a backlight and one of circular polarization or linear polarization is subjected to a forward reflection or a forward scattering to a backlight side. Re-reflected light from the backlight part partly changes the polarized state and partly permeates when coming into the luminance enhancing film and polarizing plate again and, therefore, when such a process is repeated, utilization rate of light increases and the front luminance is enhanced to an extent of about 1.4-fold. With regard to the luminance enhancing film, an anisotropic reflecting system and an anisotropic scattering system have been known and any of them may be combined with the polarizing plate of the present invention.

In an anisotropic reflecting system, a luminance enhancing film having anisotropy in reflective rate and in transmission by means of multiple layering of uniaxially stretched film and non-stretched film to make the difference in refractive rate in the stretched direction has been known and there have been known a multi-layered film system using a principle of dielectric mirror (mentioned in WO 95/17691, WO 95/17692 and WO 95/17699) and a cholesteric liquid crystal system (mentioned in European Patent No. 606,940 A2 and Japanese Patent Laid-Open No. 08/271,731 A). With regard to a luminance enhancing film of a multi-layered system using the principle of dielectric mirror and with regard to a luminance enhancing film of a cholesteric liquid crystals system, DBEF-E, DBEF-D and DBEF-M (all manufactured by 3M) and Nipocs (manufactured by Nitto Denko K. K.), respectively, are preferably used. With regard to Nipocs (manufactured by Nitto Denko K. K.), Nitto Giho, vol. 38, no. 1 (issue of May), 2000, pages 19 to 21, etc. may be referred to.

It is also preferred in the present invention to use by combining with a luminance enhancing film prepared by blending of a positive inherent double refractive polymer and a negative inherent double refractive polymer followed by subjecting to a uniaxial stretching mentioned in WO 97/32223, WO 97/32224, WO 97/32225, WO 97/32226 and Japanese Patent Laid-Open Nos. 09/274,108 A and 11/174,231 A. With regard to the luminance enhancing film of an anisotropic scattering system, DRPF-H (manufactured by 3M) is preferred.

The polarizing plate and the luminance enhancing film of the present invention are preferred to be used in a form of being adhered via an adhesive or in a united form where one of the protective films for a polarizing plate is used as a luminance enhancing film.

### (5) Other Functional Optical Films

It is also preferred that the polarizing plate of the present invention is used by combining with a functional optical film equipped with hard coat layer, forward scattering layer, anti-glare layer, gas barrier layer, sliding layer, antistatic layer, undercoated layer, protective layer, etc. The functional layers as such are also preferred to be used in a compounded manner in the same layer with the above-mentioned reflective protective layer in the reflection protective film or an optically anisotropic layer in the film having an expanded viewing angle. Such a functional layer is also to be used at one or both of the polarizer side or an opposite side thereof (the side nearer the air) in the reflection preventive film, viewing angle compensatory film, etc. as such.

### (5-1) Hard Coat Layer

It is preferably carried out that the polarized plate of the present invention is combined with a functional optical film where a hard coat layer is formed on the surface of a transparent support so that a dynamic strength such as anti-scratching property is bestowed. When the hard coat layer is used by applying to the above-mentioned antireflection film, it is particularly preferred to install between a transparent support and a high refractive index layer.

The hard coat layer is preferably produced by a cross-linking reaction of a hardening compound using light and/or heat or by a polymerization reaction. With regard to the hardening functional group, an optically polymerizable function group is preferred while, with regard to an organometallic compound containing a hydrolysable functional group, an organic alkoxysilyl compound is preferred. With regard to a specific constituting composition for the hard coat layer, that which is mentioned, for example, in Japanese Patent Laid-Open Nos. 2002/144,913 A and 2000/009,908 A and WO 00/46617 may be preferably used.

Thickness of film of the hard coat layer is preferred to be 0.2 to 100 Lm.

Hardness of the hard coat layer by a pencil hardness test according to JIS K-5400 is preferably not softer than H, more preferably not softer than 2H and, most preferably, not softer than 3H. In addition, in the taper test according to JIS K-5400, the smaller the abraded amount of the test piece before and after the test, the better.

With regard to a material for forming a hard coat layer, it is possible to use a compound having an ethylenic unsaturated group or a compound having a ring-opening polymerizable group and each of those compounds may be used either solely or in combination thereof. Preferred examples of the compound having an ethylenic unsaturated group are polyol polyacrylates such as ethylene glycol diacrylate, trimethylolpropane triacrylate, ditrimethylolpropane tetraacrylate, pentaerythritol triacrylate, pentaerythritol tetraacrylate, dipentaerythritol pentaacrylate and dipentaerythritol hexaacrylate; epoxyacrylates such as bisphenol A diglycidyl ether diacrylate and hexanediol diglycidyl ether diacrylate; and urethane acrylate prepared by the reaction of polyisocyanate with hydroxyl-containing acrylate such as hydroxyethyl acrylate.

Examples of the commercially available compound are EB-600, EB-40, EB-140, EB-1150, EB-1290K, IRR 214, EB-2220, TMPTA and TMPTMA (all of them are manufactured by Daicel UCB K. K.) and UV-6300 and UV-1700B (both are manufactured by Nippon Synthetic Chemical Industry Co., Ltd.).

Preferred examples of the compound having a ring-opening polymerizable compound are glycidyl ethers such as ethylene glycol diglycidyl ether, bisphenol A diglycidyl ether, trimethylolethane triglycidyl ether, trimethylolpropane triglycidyl ether, glycerol triglycidyl ether, triglycidyl trishydroxyethyl isocyanurate, sorbitol tetraglycidyl ether, pentaerythritol tetraglycidyl ether, polyglycidyl ether of cresol novolak resin and polyglycidyl ether of phenol novolak resin; alicyclic epoxy compounds such as Celloxide 2021P, Celloxide 2081, Epolead GT-301, Epolead GT-401 and EHPE 3150 CE (all of them are manufactured by Daicel Chemical Industries, Ltd.) and polycyclohexyl epoxymethyl ether of phenol novolak resin; and oxetanes such as OXT-121, OXT-221, OX-SW and PNOX-1009 (all are manufactured by Toa Gosei). Besides the above, a glycidyl (meth)acrylate polymer or a copolymer of glydicyl (meth)acrylate with a monomer being copolymerizable therewith is also able to be used for a hard coat layer.

It is also possible that the hard coat layer is added with fine particles of oxide such as those of silicon, titanium, zirconium and aluminum; cross-linked particles such as those of polyethylene, polystyrenel, poly(meth)acrylate and polydimethylsiloxane; cross-linked fine particles of organic fine particles such as fine particles of cross-linked rubber, e.g. SBR and NBR, etc. in order to reduce the hardening/shrinking of the hard coat layer, to enhance the close adhesion to a substrate and to reduce the curing of the product treated with the hard coat of the present invention. Average particle size of those cross-linked fine particles is preferred to be 1 nm to 20,000 nm. There is no particular limitation for the shape of the cross-linked fine particles and any of spheres, rods, needles, plates, etc. may be used. Adding amount of the fine particles is preferably not more than 60% by volume of the hard coat layer after hardening and, more preferably, not more than 40% by volume thereof.

When the above-mentioned inorganic fine particles are added, those inorganic fine particles usually have poor miscibility with a binder polymer and, therefore, it is preferably carried out that those inorganic fine particles are subjected to a surficial treatment using a surface treating agent which contains metal such as silicon, aluminum and titanium and has a functional group such as alkoxide group, carboxylic acid group, sulfonic acid group and phosphonic acid group.

It is preferred that a hard coat layer is hardened by heat or using active energy ray. Among them, it is more preferred to use active energy ray such as radioactive ray, gamma ray, alpha ray, electronic ray or ultraviolet ray and, when safety and productivity are taken into consideration, it is particularly preferred to use electronic ray or ultraviolet ray. When hardening is carried out by heat, temperature for the heating is preferably not higher than 140° C. and, more preferably, not higher than 100° C. by taking the heat resistance of the plastic itself into consideration.

### (5-2) Forward Scattering Layer

A forward scattering layer is used for improving the viewing angle characteristics (hue and luminance distribution) in upward, downward, left and right directions when the polarizing plate of the present invention is applied to a liquid crystal display device. In the present invention, a constitution where fine particles having different refractive indexes are dispersed in a binder is preferred and, for example, a constitution where the forward scattering coefficient is specified (Japanese Patent Laid-Open No. 11/038,208 A), a constitution where relative refractive indexes of the transparent resin and the fine particles are made within a specific range (Japanese Patent Laid-Open No. 2000/199,809 A) and a constitution where haze value is stipulated as not less than 40% (Japanese Patent Laid-Open No. 2002/107,512 A) may be used. It is also able to be preferably carried out that the polarizing plate of the present invention is used together with Lumisty mentioned in “Optically Functional Films”, pages 31 to 39 which is a technical report issued by Sumitomo Chemical so as to control the viewing angle characteristic of haze.

### (5-3) Anti-Glare Layer

An anti-glare layer is used whereby reflected light is scattered so that glare is prevented. An anti-glare function is achieved by formation of unevenness on the outermost surface (displaying surface) of a liquid crystal display device. Haze of an optical film having an anti-glare function is preferably 3 to 30%, more preferably 5 to 20% and, most preferably, 7 to 20%.

With regard to a method for the formation of unevenness on the film surface, a method where unevenness is formed on the film surface by addition of fine particles (Japanese Patent Laid-Open No. 2000/271,878 A, etc.), a method where small amount (0.1 to 50% by mass) of relatively big particles (particle size: 0.05 to 2 μm) is added to form an uneven film on the surface (Japanese Patent Laid-Open Nos. 2000/281,410 A, 2000/095,893 A, 2001/100,004 A, 2001/281,407 A, etc.), a method where uneven form is physically transcribed on a film surface (such as an embossing processing mentioned in Japanese Patent Laid-Open Nos. 63/278,839 A, 11/183,710 A and 2000/275,401 A, etc.), etc. may be preferably used.

### [Liquid Crystal Display Device Using Polarized Plate]

Now, the liquid crystal display device where the polarizing plate of the present invention is used will be illustrated.

In the liquid crystal display device where liquid crystal cell and two polarizing plates arranged on both sides thereof, at least one polarized plate is the polarized plate of the present invention.

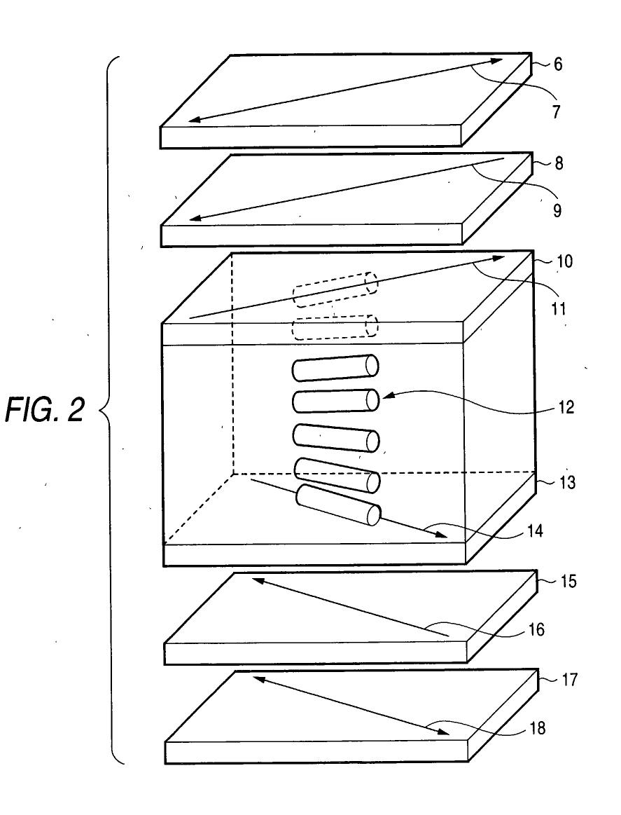

FIG. 2 is an example of the liquid crystal display device in which the polarizing plate of the present invention is used.

The liquid crystal display device as shown in FIG. 2 has liquid crystal cells 10 to 13 and upper polarized plate 6 and lower polarized plate 17 aligned by sandwiching of said liquid crystal cells 10 to 13. Although the polarizing plates are sandwiched by a polarizer and a pair of protective films, it is shown as a unified polarized plate in FIG. 2 and detailed structure is omitted. Liquid crystal cells are composed of upper electrode substrate 10, lower electrode substrate 13 and liquid crystal molecules 12 sandwiched thereby. Depending upon the difference in liquid crystal molecules conducting an ON-OFF display, liquid crystal cell is classified into display modes of TN (twisted nematic), IPS (in-plane switching), OCB (optically compensatory bend), VA (vertically aligned) and ECB (electrically controlled birefringence) and the polarized plate of the present invention is able to be used for any of display modes independently of transmission and reflection types.

Among those display modes, OCB mode or VA mode are preferred.

An oriented film (not shown) is formed on the surface of the electrode substrates 10 and 13 contacting to the liquid crystal molecules 12 and, by a rubbing treatment, etc. applied on the oriented film, alignment of the liquid crystal molecules 12 in a state where no electric field is applied or is lowly applied is controlled. In the inner side of the substrates 10 and 13, a transparent electrode (not shown) comprising liquid crystal molecule 12 which is able to apply electric field to liquid crystal layer is formed.

A rubbing direction of TN mode is applied in an orthogonally crossing direction to upper and lower substrates and size of tilted angle is able to be controlled by its strength, rubbing time, etc. The oriented film is formed by application of a polyimide film followed by burning. Size of the twist angle of the liquid crystal layer is determined by a crossing angle of the upper and lower substrates in a rubbing direction and by a chiral agent added to the liquid crystal material. Here, a chiral agent where pitch is about 60 μm is added so as to make the twist angle 90°.

In the case of liquid crystal display element for notebook computers, personal computer monitor and television, the twist angle is set at about 90° (85 to 95°) while, in the case of display device of a reflection type such as mobile phones, it is set at 0 to 70°. In an IPS mode and an ECB mode, the twist angle is 0°. In an IPS mode, electrode is aligned only to the lower substrate 8 and electric field parallel to the substrate surface is applied. In an OCB mode, there is no twist angle and tilt angle is made big while, in a VA mode, liquid crystal molecules 12 are aligned vertically to upper and lower substrates.

Size of Δnd which is a product of thickness d and refractive anisotropy Δn changes the brightness upon white display. Therefore, its range is set for each display mode so as to achieve the highest brightness.

With regard to a crossing angle between an absorptive axis 7 of the upper polarizing plate 6 and an absorptive axis 18 of the lower polarizing plate 17, layering is conducted in such a manner that it is usually made nearly orthogonal whereby a high contrast is achieved. A crossing angle between an absorptive axis 7 of the upper polarizing plate 6 of the liquid crystal cell and a rubbing direction of the upper substrate 10 varies depending upon the liquid crystal display mode and, in TN and IPS modes, it is usually set in parallel or vertical manner. In OCB and ECB modes, it is often to set at 45°. However, the optimum value is different in each display mode due to color tone of displayed color and viewing angle and the range is not limited to the above-mentioned ones.

The liquid crystal display device for which the polarizing plate of the present invention is used is not limited to the constitution of FIG. 2 but other materials may be contained. For example, a color filter may be aligned between a liquid crystal cell and a polarizer. It is also possible that the above-mentioned film having an expanded viewing angle is separately aligned between the liquid crystal cell and the polarizing plate. The polarizing plates 6 and 17 and the optically anisotropic layers (film where viewing angle is expanded) 8 and 15 may be aligned in a layered state being adhered with an adhesive or may be aligned as the so-called an elliptic polarizing plate in a united type where one of the protective film at the side of the liquid crystals cell is used for expansion of viewing angle.

When a liquid crystal display device where the polarizing plate of the present invention is used is used as a transmission type, backlight where cold cathode or hot cathode fluorescent tube, light emitting diode, field emission element or electroluminescent element is a light source is able to be aligned on the back side. The liquid crystal display device where the polarizing plate of the present invention is used may be in a reflective type and, in that case, only one sheet of the polarizing plate may be aligned on the observing side and a reflective film is formed on the back surface of the liquid crystal cell or on the inner surface of lower substrate of the liquid crystal cell. It is of course possible that a front light using the above-mentioned light source is formed at the observing side of the liquid crystal cell.

Hereafter, the present invention achieving the fourth object of the invention is described.

The present invention is characterized in that an optical characteristic where wavelength dispersion of retardation is different when light of incidence is in the direction of normal line and when it is in the oblique direction inclining therefrom such as in the direction of 60° of polar angle is bestowed on a cellulose acylate film and is positively used for optical compensation. The coverage of the present invention is not limited by the display mode of the liquid crystal layer but is also able to be used for liquid crystal display device having any of display modes such as VA mode, IPS mode, ECB mode, TN mode and OCB mode.

The above-mentioned characteristic feature of the present invention is able to be achieved when a liquid crystal compound represented by the formula (I) is contained in an optical film in combination with a retardation raising agent. The advantages of the invention are able to be particularly significantly achieved when the compounds represented by the formulae (II) to (IV) are used as a retardation raising agent.

Details of the present invention will be illustrated as hereunder.

A compound of the formula (I) will be illustrated in detail as follows.

With regard to L₁ and L₂, the following examples may be preferably listed.

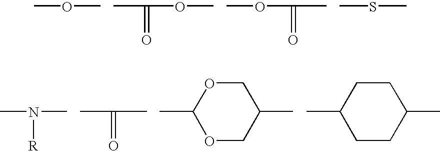

More preferably, they are —O—, —COO— and —OCO—.

R₁ is a substituent and, when they are present in plural, they may be same or different and also may form a ring. With regard to examples of the substituent, the following may be adopted.

Halogen atom (such as fluorine atom, chlorine atom, bromine atom and iodine atom), an alkyl group (preferably an alkyl group of 1 to 30 carbon number(s) such as methyl group, ethyl group, n-propyl group, isopropyl group, tert-butyl group, n-octyl group and 2-ethylhexyl group), a cycloalkyl group (preferably, a substituted or unsubstituted alkyl group of 3 to 30 carbon number(s) such as cyclohexyl group, cyclopentyl group and 4-n-dodecylcylohexyl group), a bicycloalkyl group (preferably, a substituted or unsubstituted bicycloalkyl group of 5 to 30 carbon number(s) or, in other words, a univalent group resulted by removal of one hydrogen atom from a bicycloalkane of 5 to 30 carbon numbers such as bicyclo[1,2,2]heptan-2-yl and bicyclo[2,2,2]octan-3-yl), an alkenyl group (preferably a substituted or unsubstituted alkenyl group of 2 to 30 carbon atom(s) such as vinyl group and allyl group), a cycloalkenyl group (preferably, a substituted or unsubstituted alkenyl group of 3 to 30 carbon number(s) or, in other words, a univalent group resulted by removal of one hydrogen atom from cycloalkene of 3 to 30 carbon number(s) such as 2-cyclopenten-1-yl group and 2-cyclohexen-1-yl group), a bicycloalkenyl group (a substituted or unsubstituted bicycloalkenyl group or, preferably, a substituted or unsubstituted bicycloalkenyl group of 5 to 30 carbon number(s) or, in other words, a univalent group resulted by removal of one hydrogen atom from a bicycloalkene having one double bond such as bicyclo[2,2,1]hept-2-en-1-yl group and cyclo[2,2,2]oct-2-en-4-yl group), an alkynyl group (preferably, a substituted or unsubstituted alkynyl group of 2 to 30 carbon number(s) such as ethynyl group and propargyl group),

anaryl group (preferably a substituted or unsubstituted aryl group having 6 to 30 carbons such as phenyl group, p-tolyl group and naphthyl group), a heterocyclic group (preferably a univalent group where one hydrogen is removed from a five- or six-membered substituted or unsubstituted aromatic or non-aromatic heterocyclic compound and, more preferably, an five- or six-membered aromatic heterocyclic group having 3 to 30 carbons such as 2-furyl group, 2-thienyl group, 2-pyrimidinyl group and 2-benzothiazolyl group), cyano group, hydroxyl group, nitro group, carboxyl group, an alkoxy group (preferably, a substituted or unsubstituted alkoxy group having 1 to 30 carbon(s) such as methoxy group, ethoxy group, isopropoxy group, tert-butoxy group, n-octyloxy group and 2-methoxyethoxy group), an aryloxy group (preferably, a substituted or unsubstituted aryloxy group having 6 to 30 carbons such as phenoxy group, 2-methylphenoxy group, 4-tert-butylphenoxy group, 3-nitrophenoxy group and 2-tetradecanoylaminophenoxy group), a silyloxy group (preferably, a silyloxy group having 3 to 20 carbons such as trimethylsilyloxy group and tert-butyldimethylsilyloxy group), a heterocyclic oxy group (preferably, a substituted or unsubstituted heterocyclic oxy group having 2 to 30 carbons such as 1-phenyltetrazol-5-oxy group and 2-tetrahydropyranyloxy group), an acyloxy group (preferably, formyloxy group, a substituted or unsubstituted alkylcarbonyloxy group having 2 to 30 carbons and a substituted or unsubstituted arylcarbonyloxy group having 6 to 30 carbons such as formyloxy group, acetyloxy group, pivaloyloxy group, stearoyloxy group, benzoyloxy group and p-methoxyphenylcarbonyloxy group), a carbamoyloxy group (preferably, a substituted or unsubstituted carbamoyloxy group having 1 to 30 carbon(s) such as N,N-dimethylcarbamoyloxy group, N,N-diethylcarbamoyloxy group, morpholinocarbonyloxy group, N,N-di-n-octylaminocarbonyloxy group and N-n-octylcarbamoyloxy group), an alkoxycarbonyloxy group (preferably, a substituted or unsubstituted alkoxycarbonyloxy group having 2 to 30 carbons such as methoxycarbonyloxy group, ethoxycarbonyloxy group, tert-butoxycarbonyloxy group and n-octylcarbonyloxy group), an aryloxycarbonyloxy group (preferably, a substituted or unsubstituted aryloxycarbonyloxy group having 7 to 30 carbons such as phenoxycarbonyloxy group, p-methoxyphenoxycarbonyloxy group and p-n-hexadecyloxyphenoxycarbonyloxy group),

an amino group (preferably, a substituted or unsubstituted alkylamino group having 1 to 30 carbon(s) and a substituted or unsubstituted anilino group having 6 to 30 carbons such as amino group, methylamino group, dimethylamino group, anilino group, N-methylanilino group and diphenylamino group), an acylamino group (preferably, formylamino group, a substituted or unsubstituted alkylcarbonylamino group having 1 to 30 carbon(s) and a substituted or unsubstituted arylcarbonylamino group having 6 to 30 carbons such as formylamino group, acetylamino group, pivaloylamino group, lauroylamino group and benzoylamino group), an aminocarbonylamino group (preferably, a substituted or unsubstituted aminocarbonylamino group having 1 to 30 carbon(s) such as carbarnoylamino group, N,N-dimethylaminocarbonylamino group, N,N-diethylaminocarbonylamino group and morpholinocarbonylamino group), an alkoxycarbonylamino group (preferably, a substituted or unsubstituted alkoxycarbonylamino group having 2 to 30 carbons such as inethoxycarbonylamino group, ethoxycarbonylamino group, tert-butoxycarbonylamino group, n-octadecyloxycarbonylamino group and N-methyl-methoxycarbonylamino group), an aryloxycarbonylamino group (preferably, a substituted or unsubstituted aryloxycarbonylamino group having 7 to 30 carbons such as phenoxycarbonylamino group, p-chlorophenoxycarbonylamino group and m-n-octyloxyphenoxycarbonylamino group), a sulfamoylamino group (preferably, a substituted or unsubstituted sulfamoylamino group having 0 to 30 carbon(s) such as sulfamoylamino group, N,N-dimethylaminosulfonylamino group and N-n-octylaminosulfonylamino group), an alkyl and arylsulfonylamino group (preferably, a substituted or unsubstituted alkylsulfonylamino group having 1 to 30 carbon(s) and a substituted or unsubstituted arylsulfonylamino group having 6 to 30 carbons such as methylsulfonylamino group, butylsulfonylamino group, phenylsulfonylamino group, 2,3,5-trichlorophenylsulfonylamino group and p-methylphenylsulfonylamino group), mercapto group, an alkylthio group (preferably, a substituted or unsubstituted alkylthio group having 1 to 30 carbon(s) such as methylthio group, ethylthio group and n-hexadecylthio group), an arylthio group (preferably, a substituted or unsubstituted arylthio group having 6 to 30 carbons such as phenylthio group, p-chlorophenylthio group and m-methoxyphenylthio group), a heterocyclic thio group (preferably, a substituted or unsubstituted heterocyclic thio group having 2 to 30 carbons such as 2-benzothiazolylthio group and 1-phenyltetrazol-5-ylthio group), a sulfamoyl group (preferably, a substituted or unsubstituted sulfamoyl group having 0 to 30 carbon(s) such as N-ethylsulfamoyl group, N-(3-dodecyloxypropyl)sulfamoyl group, N,N-dimethylsulfamoyl group, N-acetylsulfamoyl group, N-benzoylsulfamoyl group and N—(N′-phenylcarbamoyl)sulfamoyl group, sulfo group, an alkyl and arylsulfinyl group (preferably, a substituted or unsubstituted alkylsulfinyl group having 1 to 30 carbon(s) and substituted or unsubstituted arylsulfinyl group having 6 to 30 carbons such as methylsulfinyl group, ethylsulfinyl group, phenylsulfinyl group and p-methylphenylsulfinyl group), an alkyl and arylsulfonyl group (preferably, a substituted or unsubstituted alkylsulfonyl group having 1 to 30 carbons and a substituted or unsubstituted arylsulfonyl group having 6 to 30 carbons such as methylsulfonyl group, ethylsulfonyl group, phenylsulfonyl group and p-methylphenylsulfonyl group), an acyl group (preferably, formyl group, a substituted or unsubstituted alkylcarbonyl group having 2 to 30 carbons and a substituted or unsubstituted arylcarbonyl group having 7 to 30 carbons such as acetyl group and pivaloylbenzoyl group), an aryloxycarbonyl group (preferably, a substituted or unsubstituted aryloxycarbonyl group having 7 to 30 carbons such as phenoxycarbonyl group, o-chlorophenoxycarbonyl group, m-nitrophenoxycarbonyl group and p-tert-butylphenoxycarbonyl group), an alkoxycarbonyl group (preferably, a substituted or unsubstituted alkoxycarbonyl group having 2 to 30 carbons such as methoxycarbonyl group, ethoxycarbonyl group, tert-butoxycarbonyl group and n-octadecyloxycarbonyl group),

a carbamoyl group (preferably, a substituted or unsubstituted carbamoyl group having 1 to 30 carbon(s) such as carbamoyl group, N-methylcarbamoyl group, N,N-dimethylcarbamoyl group, N,N-di-n-octylcarbamoyl group and N-(methylsulfonyl)carbamoyl group), an aryl and heterocyclic azo group (preferably, a substituted or unsubstituted arylazo group having 6 to 30 carbons and a substituted or unsubstituted heterocyclic azo group having 3 to 30 carbons such as phenylazo group, p-chlorophenylazo group and 5-ethylthio-1,3,4-thiadiazol-2-ylazo group), an imide group (preferably, N-succinimide group and N-phthalimide group), a phosphine group (preferably, a substituted or unsubstituted phosphine group such as dimethylphosphino group, diphenylphosphino group and methylphenoxyphosphino group), a phosphinyl group (preferably, a substituted or unsubstituted phosphinyl group having 2 to 30 carbons such as phosphinyl group, dioctylphosphinyl group and diethoxyphosphinyl group), a phosphinyloxy group (preferably, a substituted or unsubstituted phosphinyloxy group having 2 to 30 carbons such as diphenxoyphosphinyloxy group and dioctyloxyphosphinyl group), a phosphinylamino group (preferably, a substituted or unsubstituted phosphinylamino group having 2 to 30 carbons such as dimethoxyphosphinylamino group and dimethylaminophosphinyl group) and a silyl group (preferably, a substituted or unsubstituted silyl group having 3 to 30 carbons such as trimethylsilyl group, tert-butyldimethylsilyl group and phenyldimethylsilyl group).

With regard to that having a hydrogen atom among the above-mentioned substituents, the hydrogen may be removed followed by substituting with the above group. Examples of the functional group as such are an alkylcarbonylaminosulfonyl group, an arylcarbonylaminosulfonyl group, an alkylsulfonylaminocarbonyl group and an arylsulfonylaminocarbonyl group. Specific examples thereof are methylsulfonylaminocarbonyl group, p-methylphenylsulfonylaminocarbonyl group, acetylaminosulfonyl group and benzoylaminosulfonyl group.

R₁ is preferably halogen atom, alkyl group, alkenyl group, aryl group, heterocyclic group, hydroxyl group, carboxyl group, alkoxy group, aryloxy group, acyloxy group, cyano group and amino group. More preferred ones are halogen atom, alkyl group, cyano group and alkoxy group.

R₂ and R₃ each independently is a substituent. Examples thereof are the above-mentioned examples for the R₁. Preferred ones are a substituted or unsubstituted benzene ring and a substituted or unsubstituted cyclohexane ring. More preferred ones are a substituted benzene ring and a substituted cyclohexane ring. Still more preferred ones are a benzene ring having a substituent at 4-position and a cyclohexane ring having a substituent at 4-position.

R₄ and R₅ each independently is a substituent. Examples thereof are the above-mentioned examples for R₁. Preferred one is an electron-attractive substituent where Hammett's substituent constant σₚ value is more than 0. It is more preferred to have an electron-attractive substituent where σₚ value is 0 to 1.5. Examples of the substituent as such are trifluoromethyl group, cyano group, carbonyl group and nitro group. R₄ and R₅ may be bonded to form a ring.

Hammett's substituent constants σₚ and σₘ are mentioned in detail in reference books such as, for example, “Hammett Rule—Structure and Reactivity” by Naoki Inamoto (Maruzen), “New Chemical Experiments, Vol. 14, Synthesis and Reaction of Organic Compounds, V”, page 2605, edited by the Chemical Society of Japan (Maruzen), “Theoretical Organic Chemistry”, page 217, by Tadao Nakatani (Tokyo Kagaku Dojin) and Chemical Review, volume 91, pages 165 to 195 (1991).

A₁ and A₂ each is a group dependently selected from —O—, —NR— (R is hydrogen atom or substituent), —S— and —CO—. Preferably, it is a group independently selected from —O—, —NR— (R is a substituent) and —S—.

n is preferably 0 or 1 and, most preferably, 0.

Hereinafter, a compound represented by the formula (I) contained at least one in the composition of the present invention will be illustrated in detail by referring to specific examples although the present invention is not limited by the following specific examples at all. Unless otherwise mentioned, the following compound is referred to an exemplified compound (X) by the figure in the parentheses ( ).

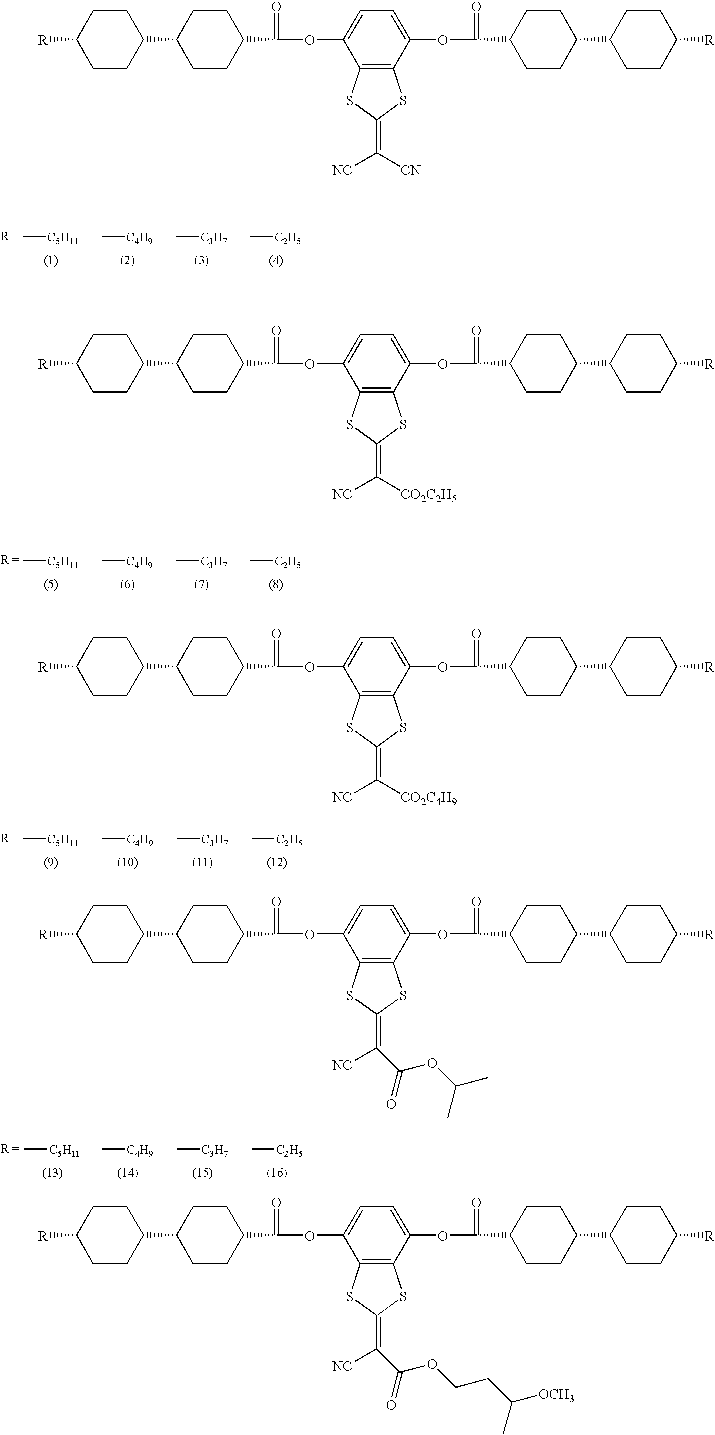

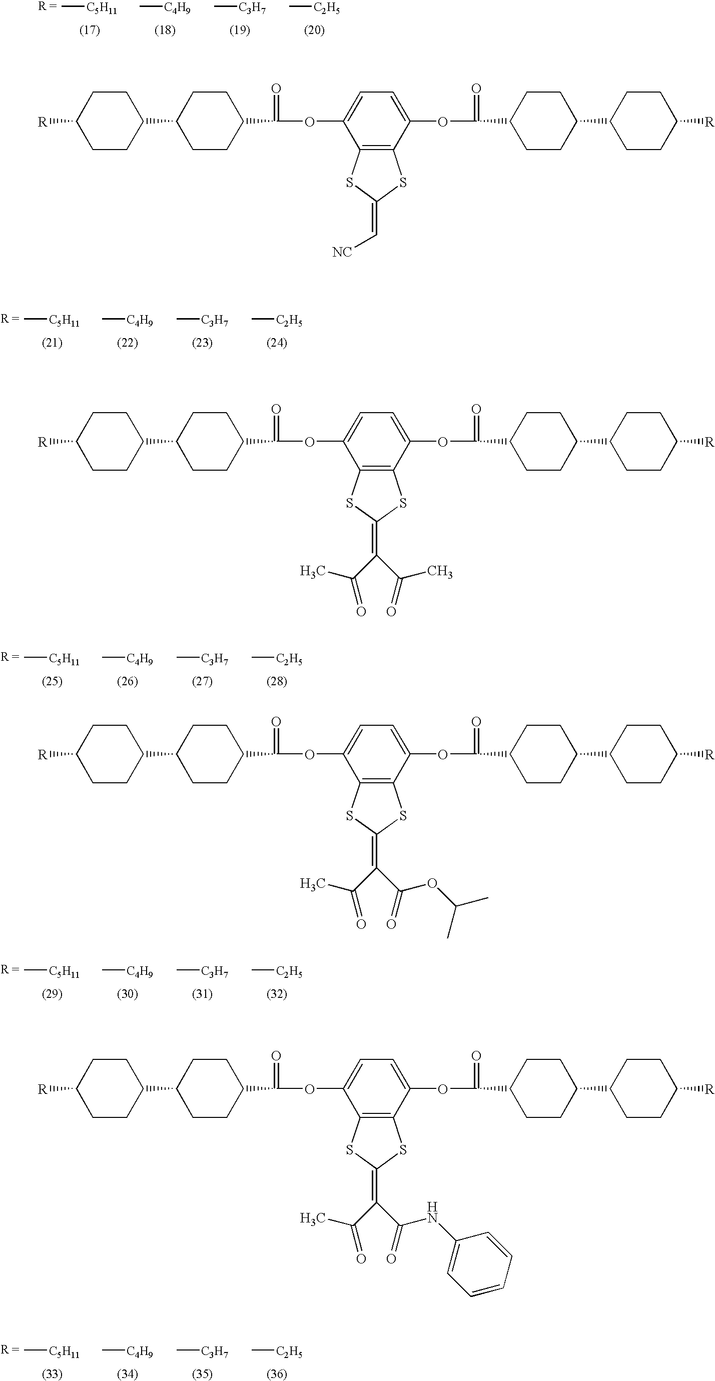

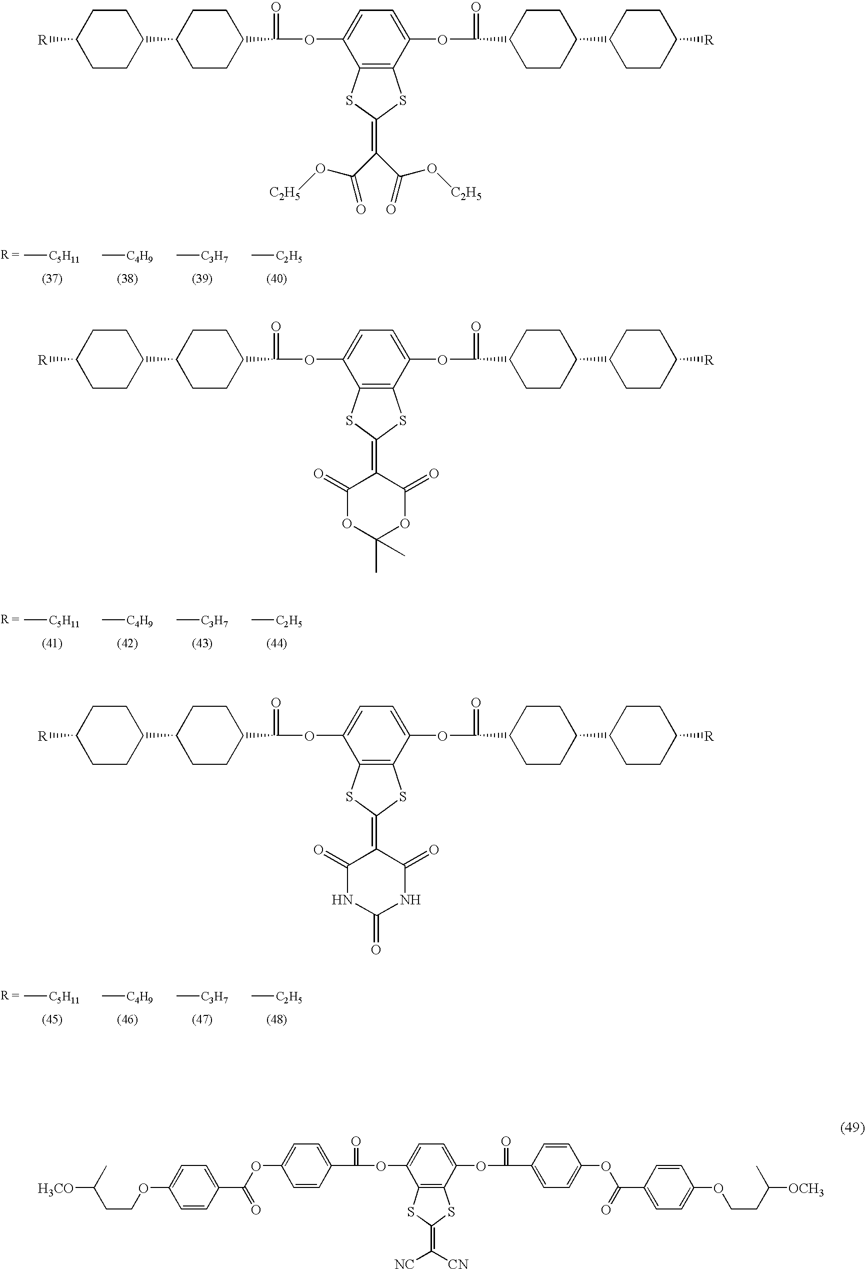

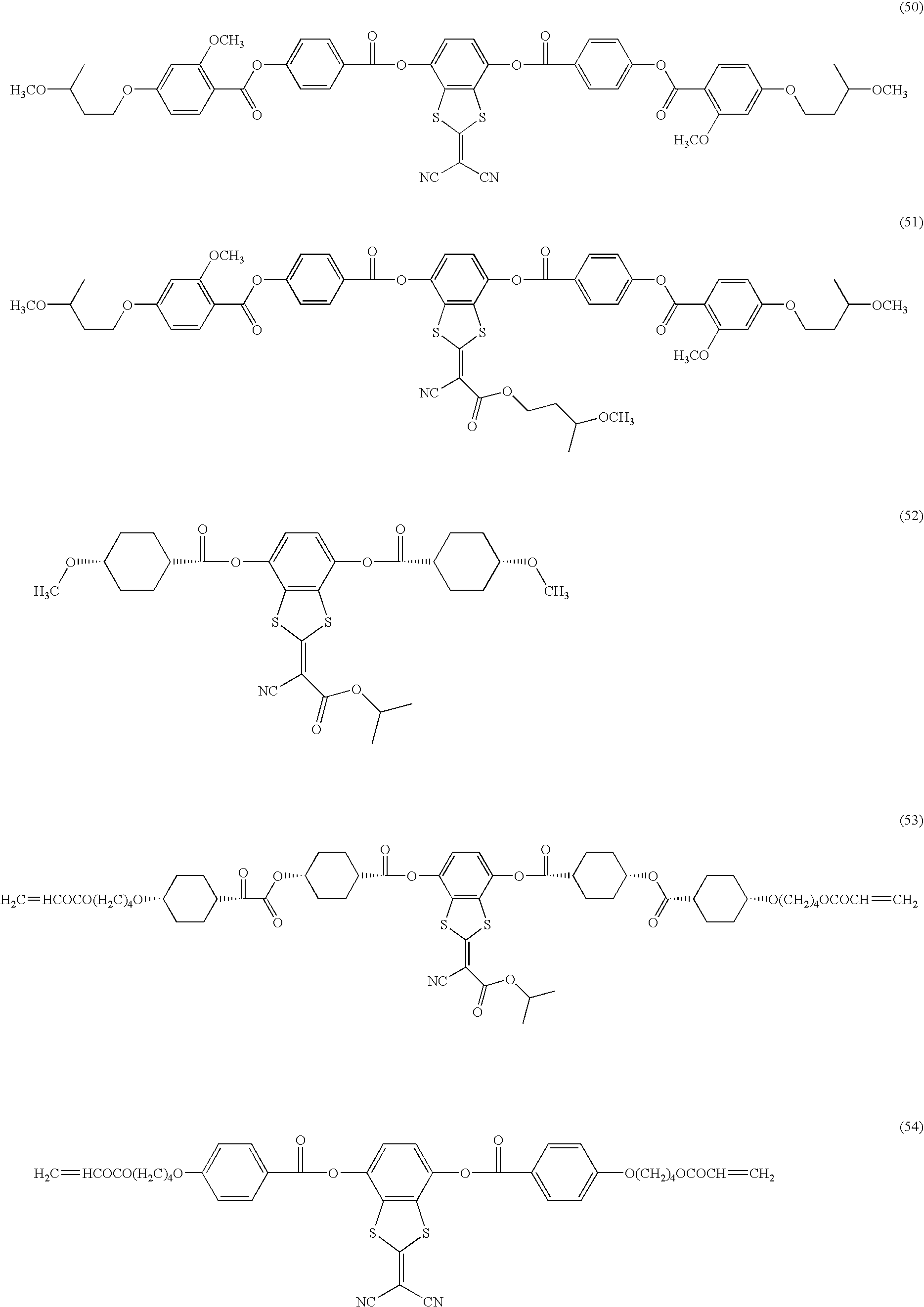

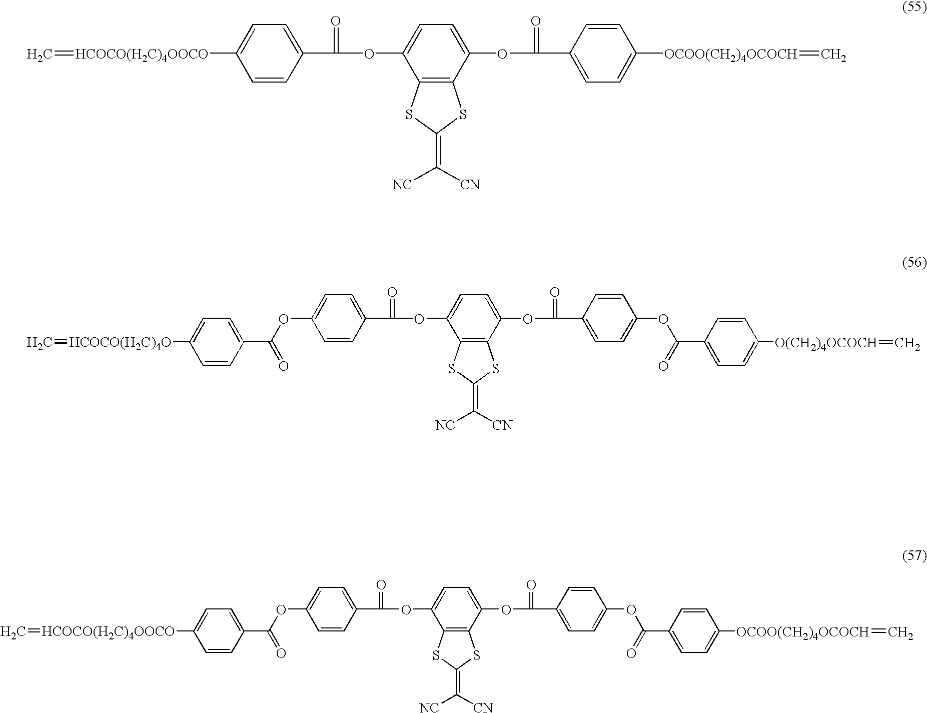

Content of the compound represented by the formula (I) in the present invention to the cellulose compound is preferably 0.1 to 30 part(s) by mass, more preferably 0.5 to 20 part(s) by mass and, still more preferably 1 to 12 part(s) by mass, most preferably, 1 to 5 part(s) by mass.

The compound represented by the formula (1) is preferred to express a liquid crystal phase within a temperature range of 100° C. to 300° C. More preferably, it is 120° C. to 200° C. With regard to the liquid crystal phase, it is preferred to be a nematic phase or a smectic phase.

Synthesis of the compound represented by the formula (I) is able to be carried out by a known method.

An Rth raising agent which is to be contained in the optical film of the present invention together with the compound represented by the formula (1) will be illustrated in detail.

The Rth raising agent of the present invention is preferred to satisfy the following formulae (1) and (2).

(Rth(a)−Rth(0))/a≧5.0 (1)

0.01≦A≦30 (2)

In the formulae,

Rth (a): Rth (nm) of the film at 550 nm wavelength containing A % of the retardation raising agent

Rth (0): Rth (nm) of the film at 550 nm wavelength containing no retardation raising agent

a: % by mass of the Rth raising agent when cellulose acylate which is a film material is 100 parts by mass

The formula (1) is more preferred to be the following formula (1 a).

(Rth(a)−Rth(0))/a≧10.0 (1a)

The formula (1) is most preferred to be the following formula (1b).

(Rth(a)−Rth(0))/a≧15.0 (1b)

With regard to the Rth raising agent in the present invention, it has preferably at least one maximum absorption at 250 to 380 nm, more preferably at least one maximum absorption at 250 to 360 nm and, most preferably, at least one maximum absorption at 300 to 355 nm.

With regard to the Rth raising agent in the present invention, it is preferred to be a compound having at least two aromatic rings.

The Rth raising agent is preferred to be selected from the compounds represented by the formulae (II), (III), (IV) and (V).

Now, the compound represented by the formula (II) will be illustrated,

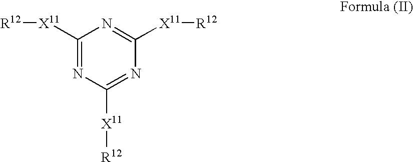

In the above-mentioned formula (II), each R¹² independently is an aromatic ring or a hetero ring having a substituent at least any of ortho-, meta- and para-positions.

X¹¹ each independently is a single bond or —NR¹³—. Here, R¹³ each independently is hydrogen atom, a substituted or unsubstituted alkyl group, alkenyl group, aryl group or heterocyclic group.

The aromatic ring represented by R¹² is preferably phenyl or naphthyl and, particularly preferably, it is phenyl. The aromatic ring represented by R¹² may have at least one substituent at any substituting position. Examples of the above substituent include halogen atom, hydroxyl, cyano, nitro, carboxyl, an alkyl group, an alkenyl group, an aryl group, an alkoxy group, an alkenyloxy group, an aryloxy group, an acyloxy group, an alkoxycarbonyl group, an alkenyloxycarbony group, an aryloxycarbonyl group, a sulfamoyl group, an alkyl-substituted sulfamoyl group, an alkenyl-substituted sulfamoyl group, an aryl-substituted sulfamoyl group, a sulfonamide group, carbamoyl, an alkyl-substituted carbamoyl group, an alkenyl-substituted carbamoyl group, an aryl-substituted carbamoyl group, an amide group, an alkylthio group, an alkenylthio group, an arylthio group and an acyl group.

The heterocyclic group represented by R¹² is preferred to have an aromatic property. A hetero ring having an aromatic property is usually an unsaturated hetero ring and, preferably, it is a hetero ring having the maximum double bonds. The hetero ring is preferably five-, six- or seven-membered ring, more preferably five- or six-membered ring and, most preferably, six-membered ring. Hetero atom of the hetero ring is preferably nitrogen atom, sulfur atom or oxygen atom and, particularly preferably, nitrogen atom. With regard to a hetero ring having an aromatic property, pyridine ring (2-pyridyl or 4-pyridyl as a heterocyclic group) is particularly preferred. The heterocyclic group may have a substituent. Examples of the substituent for the heterocyclic group are the same as those for the above-mentioned aryl moiety.

A heterocyclic group when X¹¹ is a single bond is preferably a heterocyclic group having a free valence in a nitrogen atom. A heterocyclic group having a free valence in nitrogen atom is preferably five-, six- or seven-membered ring, more preferably five- or six-membered ring and, most preferably, five-membered ring. The heterocyclic group may have plural nitrogen atoms. The heterocyclic group may also have a hetero atom (such as O and S) other than nitrogen atom. As hereunder, examples of the heterocyclic group having free valence in the nitrogen atom is shown.

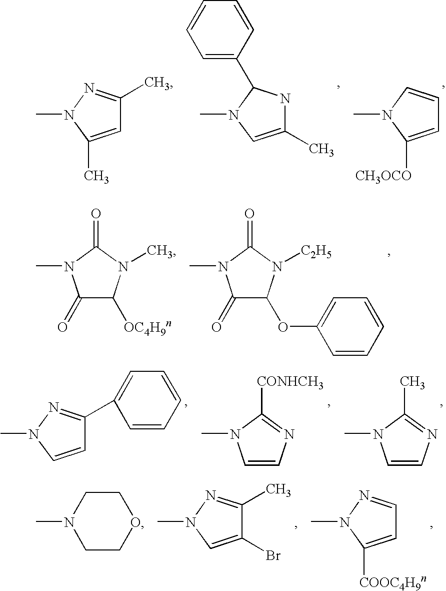

In the formula (II), X¹¹ is a single bond or —NR¹³—. R¹³ independently is hydrogen atom, a substituted or unsubstituted alkyl group, an alkenyl group, an aryl group or a heterocyclic group.

The alkyl group represented by R¹³ may be a cyclic alkyl group or a chain alkyl group although a chain alkyl group is preferred and a straight-chain alkyl group is more preferred over a branched chain alkyl group. Carbon atom number(s) of the alkyl group is/are preferably 1 to 30, more preferably 1 to 20, still more preferably 1 to 10, further more preferably 1 to 8 and, most preferably, 1 to 6. The alkyl group may have a substituent. Examples of the substituent include halogen atom, an alkoxy group (such as methoxy group and ethoxy group) and an acyloxy group (such as acryloyloxy group and methacryloyloxy group).

The alkenyl group represented by R¹³ may be a cyclic alkenyl group or a chain alkenyl group although a chain alkenyl group is preferred and a straight-chain alkenyl group is more preferred over a branched chain alkenyl group. Carbon atom numbers of the alkenyl group are preferably 2 to 30, more preferably 2 to 20, still more preferably 2 to 10, further more preferably 2 to 8 and, most preferably, 2 to 6. The alkenyl group may have a substituent. Examples of the substituent are the same as those for the above alkyl group.

The aromatic ring group and heterocyclic group represented by R¹³ are the same as the aromatic ring and hetero ring represented by R¹² and a preferred range thereof are also the same. The aromatic ring group and the heterocyclic group may further have a substituent and examples of the substituent are the same as those for the aromatic ring and the hetero ring represented by R¹².

As hereunder, specific examples of the retardation raising agent used in the present invention represented by the formula (II) will be mentioned. Plural R's shown in the same structural formula of each of the exemplified compounds stand for the same group. Definition for R is shown after the formula together with the specific example numbers.

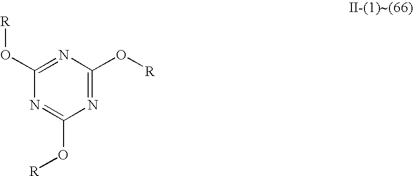

II-(1) phenyl
II-(2) 3-ethoxycarbonylphenyl
II-(3) 3-butoxyphenyl
II-(4) m-biphenylyl
II-(5) 3-phenylthiophenyl
II-(6) 3-chlorophenyl
II-(7) 3-benzoylphenyl
II-(8) 3-acetoxyphenyl
II-(9) 3-benzoyloxyphenyl
II-(10) 3-phenoxycarbonylphenyl
II-(11) 3-methoxyphenyl
II-(12) 3-anilinophenyl
II-(13) 3-isobutyrylaminophenyl
II-(14) 3-phenoxycarbonylaminophenyl
II-(15) 3-(3-ethylureido)phenyl
II-(16) 3-(3,3-diethyhlreido)phenyl
II-(17) 3-methylphenyl
II-(18) 3-phenoxyphenyl
II-(19) 3-hydroxyphenyl
II-(20) 4-ethoxycarbonylphenyl
II-(21) 4-butoxyphenyl
II-(22) p-biphenylyl
II-(23) 4-phenylthiophenyl
II-(24) 4-chlorophenyl
II-(25) 4-benzoylphenyl
II-(26) 4-acetoxyphenyl
II-(27) 4-benzoyloxyphenyl
II-(28) 4-phenoxycarbonylphenyl
II-(29) 4-methoxyphenyl
II-(30) 4-anilinophenyl
II-(31) 4-isobutyrylaminophenyl
II-(32) 4-phenoxycarbonylaminophenyl
II-(33) 4-(3-ethylureido)phenyl
II-(34) 4-(3,3-diethylureido)phenyl
II-(35) 4-methylphenyl
II-(36) 4-phenoxyphenyl
II-(37) 4-hydroxyphenyl
II-(38) 3,4-diethoxycarbonylphenyl
II-(39) 3,4-dibutoxyphenyl
II-(40) 3,4-diphenylphenyl
II-(41) 3,4-diphenylthiophenyl
II-(42) 3,4-dichlorophenyl
II-(43) 3,4-dibenzoylphenyl
II-(44) 3,4-diacetoxyphenyl
II-(45) 3,4-dibenzoyloxyphenyl
II-(46) 3,4-diphenoxycarbonylphenyl
II-(47) 3,4-dimethoxyphenyl
II-(48) 3,4-dianilinophenyl
II-(49) 3,4-dimethylphenyl
II-(50) 3,4-diphenoxyphenyl
II-(51) 3,4-dihydroxyphenyl
II-(52) 2-naphthyl
II-(53) 3,4,5-triethoxycarbonylphenyl
II-(54) 3,4,5-tributoxyphenyl
II-(55) 3,4,5-triphenylphenyl
II-(56) 3,4,5-triphenylthiophenyl
II-(57) 3,4,5-trichlorophenyl
II-(58) 3,4,5-tribenzoylphenyl
II-(59) 3,4,5-triacetoxyphenyl
II-(60) 3,4,5-tribenzoyloxyphenyl
II-(61) 3,4,5-triphenoxycarbonylphenyl
II-(62) 3,4,5-trimethoxyphenyl
II-(63) 3,4,5-trianilinophenyl
II-(64) 3,4,5-trimethylphenyl
II-(65) 3,4,5-triphenoxyphenyl
II-(66) 3,4,5-trihydroxyphenyl

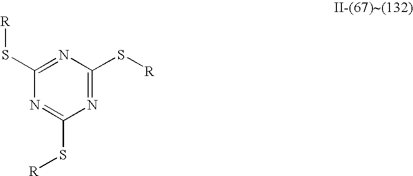

II-(67) phenyl
II-(68) 3-ethoxycarbonylphenyl
II-(69) 3-butoxyphenyl
II-(70) m-biphenylyl
II-(71) 3-phenylthiophenyl
II-(72) 3-chlorophenyl
II-(73) 3-benzoylphenyl
II-(74) 3-acetoxyphenyl
II-(75) 3-benzoyloxyphenyl
II-(76) 3-phenoxycarbonylphenyl
II-(77) 3-methoxyphenyl
II-(78) 3-anilinophenyl
II-(79) 3-isobutyrylaminophenyl
II-(80) 3-phenoxycarbonylaminophenyl
II-(81) 3-(3-ethylureido)phenyl
II-(82) 3-(3,3-diethylureido)phenyl
II-(83) 3-methylphenyl
II-(84) 3-phenoxyphenyl
II-(85) 3-hydroxyphenyl
II-(86) 4-ethoxycarbonylphenyl
II-(87) 4-butoxyphenyl
II-(88) p-biphenylyl
II-(89) 4-phenylthiophenyl
II-(90) 4-chlorophenyl
II-(91) 4-benzoylphenyl
II-(92) 4-acetoxyphenyl
II-(93) 4-benzoyloxyphenyl
II-(94) 4-phenoxycarbonylphenyl
II-(95) 4-methoxyphenyl
II-(96) 4-anilinophenyl
II-(97) 4-isobutyrylaminophenyl
II-(98) 4-phenoxycarbonylaminophenyl
II-(99) 4-(3-ethylureido)phenyl
II-(100) 4-(3,3-diethylureido)phenyl
II-(101) 4-methylphenyl
II-(102) 4-phenoxyphenyl
II-(103) 4-hydroxyphenyl
II-(104) 3,4-diethoxycarbonylphenyl
II-(105) 3,4-dibutoxyphenyl
II-(106) 3,4-diphenylphenyl
II-(107) 3,4-diphenylthiophenyl
II-(108) 3,4-dichlorophenyl
II-(109) 3,4-dibenzoylphenyl
II-(110) 3,4-diacetoxyphenyl
II-(111) 3,4-dibenzoyloxyphenyl
II-(112) 3,4-diphenoxycarbonylphenyl
II-(113) 3,4-dimethoxyphenyl
II-(114) 3,4-dianilinophenyl
II-(115) 3,4-dimethylphenyl
II-(116) 3,4-diphenoxyphenyl
II-(117) 3,4-dihydroxyphenyl
II-(118) 2-naphthyl
II-(119) 3,4,5-triethoxycarbonylphenyl
II-(120) 3,4,5-tributoxyphenyl
II-(121) 3,4,5-triphenylphenyl
II-(122) 3,4,5-triphenylthiophenyl
II-(123) 3,4,5-trichlorophenyl
II-(124) 3,4,5-tribenzoylphenyl
II-(125) 3,4,5-triacetoxyphenyl
II-(126) 3,4,5-tribenzoyloxyphenyl
II-(127) 3,4,5-triphenoxycarbonylphenyl
II-(128) 3,4,5-trimethoxyphenyl
II-(129) 3,4,5-trianilinophenyl
II-(130) 3,4,5-trimethylphenyl
II-(131) 3,4,5-triphenoxyphenyl
II-(132) 3,4,5-trihydroxyphenyl

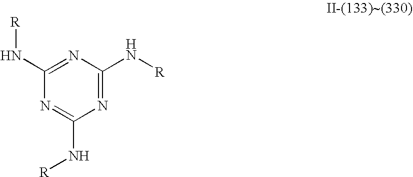

II-(133) phenyl
II-(134) 4-butylphenyl
II-(135) 4-(2-methoxy-2-methoxyethyl)phenyl
II-(136) 4-(5-nonenyl)phenyl
II-(137) p-biphenylyl
II-(138) 4-ethoxycarbonylphenyl
II-(139) 4-butoxyphenyl
II-(140) 4-methylphenyl
II-(141) 4-chlorophenyl
II-(142) 4-phenylthiophenyl
II-(143) 4-benzoylphenyl
II-(144) 4-acetoxyphenyl
II-(145) 4-benzoyloxyphenyl
II-(146) 4-phenoxycarbonylphenyl
II-(147) 4-methoxyphenyl
II-(148) 4-anilinophenyl
II-(149) 4-isobutyrylaminophenyl
II-(150) 4-phenoxycarbonylaminophenyl
II-(151) 4-(3-ethylureido)phenyl
II-(152) 4-(3,3-diethylureido)phenyl
II-(153) 4-phenoxyphenyl
II-(154) 4-hydroxyphenyl
II-(155) 3-butylphenyl
II-(156) 3-(2-methoxy-2-methoxyethyl)phenyl
II-(157) 3-(5-nonenyl)phenyl
II-(158) m-biphenylyl
II-(159) 3-ethoxycarbonylphenyl
II-(160) 3-butoxyphenyl
II-(161) 3-methylphenyl
II-(162) 3-chlorophenyl
II-(163) 3-phenylthiophenyl
II-(164) 3-benzoylphenyl
II-(165) 3-acetoxyphenyl
II-(166) 3-benzoyloxyphenyl
II-(167) 3-phenoxycarbonylphenyl
II-(168) 3-methoxyphenyl
II-(169) 3-anilinophenyl
II-(170) 3-isobutyrylaminophenyl
II-(171) 3-phenoxycarbonylaminophenyl
II-(172) 3-(3-ethylureido)phenyl
II-(173) 3-(3,3-diethylureido)phenyl
II-(174) 3-phenoxyphenyl
II-(175) 3-hydroxyphenyl
II-(176) 2-butylphenyl
II-(177) 2-(2-methoxy-2-methoxyethyl)phenyl
II-(178) 2-(5-nonenyl)phenyl
II-(179) o-biphenylyl
II-(180) 2-ethoxycarbonylphenyl
II-(181) 2-butoxyphenyl
II-(182) 2-methylphenyl
II-(183) 2-chlorophenyl
II-(184) 2-phenylthiophenyl
II-(185) 2-benzoylphenyl
II-(186) 2-acetoxyphenyl
II-(187) 2-benzoyloxyphenyl
II-(188) 2-phenoxycarbonylphenyl
II-(189) 2-methoxyphenyl
II-(190) 2-anilinophenyl
II-(191) 2-isobutyrylaminophenyl
II-(192) 2-phenoxycarbonylaminophenyl
II-(193) 2-(2-ethylureido)phenyl
II-(194) 2-(2,2-diethylureido)phenyl
II-(195) 2-phenoxyphenyl
II-(196) 2-hydroxyphenyl
II-(197) 3,4-dibutylphenyl
II-(198) 3,4-di(2-methoxy-2-ethoxyethyl)phenyl
II-(199) 3,4-diphenylphenyl
II-(200) 3,4-diethoxycarbonylphenyl
II-(201) 3,4-didodecyloxyphenyl
II-(202) 3,4-dimethylphenyl
II-(203) 3,4-dichlorophenyl
II-(204) 3,4-dibenzoylphenyl
II-(205) 3,4-diacetoxyphenyl
II-(206) 3,4-dimethoxyphenyl
II-(207) 3,4-di-N-methylaminophenyl
II-(208) 3,4-diisobutyrylaminophenyl
II-(209) 3,4-diphenoxyphenyl
II-(210) 3,4-dihydroxyphenyl
II-(211) 3,5-dibutylphenyl
II-(212) 3,5-di(2-methoxy-2-ethoxyethyl)phenyl
II-(213) 3,5-diphenylphenyl
II-(214) 3,5-diethoxycarbonylphenyl
II-(215) 3,5-didodecyloxyphenyl
II-(216) 3,5-dimethylphenyl
II-(217) 3,5-dichlorophenyl
II-(218) 3,5-dibenzoylphenyl
II-(219) 3,5-diacetoxyphenyl
II-(220) 3,5-dimethoxyphenyl
II-(221) 3,5-di-N-methylaminophenyl
II-(222) 3,5-diisobutyrylaminophenyl
II-(223) 3,5-diphenoxyphenyl
II-(224) 3,5-dihydroxyphenyl
II-(225) 2,4-dibutylphenyl
II-(226) 2,4-di(2-methoxy-2-ethoxyethyl)phenyl
II-(227) 2,4-diphenylphenyl
II-(228) 2,4-diethoxycarbonylphenyl
II-(229) 2,4-didodecyloxyphenyl
II-(230) 2,4-dimethylphenyl
II-(231) 2,4-dichlorophenyl
II-(232) 2,4-dibenzoylphenyl
II-(233) 2,4-diacetoxyphenyl
II-(234) 2,4-dimethoxyphenyl
II-(235) 2,4-di-N-methylaminophenyl
II-(236) 2,4-diisobutyrylaminophenyl
II-(237) 2,4-diphenoxyphenyl
II-(238) 2,4-dihydroxyphenyl
II-(239) 2,3-dibutylphenyl
II-(240) 2,3-di(2-methoxy-2-ethoxyethyl)phenyl
II-(241) 2,3-diphenylphenyl
II-(242) 2,3-diethoxycarbonylphenyl
II-(243) 2,3-didodecyloxyphenyl
II-(244) 2,3-dimethylphenyl
II-(245) 2,3-dichlorophenyl
II-(246) 2,3-dibenzoylphenyl
II-(247) 2,3-diacetoxyphenyl
II-(248) 2,3-dimethoxyphenyl
II-(249) 2,3-di-N-methylaminophenyl
II-(250) 2,3-diisobutyrylaminophenyl
II-(251) 2,3-diphenoxyphenyl
II-(252) 2,3-dihydroxyphenyl
II-(253) 2,6-dibutylphenyl
II-(254) 2,6-di(2-methoxy-2-ethoxyethyl)phenyl
II-(255) 2,6-diphenylphenyl
II-(256) 2,6-diethoxycarbonylphenyl
II-(257) 2,6-didodecyloxyphenyl
II-(258) 2,6-dimethylphenyl
II-(259) 2,6-dichlorophenyl
II-(260) 2,6-dibenzoylphenyl
II-(261) 2,6-diacetoxyphenyl
II-(262) 2,6-dimethoxyphenyl
II-(263) 2,6-di-N-methylaminophenyl
II-(264) 2,6-diisobutyrylaminophenyl
II-(265) 2,6-diphenoxyphenyl
II-(266) 2,6-dihydroxyphenyl
II-(267) 3,4,5-tributylphenyl
II-(268) 3,4,5-tri(2-methoxy-2-ethoxyethyl)phenyl
II-(269) 3,4,5-triphenylphenyl
II-(270) 3,4,5-triethoxycarbonylphenyl
II-(271) 3,4,5-tridecyloxyphenyl
II-(272) 3,4,5-trimethylphenyl
II-(273) 3,4,5-trichlorophenyl
II-(274) 3,4,5-tribenzoylphenyl
II-(275) 3,4,5-triacetoxyphenyl
II-(276) 3,4,5-trimethoxyphenyl
II-(277) 3,4,5-tri-N-methylaminophenyl
II-(278) 3,4,5-triisobutyrylaminophenyl
II-(279) 3,4,5-triphenoxyphenyl
II-(280) 3,4,5-trihydroxyphenyl
II-(281) 2,4,6-tributylphenyl
II-(282) 2,4,6-tri(2-methoxy-2-ethoxyethyl)phenyl
II-(283) 2,4,6-triphenylphenyl
II-(284) 2,4,6-triethoxycarbonylphenyl
II-(285) 2,4,6-tridecyloxyphenyl
II-(286) 2,4,6-trimethylphenyl
II-(287) 2,4,6-trichlorophenyl
II-(288) 2,4,6-tribenzoylphenyl
II-(289) 2,4,6-triacetoxyphenyl
II-(290) 2,4,6-trimethoxyphenyl
II-(291) 2,4,6-tri-N-methylaminophenyl
II-(292) 2,4,6-triisobutyrylaminophenyl
II-(293) 2,4,6-triphenoxyphenyl
II-(294) 2,4,6-trihydroxyplhenyl
II-(295) pentafluorophenyl
II-(296) pentachlorophenyl
II-(297) pentamethoxyphenyl
II-(298) 6-N-methylsulfamoyl-8-methoxy-2-naphthyl
II-(299) 5-N-methylsulfamoyl-2-naphthyl
II-(300) 6-N-phenyl sulfamoyl-2-naphthyl
II-(301) 5-ethoxy-7-N-methylsulfamoyl-2-naphthyl
II-(302) 3-methoxy-2-naphthyl
II-(303) 1-ethoxy-2-naphthyl
II-(304) 6-N-phenylsulfamoyl-8-methoxy-2-naphthyl
II-(305) 5-methoxy-7-N-phenylsulfamoyl-2-naphthyl
II-(306) 1-(4-methylphenyl)-2-naphthyl
II-(307) 6,8-di-N-methylsulfamoyl-2-naphthyl
II-(308) 6-N-2-acetoxyethylsulfamoyl-8-methoxy-2-naphthyl
II-(309) 5-acetoxy-7-N-phenylsulfamoyl-2-naphthyl
II-(310) 3-benzoyloxy-2-naphthyl
II-(311) 5-acetylamino-1-naphthyl
II-(312) 2-methoxy-1-naphthyl
II-(313) 4-phenoxy-1-naphthyl
II-(314) 5-N-methylsulfamoyl-1-naphthyl
II-(315) 3-N-methylcarbamoyl-4-hydroxy-1-naphthyl
II-(316) 5-methoxy-6-N-ethylsulfamoyl-1-naphthyl
II-(317) 7-tetradecyloxy-1-naphthyl
II-(318) 4-(4-methylphenoxy)-1-naphthyl
II-(319) 6-N-methylsulfamoyl-1-naphthyl
II-(320) 3-N,N-dimethylcarbamoyl-4-methoxy-1-naphthyl
II-(321) 5-methoxy-6-N-benzylsulfamoyl-1-naphthyl
II-(322) 3,6-di-N-phenylsulfamoyl-1-naphthyl
II-(323) methyl
II-(324) ethyl
II-(325) butyl
II-(326) octyl
II-(327) dodecyl
II-(328) 2-butoxy-2-ethoxyethyl
II-(329) benzyl
II-(330) 4-methoxybenzyl

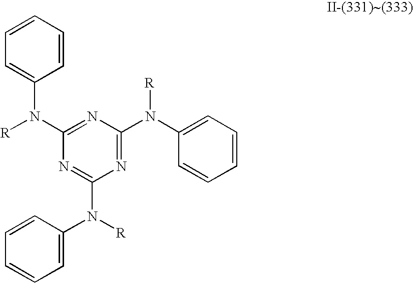

II-(331) methyl
II-(332) phenyl
II-(333) butyl
II-(334) a compound of the following chemical formula

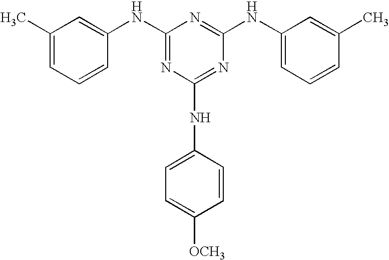

As hereunder, the compound represented by the formula (III) will be illustrated.

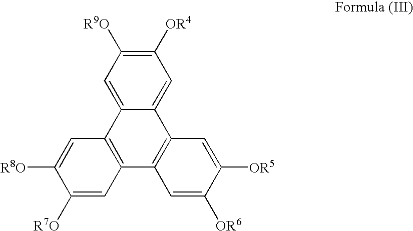

In the formula, R⁴, R⁵, R⁶, R⁷, R⁸ and R⁹ each independently represents a hydrogen atom or a substituent.

Each substituent represented by R⁴, R⁵, R⁶, R⁷, R⁸ and R⁹ includes an alkyl group (an alkyl group having preferably 1 to 40 carbon(s), more preferably 1 to 30 carbon(s) and, particularly preferably, 1 to 20 carbon(s) such as methyl group, ethyl group, isopropyl group, tert-butyl group, n-octyl group, n-decyl group, n-hexadecyl group, cyclopropyl group, cyclopentyl group and cyclohexyl group), an alkenyl group (an alkenyl group having preferably 2 to 40 carbons, more preferably 2 to 30 carbons and, particularly preferably, 2 to 20 carbons such as vinyl group, allyl group, 2-butenyl group and 3-pentenyl group), an alkynyl group (an alkynyl group having preferably 2 to 40 carbons, more preferably 2 to 30 carbons and, particularly preferably, 2 to 20 carbons such as propargyl group and 3-pentynyl group), an aryl group (an aryl group having preferably 6 to 30 carbons, more preferably 6 to 20 carbons and, particularly preferably, 6 to 12 carbons such as phenyl group, p-methylphenyl group and naphthyl group), a substituted or unsubstituted amino group (an amino group having preferably 0 to 40 carbon(s), more preferably 0 to 30 carbon(s) and, particularly preferably, 0 to 20 carbon(s) such as an unsubstituted amino group, methylamino group, dimethylamino group, diethylamino group and aniline group),

an alkoxy group (an alkoxy group having preferably 1 to 40 carbon(s), more preferably 1 to 30 carbon(s) and, particularly preferably, 1 to 20 carbon(s) such as methoxy group, ethoxy group and butoxy group), an arylthio group (an arylthio group having preferably 6 to 40 carbons, more preferably 6 to 30 carbons and, particularly preferably, 6 to 20 carbons such as phenyloxy group and 2-naphthyloxy group), an acyl group (an acyl group having preferably 1 to 40 carbon(s), more preferably 1 to 30 carbon(s) and, particularly preferably, 1 to 20 carbon(s) such as acetyl group, benzoyl group, formyl group and pivaloyl group), an alkoxycarbonyl group (an alkoxycarbonyl group having preferably 2 to 40 carbons, more preferably 2 to 30 carbons and, particularly preferably, 2 to 20 carbons such as methoxycarbonyl group and ethoxycarbonyl group), an aryloxycarbonyl group (an aryloxycarbonyl group having preferably 7 to 40 carbons, more preferably 7 to 30 carbons and, particularly preferably, 7 to 20 carbons such as phenyloxycarbonyl group), an acyloxy group (an acyloxy group having preferably 2 to 40 carbons, more preferably 2 to 30 carbons and, particularly preferably, 2 to 20 carbons such as acetoxy group and benzoyloxy group),

an acylamino group (an acylamino group having preferably 2 to 40 carbons, more preferably 2 to 30 carbons and, particularly preferably, 2 to 20 carbons such as acetylamino group and benzoylamino group), an alkoxycarbonylamino group (an alkoxycarbonylamino group having preferably 2 to 40 carbons, more preferably 2 to 30 carbons and, particularly preferably, 2 to 20 carbons such as methoxycarbonylamino group), an aryloxycarbonylamino group (an aryloxycarbonylamino group having preferably 7 to 40 carbons, more preferably 7 to 30 carbons and, particularly preferably, 7 to 20 carbons such as phenyloxycarbonylamino group), a sulfonylamino group (a sulfonylamino group having preferably 1 to 40 carbon(s), more preferably 1 to 30 carbon(s) and, particularly preferably, 1 to 20 carbon(s) such as methanesulfonylamino group and benzenesulfonylamino group, a sulfamoyl group (a sulfamoyl group having preferably 0 to 40 carbon(s), more preferably 0 to 30 carbon(s) and, particularly preferably, 0 to 20 carbon(s) such as sulfamoyl group, methylsulfamoyl group, dimethylsulfamoyl group and phenylsulfamoyl group), a carbamoyl group (a carbamoyl group having preferably 1 to 40 carbon(s), more preferably 1 to 30 carbon(s) and, particularly preferably, 1 to 20 carbon(s) such as an unsubstituted carbamoyl group, methylcarbamoyl group, diethylcarbamoyl group and phenylcarbamoyl group),

an alkylthio group (having preferably 1 to 40 carbon(s), more preferably 1 to 30 carbon(s) and, particularly preferably, 1 to 20 carbon(s) such as phenylthio group), a sulfonyl group (a sulfonyl group having preferably 1 to 40 carbon(s), more preferably 1 to 30 carbon(s) and, particularly preferably, 1 to 20 carbon(s) such as mesyl group and tosyl group), a sulfinyl group (a sulfinyl group having preferably 1 to 40 carbon(s), more preferably 1 to 30 carbon(s) and, particularly preferably, 1 to 20 carbon(s) such as methanesulfinyl group and benzenesulfinyl group), a ureido group (a ureido group having preferably 1 to 40 carbon(s), more preferably 1 to 30 carbon(s) and, particularly preferably, 1 to 20 carbon(s) such as an unsubstituted ureido group, methylureido group and phenylureido group), a phosphoric acid amide group (a phosphoric acid amide group having preferably 1 to 40 carbon(s), more preferably 1 to 30 carbon(s) and, particularly preferably, 1 to 20 carbon(s) such as diethylphosphoric acid amide group and phenylphosphoric acid amide group), hydroxyl group, mercapto group, halogen atom (such as fluorine atom, chlorine atom, bromine atom and iodine atom), cyano group, sulfo group, carboxyl group, nitro group, hydroxamic acid group, sulfino group, hydrazine group, imino group, a heterocyclic group (a heterocyclic group having preferably 1 to 30 carbon(s) and, more preferably, 1 to 12 carbon(s) such as a heterocyclic group having hetero atom such as nitrogen atom, oxygen atom and sulfur atom and its examples are imidazolyl group, pyridyl group, quinolyl group, furyl group, piperidyl group, morpholine group, benzoxazolyl group, benzimidazolyl group, benzthiazolyl group and 1,3,5-triazyl group) and a silyl group (a silyl group having preferably 3 to 40 carbons, more preferably 3 to 30 carbons and, particularly preferably, 3 to 24 carbons such as trimethylsilyl group and triphenylsilyl group). The substituent as such may be further substituted with such a substituent. When there are two or more substituents, they may be same or different. In case it is possible, they may be bonded each other to form a ring.

Preferred substituent represented by each of R⁴, R⁵, R⁶, R⁷, R⁸ and R⁹ is an alkyl group, an aryl group, a substituted or unsubstituted amino group, an alkoxy group, an alkylthio group or a halogen atom.

Specific examples of the compound represented by the formula (III) are as follows although they are non-limitative.

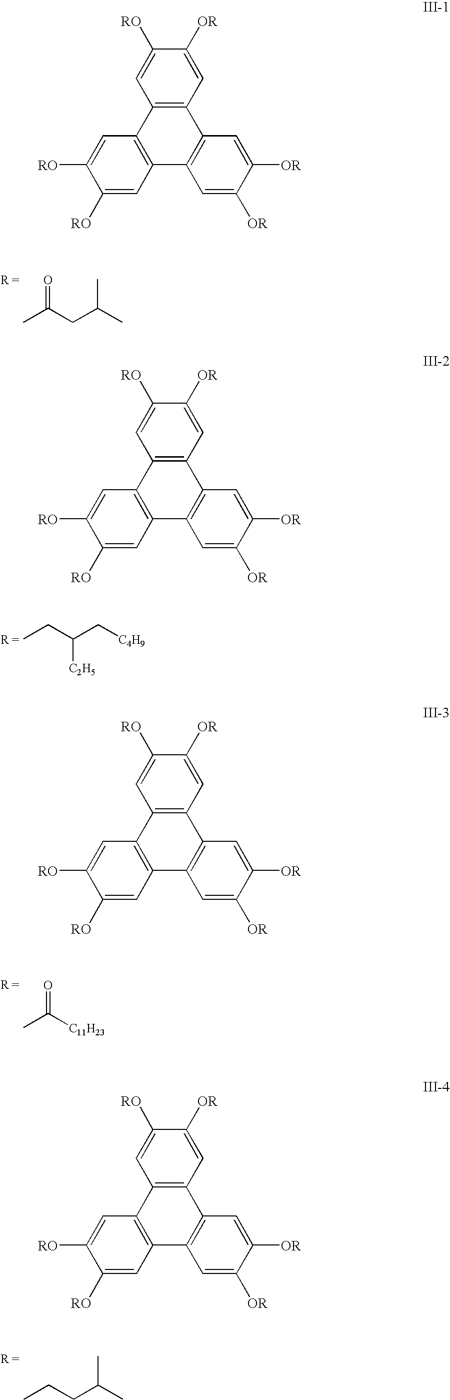

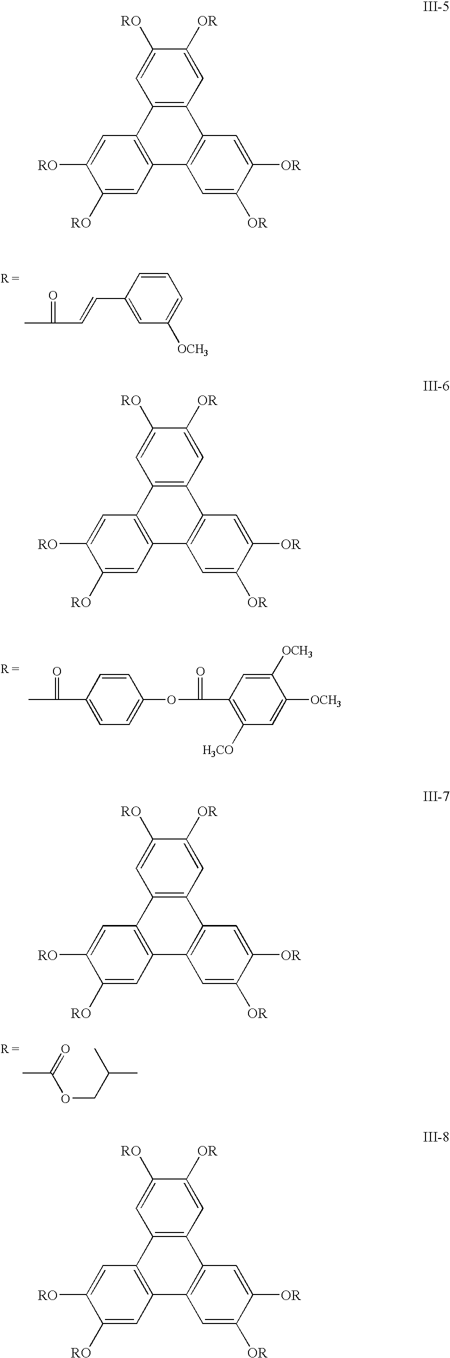

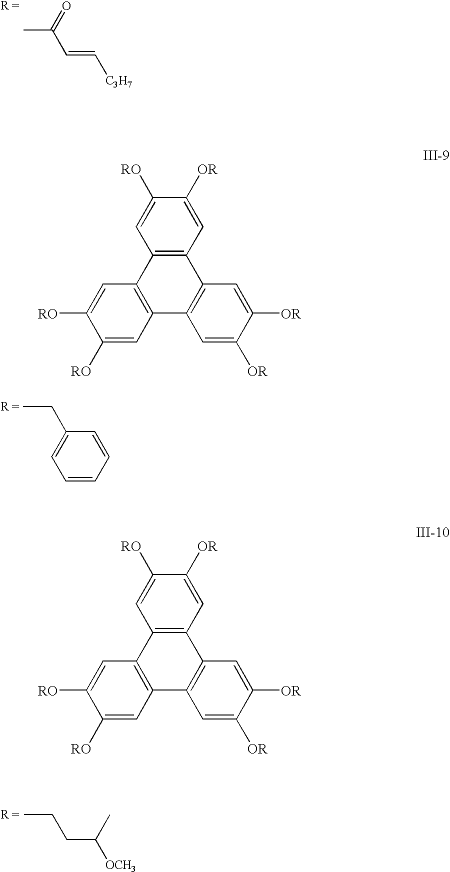

Now, the compound represented by the formula (IV) will be illustrated.

Q⁷¹-Q⁷²-OH Formula (IV)

(In the formula, Q⁷¹ is a nitrogen-containing aromatic hetero ring and Q⁷² is an aromatic ring.)

In the formula (IV), Q⁷¹ is a nitrogen-containing aromatic hetero ring and it is, preferably, a five- to seven-membered nitrogen-containing aromatic hetero ring and, more preferably, a five- to six-membered nitrogen-containing aromatic hetero ring.

Examples of the preferred nitrogen-containing aromatic hetero ring are rings such as imidazole, pyrazole, triazole, tetrazole, thiazole, oxazole, selanazole, benzotriazole, benzothiazole, benzoxazole, benzoselanazole, thiadiazole, oxadiazole, naphthothiazole, naphthoxazole, azabenzimidazole, purine, pyridine, pyrazine, pyrimidine, pyridazine, triazine, triazaindene and tetrazaindene and more preferred ones are triazine and a five-membered nitrogen-containing aromatic hetero ring. To be more specific, preferred rings are 1,3,5-triazine, imidazole, pyrazole, triazole, tetrazole, thiazole, oxazole, benzotriazole, benzothiazole, benzoxazole, thiadiazole and oxadiazole and particularly preferred ones are 1,3,5-triazine ring and benzotriazine ring.

The nitrogen-containing aromatic hetero ring represented by Q⁷¹ may have further substituent and, with regard to the substituent, a substituent T which will be mentioned later will be applied. When there are plural substituents, they may be fused to form a ring.

Q⁷² is an aromatic ring. The aromatic ring represented by Q⁷² may be an aromatic hydrocarbon ring or an aromatic hetero ring. That may be a monocyclic ring or may form a fused ring with other ring. With regard to the aromatic hydrocarbon ring, it is preferably a monocyclic or bicyclic aromatic hydrocarbon ring having 6 to 30 carbons (such as benzene ring and naphthalene ring), more preferably an aromatic hydrocarbon ring having 6 to 20 carbons and, still more preferably, an aromatic hydrocarbon ring having 6 to 12 carbons. Further preferably, it is benzene ring.

With regard to an aromatic hetero ring, it is preferably an aromatic hetero ring containing nitrogen atom or sulfur atom. Specific examples of the hetero ring are thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzthiazole, benzotriazole and tetrazaindene. Preferred aromatic hetero ring is pyridine, triazine or quinoline.

With regard to an aromatic ring represented by Q⁷², it is preferably an aromatic hydrocarbon ring, more preferably naphthalene ring and benzene ring and, particularly preferably, benzene ring. Q⁷² may further have a substituents and the following substituent T is preferred.

Examples of the substituent T are an alkyl group (having preferably 1 to 20, more preferably 1 to 12 and, particularly preferably, 1 to 8 carbon(s) such as methyl group, ethyl group, isopropyl group, tert-butyl group, n-octyl group, n-decyl group, n-hexadecyl group, cyclopropyl group, cyclopentyl group and cyclohexyl group), an alkenyl group (having preferably 2 to 20, more preferably 2 to 12 and, particularly preferably, 2 to 8 carbons such as vinyl group, allyl group, 2-butenyl group and 3-pentenyl group), an alkynyl group (having preferably 2 to 20, more preferably 2 to 12 and, particularly preferably, 2 to 8 carbons such as propargyl group and 3-pentynyl group), an aryl group (having preferably 6 to 30, more preferably 6 to 20 and, particularly preferably, 6 to 12 carbons such as phenyl group, biphenyl group and naphthyl group), an amino group (having preferably 0 to 20, more preferably 0 to 10 and, particularly preferably, 0 to 6 carbon(s) such as amino group, methylamino group, dimethylamino group, diethylamino group and dibenzylamino group), an alkoxy group (having preferably 1 to 20, more preferably 1 to 12 and, particularly preferably, 1 to 8 carbon(s) such as methoxy group, ethoxy group and butoxy group), an aryloxy group (having preferably 6 to 20, more preferably 6 to 16 and, particularly preferably, 6 to 12 carbons such as phenyloxy group and 2-naphthyloxy group), an acyl group (having preferably 1 to 20, more preferably 1 to 16 and, particularly preferably, 1 to 12 carbon(s) such as acetyl group, benzoyl group, formyl group and pivaloyl group), an alkoxycarbonyl group (having preferably 2 to 20, more preferably 2 to 16 and, particularly preferably, 2 to 12 carbons such as methoxycarbonyl group and ethoxycarbonyl group), an aryloxycarbonyl group (having preferably 7 to 20, more preferably 7 to 16 and, particularly preferably, 7 to 10 carbons such as phenyloxycarbonyl group), an acyloxy group (having preferably 2 to 20, more preferably 2 to 16 and, particularly preferably, 2 to 10 carbons such as acetoxy group and benzoyloxy group),

an acylamino group (having preferably 2 to 20, more preferably 2 to 16 and, particularly preferably, 2 to 10 carbons such as acetylamino group and benzoylamino group), an alkoxycarbonylamino group (having preferably 2 to 20, more preferably 2 to 16 and, particularly preferably, 2 to 12 carbons such as methoxycarbonylamino group), an aryloxycarbonylamino group (having preferably 7 to 20, more preferably 7 to 16 and, particularly preferably, 7 to 12 carbons such as phenyloxycarbonylamino group), a sulfonylamino group (having preferably 1 to 20, more preferably 1 to 16 and, particularly preferably, 1 to 12 carbon(s) such as methanesulfonylamino group and benzenesulfonylamino group), a sulfamoyl group (having preferably 0 to 20, more preferably 0 to 16 and, particularly preferably, 0 to 12 carbon(s) such as sulfamoyl group, methylsulfamoyl group, dimethylsulfamoyl group and phenylsulfamoyl group), a carbamoyl group (having preferably 1 to 20, more preferably 1 to 16 and, particularly preferably, 1 to 12 carbon(s) such as carbamoyl group, methylcarbamoyl group, diethylcarbamoyl group and phenylcarbamoyl group), an alkylthio group (having preferably 1 to 20, more preferably 1 to 16 and, particularly preferably, 1 to 12 carbon(s) such as methylthio group and ethylthio group), an arylthio group (having preferably 6 to 20, more preferably 6 to 16 and, particularly preferably, 6 to 12 carbons such as phenylthio group), a sulfonyl group (having preferably 1 to 20, more preferably 1 to 16 and, particularly preferably, 1 to 12 carbon(s) such as mesyl group and tosyl group), a sulfinyl group (having preferably 1 to 20, more preferably 1 to 16 and, particularly preferably, 1 to 12 carbon(s) such as methanesulfinyl group and benzenesulfinyl group), a ureido group (having preferably 1 to 20, more preferably 1 to 16 and, particularly preferably, 1 to 12 carbons such as ureido group, methylureido group and phenylureido group), a phosphoric acid amide group (having preferably 1 to 20, more preferably 1 to 16 and, particularly preferably, 1 to 12 carbon(s) such as diethylphosphoric acid amide and phenylphosphoric acid amide),

hydroxyl group, mercapto group, halogen atom (such as fluorine atom, chlorine atom, bromine atom and iodine atom), cyano group, sulfo group, carboxyl group, nitro group, hydroxamic acid group, sulfino group, hydrazine group, imino group, heterocyclic group (having preferably 1 to 30 and, more preferably, 1 to 12 carbon(s) where examples of the hetero atom are nitrogen atom, oxygen atom and sulfur atom and, to be more specific, such as imidazolyl group, pyridyl group, quinolyl group, furyl group, piperidyl group, morpholine group, benzoxazolyl group, benzimidazolyl group and benzthiazolyl group) and a silyl group (having preferably 3 to 40, more preferably 3 to 30 and, particularly preferably, 3 to 24 carbons such as trimethylsilyl group and triphenylsilyl group).

The substituent as such may be further substituted. When there are two or more substituents, they may be same or different. If it is possible, they may be connected each other to form a ring.

Specific examples of the compound represented by the formula (IV) are shown as hereunder although the present invention is not limited to the following specific examples at all.

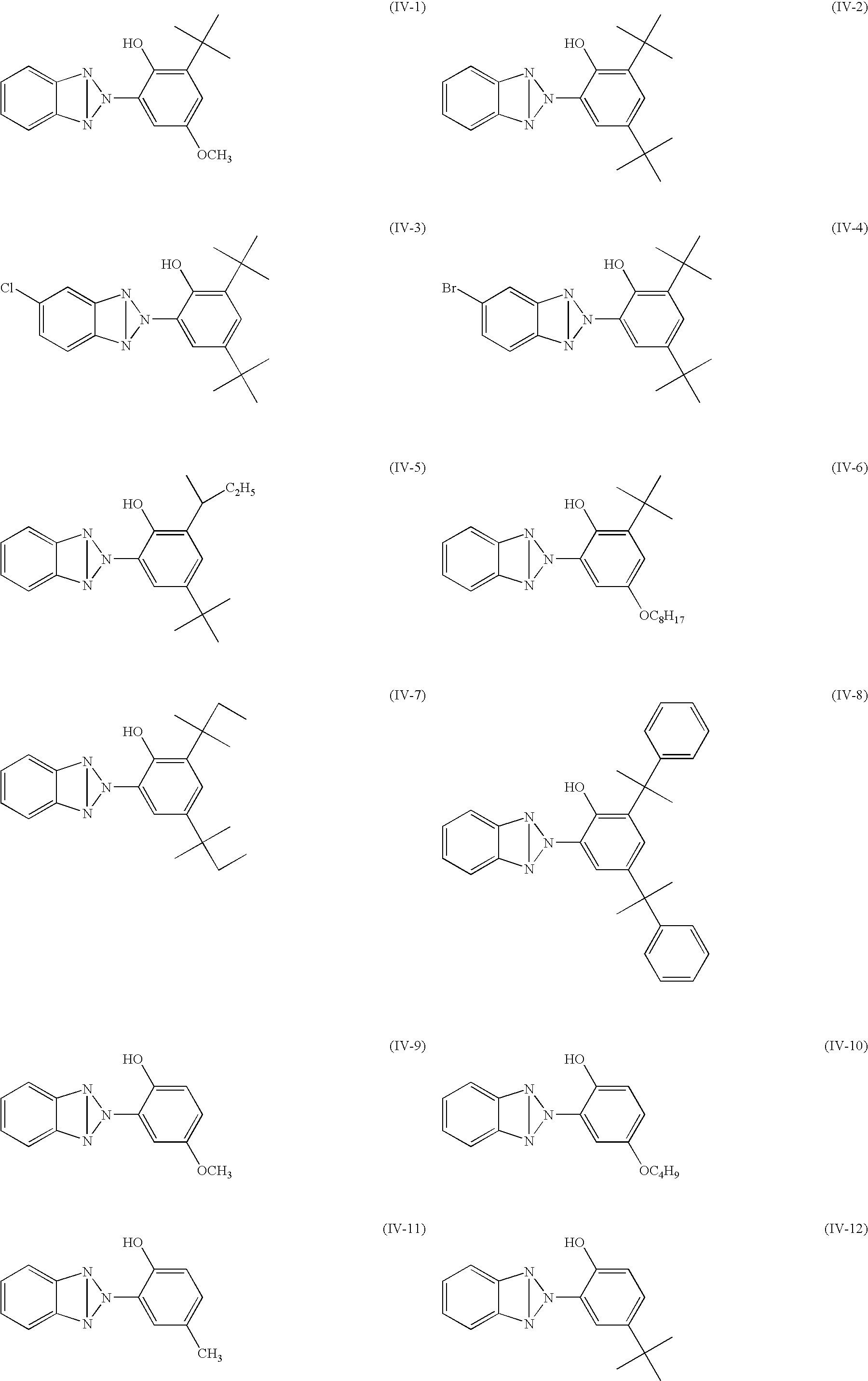

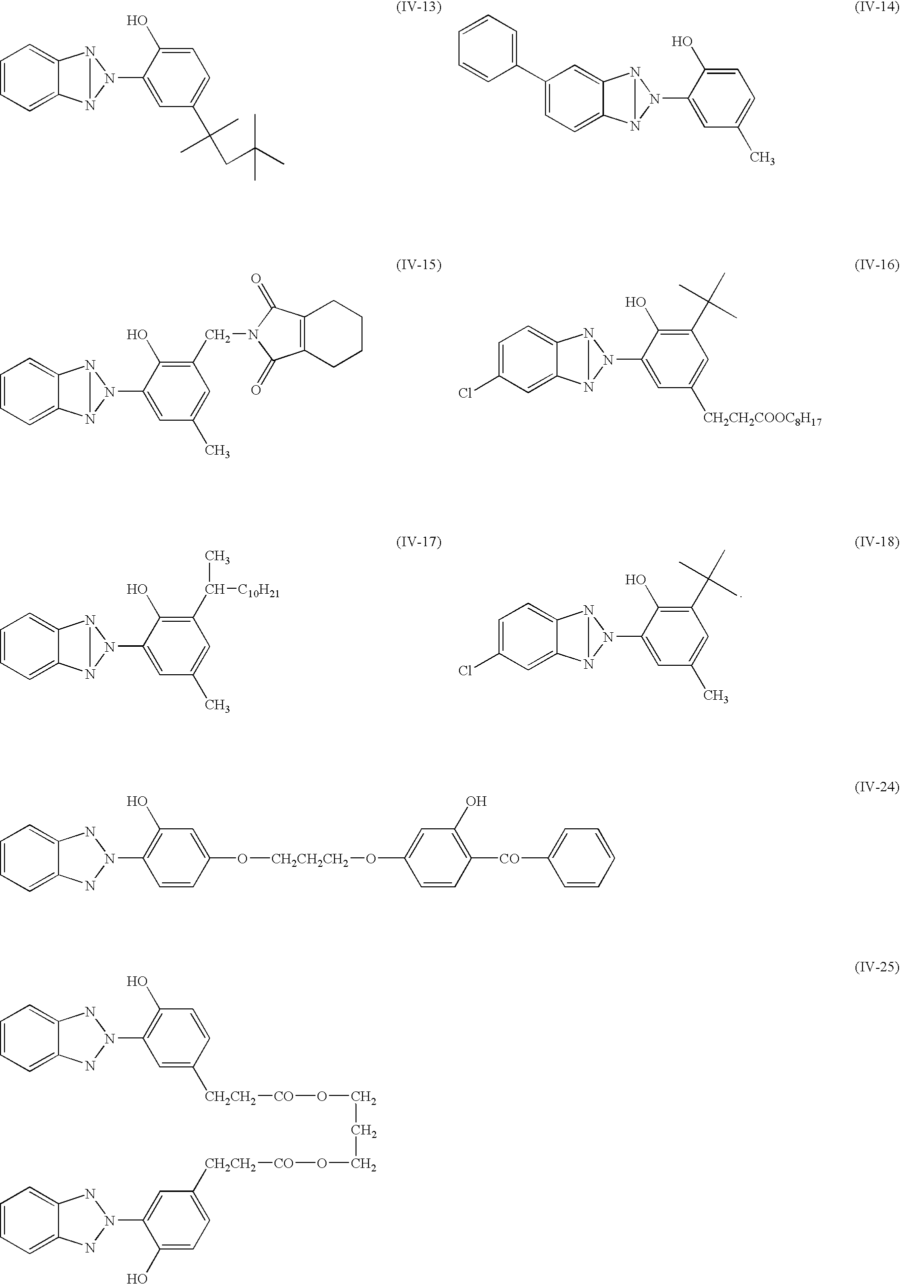

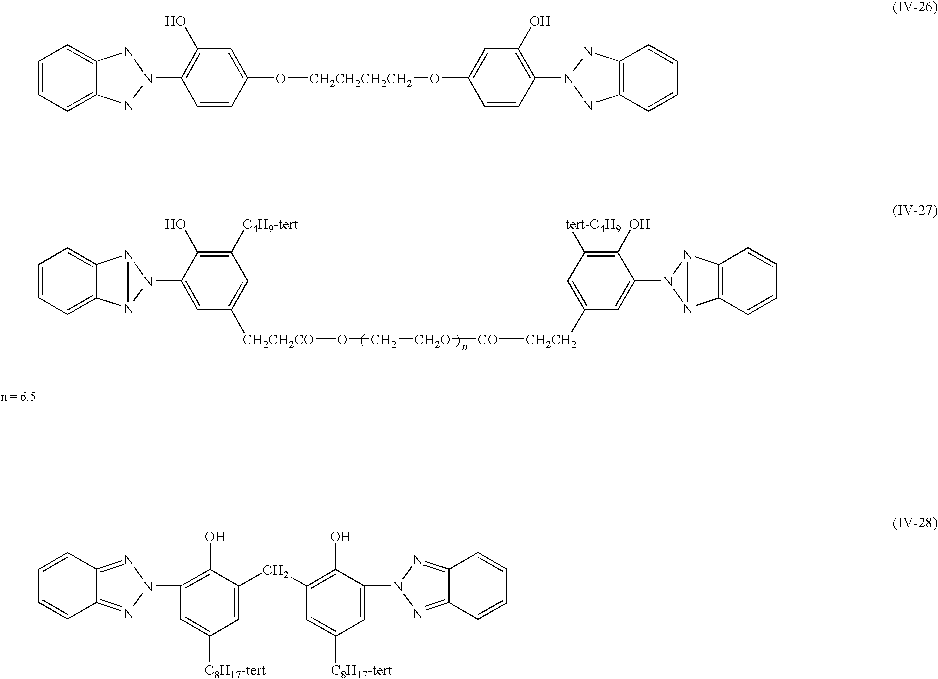

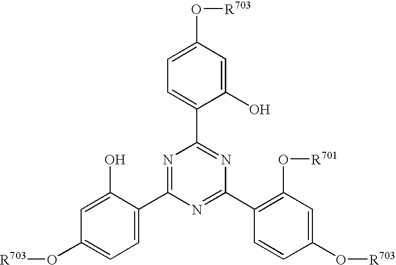

TABLE 3

| Compound | | |
|---|---|---|
| No. | R⁷⁰³ | R⁷⁰¹ |
| IV-29 | —CH₂CH(OH)CH₂OC₄H₉(-n) | —CH₃ |
| IV-30 | —CH₂CH(OH)CH₂OC₄H₉(-n) | —C₂H₅ |
| IV-31 | R⁷⁰³═R⁷⁰¹: —CH₂CH(OH)CH₂OC₄H₉(-n) | |
| IV-32 | —CH(CH₃)—CO—O—C₂H₅ | —C₂H₅ |
| IV-33 | R⁷⁰³═R⁷⁰¹: —CH(CH₃)—CO—C₂H₅ | |
| IV-34 | —C₂H₅ | —C₂H₅ |
| IV-35 | —CH₂CH(OH)CH₂OC₄H₉(-n) | —CH(CH₃)₂ |
| IV-36 | —CH₂CH(OH)CH₂OC₄H₉(-n) | —CH(CH₃)—C₂H₅ |
| IV-37 | R⁷⁰³═R⁷⁰¹: —CH₂CH(C₂H₅)—C₄H₉(-n) | |
| IV-38 | —C₈H₁₇(-n) | —C₈H₁₇(-n) |
| IV-39 | —C₃H₇(-n) | —C₃H₇(-n) |
| IV-40 | —C₃H₇(-i) | —C₂H₅ |
| IV-41 | —C₄H₉(-n) | —CH₃ |
| IV-42 | —C₄H₉(-n) | —C₂H₅ |
| IV-43 | —C₄H₉(-n) | —C₄H₉(-n) |
| IV-44 | —CH₂CH(CH₃)₂ | —CH₂CH(CH₃)₂ |
| IV-45 | —C₆H₁₃(-n) | —C₂H₅ |
| IV-46 | —C₈H₁₇(-n) | —CH₃ |
| IV-47 | —CH₂CH₂CH(CH₃)₂ | —CH₂CH₂CH(CH₃)₂ |
| IV-48 | —C₅H₁₁(-n) | —C₅H₁₁(-n) |
| IV-49 | —CH₂—CO—O—C₂H₅ | —CH₂—CO—O—C₂H₅ |

Now, the compound represented by the formula (V) will be illustrated.

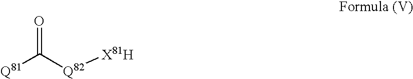

{In the formula (V), Q⁸¹ and Q⁸² each independently represents an aromatic ring; and X⁸¹ is NR⁸¹ (where R⁸¹ is hydrogen atom or a substituent), oxygen atom or sulfur atom.}

With regard to an aromatic hydrocarbon ring represented by Q⁸¹ and Q⁸², a preferred one is a monocyclic or bicyclic aromatic hydrocarbon having 6 to 30 carbons (such as benzene ring and naphthalene ring), more preferred one is an aromatic hydrocarbon ring having 6 to 20 carbons, still more preferred one is an aromatic hydrocarbon ring having 6 to 12 carbons and particularly preferred one is benzene ring.

With regard to an aromatic hetero ring represented by Q⁸¹ and Q⁸², preferred one is an aromatic hetero ring having at least one of oxygen atom, nitrogen atom or sulfur atom. Specific examples of the aromatic hetero ring are furan, pyrrole, thiophene, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylidine, quinoxaline, quinazoline, cinnoline, pteridine, acridine, phenanthroline, phenazine, tetrazole, benzimidazole, benzoxazole, benzthiazole, benzotriazole and tetrazaindene. Preferred aromatic hetero ring is pyridine ring, triazine ring and quinoline ring.

With regard to an aromatic ring represented by Q⁸¹ and Q⁸², preferred one is an aromatic hydrocarbon ring, more preferred one is an aromatic hydrocarbon ring having 6 to 10 carbons and more preferred one is a substituted or unsubstituted benzene ring.

Q⁸¹ and Q⁸² may further have a substituent and, although the substituent is preferred to be the above-mentioned substituent T, the substituent does not include carboxylic acid, sulfonic acid and quaternary ammonium salt. If possible, substituents may be connected each other to form a ring structure.

X⁸¹ is NR⁸¹ (where R⁸¹ is hydrogen atom or a substituent and, with regard to the substituent, the above-mentioned substituent T is able to be applied), oxygen atom or sulfur atom. With regard to X⁸¹, it is preferably NR⁸¹ (where R⁸¹ is preferably an acyl group or a sulfonyl group and the substituent as such may be further substituted) or oxygen atom and, particularly preferably, oxygen atom.

As hereunder, specific examples of the compound represented by the formula (V) is shown although the present invention is not limited to the following specific examples at all.

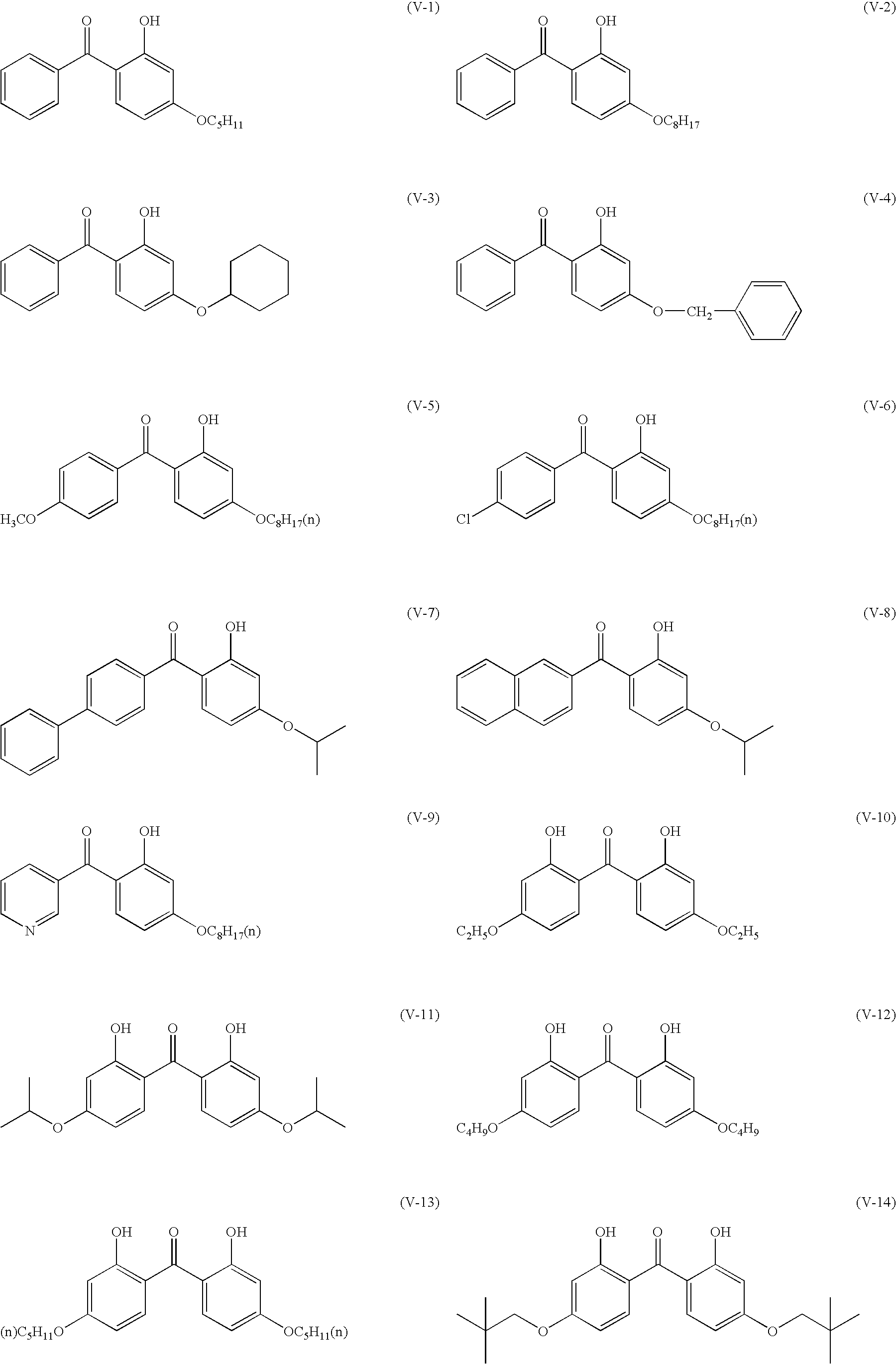

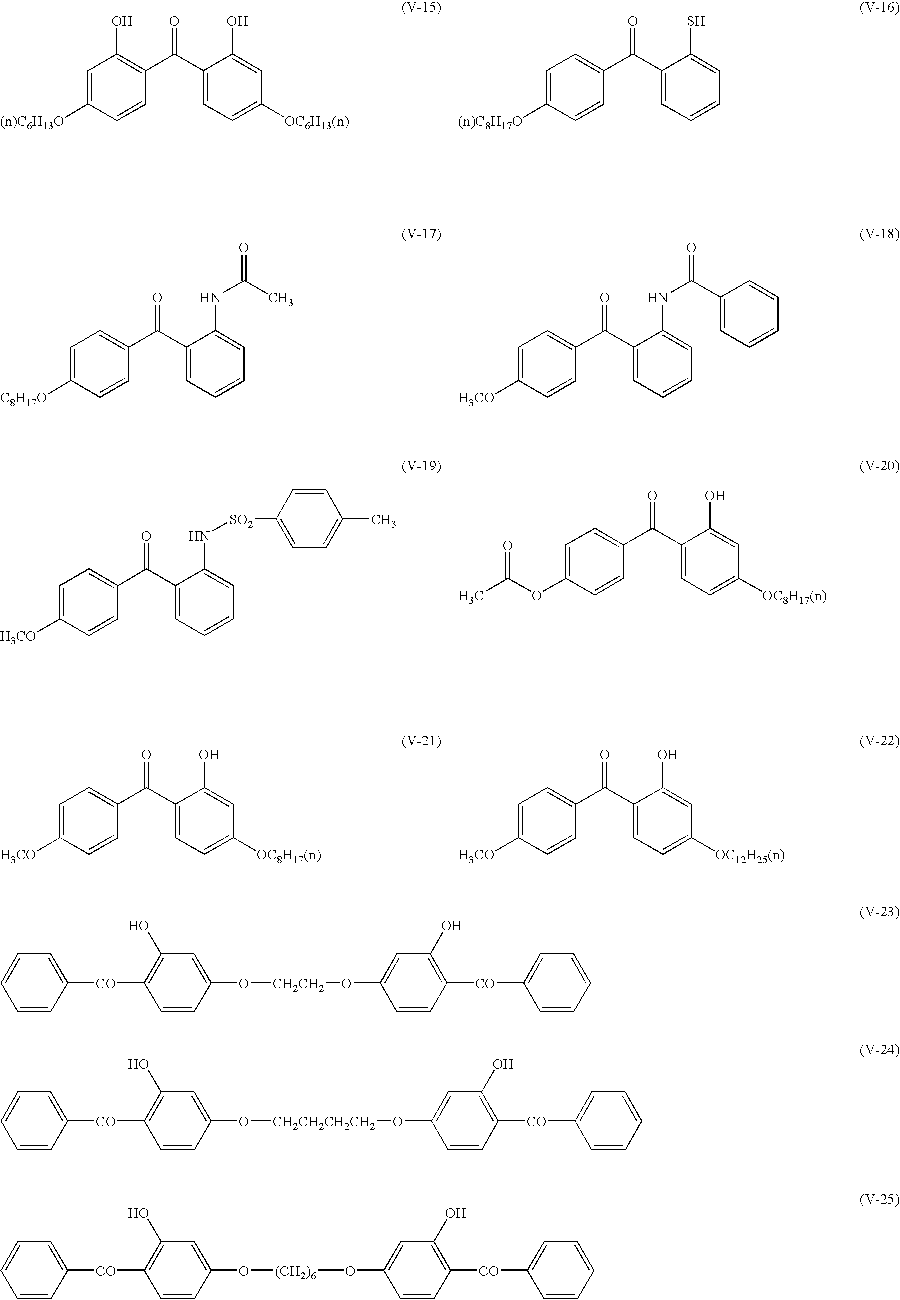

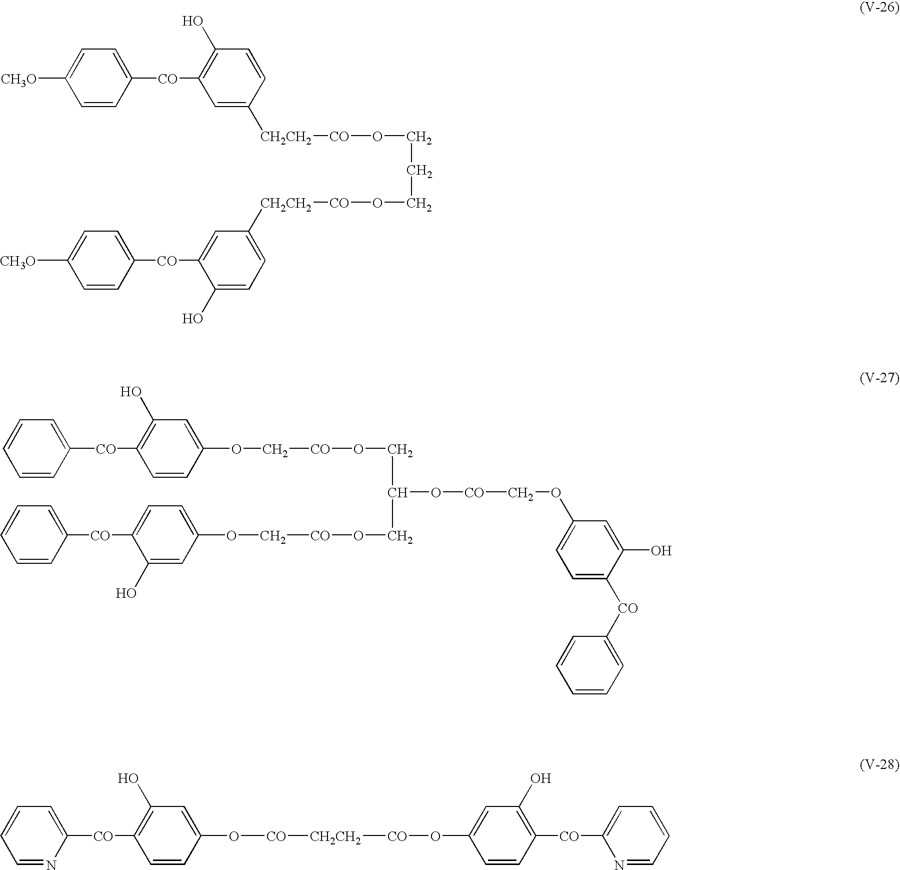

The Rth raising agent used in the present invention is more preferred to be a compound represented by the formula (II) or (III). It is also preferably carried out that a compound represented by the formula (IV) is mixed with a compound represented by the formula (II) or (III).

Each of adding amounts of the Rth raising agent and the retardation developer (compound represented by the formula (II) to (IV)) used in the present invention is preferred to be 0.1 to 30% by mass, more preferably 0.5 to 20% by mass and, particularly preferably, 1 to 10% by mass to a substrate polymer of the film. When two or more are used, it is preferred that their total amount satisfies the above-mentioned range.

The Rth raising agent used in the present invention shows a liquid crystalline property. It is more preferred that liquid crystalline property is achieved (having a thermotropic liquid crystalline property) upon heating and it is preferred that liquid crystalline property is achieved within a temperature range of 100° C. to 300° C. The liquid crystal phase is preferred to be a columnar phase, a nematic phase or a smectic phase and a columnar phase is more preferred.

The above-mentioned compound of the formula (I) and Rth raising agent may be added together with dissolving of the substrate polymer of the film or may be added to the dope after dissolving. A form where a static mixer is used and an ultraviolet absorber is added to the dope immediately before the casting is particularly preferred since the spectroscopic absorption characteristic is able to be adjusted easily.

### (Cellulose Acylate)

With regard to a cotton material for cellulose acylate, a publicly known material may be used (refer, for example, to Journal of Technical Disclosure 2001/1745 published by the Japan Institute of Invention and Innovation (JIII)). Synthesis of cellulose acylate is also able to be conducted by a publicly known method (refer, for example, to “Mokuzai Kagaku (Wood Chemistry)” by Uda, et al., pages 180 to 190 (published by Kyoritsu Shuppan, 1968)). Viscosity-average degree of polymerization of cellulose acylate is preferably 200 to 700, more preferably 250 to 500 and, most preferably, 250 to 350. It is also preferred that number-average molecular weight (Mn) of the cellulose ester used in the present invention is 10,000 to 150,000, weight-average molecular weight (Ww) thereof is 20,000 to 500,000 and Z-average molecular weight (Mz) thereof is 5,000 to 550,000. It is preferred that the molecular weight distribution of Mw/Mn (where Mw is mass-average molecular weight and Mn is number-average molecular weight) by a gel permeation chromatography is narrow. With regard to the specific value of Mw/Mn, it is preferably 1.5 to 5.0, more preferably 2.0 to 4.5 and, most preferably, 3.0 to 4.0.

Although there is no particular limitation for an acyl group of said cellulose acylate film, it is preferred to use acetyl group, propionyl group, butyryl group or benzoyl group. Degree of substitution of the total acyl group is preferably 2.0 to 3.0 and, more preferably, 2.2 to 2.95. Degree of substitution of an acyl group in the present invention is a value calculated according to ASTM D817. With regard to an acyl group, it is most preferred to be acetyl group and, when cellulose acetate where the acyl group is acetyl group is used, degree of acetylation is preferably 57.0% to 62.5% and, more preferably, 58.0 to 62.0%. When degree of acetylation is within the above range, Re does not becomes larger than the desired value due to a conveying tension upon casting, in-plane imbalance is little and changes in retardation value depending upon temperature and humidity are also little.

Particularly, when hydroxyl group of a glucose unit constituting the cellulose of cellulose acylate is substituted with acyl group where carbon atoms at 2 or more and when degree of substitution of 2-hydroxyl group of the glucose unit with acyl group is defined as DS2, that of 3-hydroxyl group thereof is defined as DS3 and that of 6-hydroxyl group thereof is defined as DS6 and they satisfy the following formulae (IV) and (V), it is now possible to achieved the desired Re and Rth easily and changes in Re value depending upon temperature and humidity become small whereby that is preferred.

2.0≦(DS2+DS3+DS6)≦3.0 (IV)

DS6/(DS2+DS3+DS6)≧0.315 (V)

More preferred range is as follows.

2.2≦(DS2+DS3+DS6)≦2.9 (IV)

DS6/(DS2+DS3+DS6)≧0.322 (V)

Alternately, particularly when degree of substitution of hydroxyl group of glucose unit of cellulose acylate with acetyl group is defined as A and degree of substitution thereof with propionyl group, butyryl group or benzoyl group is defined as B and when A and B satisfy (VI) and (VII), it is now possible to achieve the desired Re and Rth easily and a high stretching magnification is able to be achieved without breakage whereby that is preferred.

2.0≦A+B≦3.0 (VI)

0<B (VII)

More preferred range is as follows.

2.6≦A+B≦3.0 (VI)

0.5≦B≦1.5 (VII)

(Polymer Other than Cellulose Acylate)

A method for the manufacture of film having a preferred optical property by a method for production of the present invention which is characterized in including a stretching step wherein the film is stretched and a shrinking step wherein it is shrunk is applicable not only to a cellulose acylate but also to all polymers which are able to be used as an optical film being able to expected to have the same advantage as in the case of cellulose acylate.

Examples of such a polymer which is able to be used as an optical film are a polycarbonate copolymer and a polymer resin having a cyclic olefin structure.

An example of the polycarbonate copolymer is a polycarbonate copolymer comprising a repeating unit represented by the following formula (A) and a repeating unit represented by the following formula (B) in which the repeating unit represented by the formula (A) occupies 80 to 30 molar % of the whole.

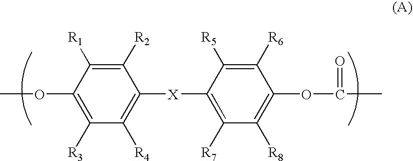

In the above formula (A), R₁ to R₈ each independently is selected from hydrogen atom, halogen atom and a hydrocarbon group having 1 to 6 carbon(s). Examples of the hydrocarbon group having 1 to 6 carbon(s) as such are an alkyl group such as methyl group, ethyl group, isopropyl group and cyclohexyl group and an aryl group such as phenyl group. Among them, hydrogen atom and methyl group are preferred.

X is the following formula (X) and R₉ and R₁₀ each independently is hydrogen atom, halogen atom and a hydrocarbon group having 1 to 3 carbon(s). With regard to the alkyl group having 1 to 3 carbon(s), the same ones as mentioned above may be listed.

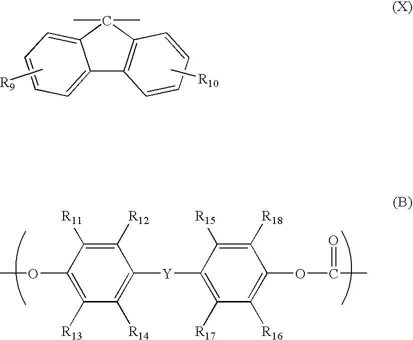

In the above formula (B), R₁₁ to R₁₈ each independently is selected from hydrogen atom, halogen atom and a hydrocarbon group having 1 to 22 carbon(s). Examples of the hydrocarbon group having 1 to 22 carbon(s) as such are an alkyl group having 1 to 9 carbon(s) such as methyl group, ethyl group, isopropyl group and cyclohexyl group and an aryl group such as phenyl group, biphenyl group and terphenyl group. Among them, hydrogen atom and methyl group are preferred.

Y is a following formula group in which R₁₉ to R₂₁, R₂₃ and R₂₄ each independently is at least one group selected from hydrogen atom, halogen atom and a hydrocarbon group having 1 to 22 carbon(s). With regard to such a hydrogen group, that which was mentioned above may be listed. R₂₂ and R₂₅ each independently is selected from a hydrocarbon group having 1 to 20 carbon(s) and examples of the hydrocarbon group as such are methylene group, ethylene group, propylene group, butylene group, cyclohexylene group, phenylene group, naphthylene group and terphenylene group. Examples of Ar₁ to Ar₃ are an aryl group having 6 to 10 carbons such as phenyl group and naphthyl group.

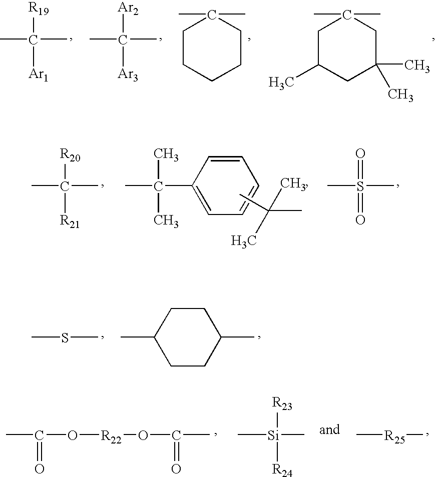

With regard to the above-mentioned polycarbonate copolymer, a polycarbonate copolymer comprising 30 to 60 molar % of a repeating unit represented by the following formula (C) and 70 to 40 molar % of a repeating unit represented by the following formula (D) is preferred.

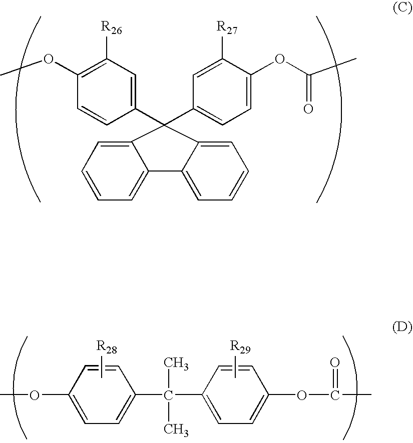

More preferable one is a polycarbonate copolymer comprising 45 to 55 molar % of a repeating unit represented by the above formula (C) and 55 to 45 molar % of a repeating unit represented by the above formula (D).

In the above formula (C), R₂₆ to R₂₇ each independently is hydrogen atom or methyl group and, in view of handling, methyl group is preferred.

In the above formula (C), R₂₈ to R₂₉ each independently is hydrogen atom or methyl group and, in view of economy, film characteristic, etc., hydrogen is preferred.

With regard to the optical film of the present invention, that where the polycarbonate copolymer having the above fluorene skeleton is used is preferred. In the polycarbonate copolymer having the above fluorene skeleton, a blended product of polycarbonate copolymer comprising, for example, a repeating unit represented by the above formula (A) and the repeating unit represented by the above formula (B) in a different composition ratio is preferred. Amount of the above formula (A) to the whole polycarbonate copolymer is preferably 80 to 30 molar %, more preferably 75 to 35 molar % and, still more preferably, 70 to 40 molar %.

The above copolymer may be a product where each two or more of repeating units represented by the above formula (A) and (B) are combined.

Here, the above-mentioned molar ratio is a molar ratio to the whole polycarbonate bulk constituting the optical film and is able to be determined, for example, by a nuclear magnetic resonance (NMR) apparatus.

The above-mentioned polycarbonate copolymer is able to be produced by a publicly known method. With regard to the polycarbonate, a method by polycondensation of dihydroxy compound with phosgene, a melting polycondensation, etc. may be advantageously used.

Limiting viscosity of the above polycarbonate copolymer is preferred to be 0.3 to 2.0 dl/g. When it is less than 0.3, there is a problem that the copolymer is fragile and no mechanical strength is able to be maintained while, when it is more than 2.0, there is problem of generation of dye line in preparation of a film from the solution since viscosity of the solution becomes too high and there is another problem that purification upon finishing the polymerization becomes difficult.

The optical film of the present invention may also be a composition (a blended product) of the above-mentioned polycarbonate copolymer with other macromolecular compound. In that case, with regard to said macromolecular compound, that which is miscible with the above polycarbonate copolymer or in which refractive index of each macromolecule is nearly the same is preferred because it is necessary to be optically transparent. Specific examples of other macromolecule are a styrene-maleic acid anhydride copolymer, etc. and the composition ratio of the polycarbonate copolymer to the macromolecular compound is that 80 to 30% by mass of the polycarbonate copolymer and 20 to 70% by mass of the macromolecular compound or preferably that 80 to 40% by mass of the polycarbonate copolymer and 20 to 60% by mass of the macromolecular compound. In the case of the blended product, it is also possible that each two or more repeating units of the above polycarbonate copolymer may be combined. In the case of the blended product, although the miscible blend is preferred, it is still possible to suppress the optical scattering among the components and to improve the transparency even when complete miscibility is available provided that refractive indexes among the components are adjusted. Incidentally, in the blended product, three or more materials may be combined and it is also possible that plural kinds of polycarbonate copolymers and other macromolecular compound are combined.

Mass-average molecular weight of the polycarbonate copolymer is 1,000 to 1,000,000 and, preferably, 5,000 to 500,000. Mass-average molecular weight of other macromolecular compound is 500 to 100,000 and, preferably, 1,000 to 50,000.

The polymer other than cellulose acylate being able to be applied to the present invention includes a polymer resin having a cyclic olefin structure (hereinafter, it will also referred to as “cyclic polyolefin resin” or “cyclic polyolefin”). Examples thereof are (1) norbornene polymer, (2) monocyclic cycloolefin polymer, (3) polymer of cyclic conjugated diene, (4) vinyl alicyclic hydrocarbon polymer and hydrogenated products of (1) to (4). Polymers which are preferred in this invention are an addition (co)polymer cyclic polyolefin containing at least one repeating unit represented by the following formula (II) and an addition (co)polymer cyclic polyolefin further containing at least one repeating unit represented by the formula (I) if necessary. An addition (co)polymer (including a ring-opened (co)polymer) containing at least one cyclic repeating unit represented by the formula (III) is also able to be used advantageously. An addition (co)polymer cyclic polyolefin further containing at least one repeating unit represented by the formula (I) if necessary may also be used preferably.

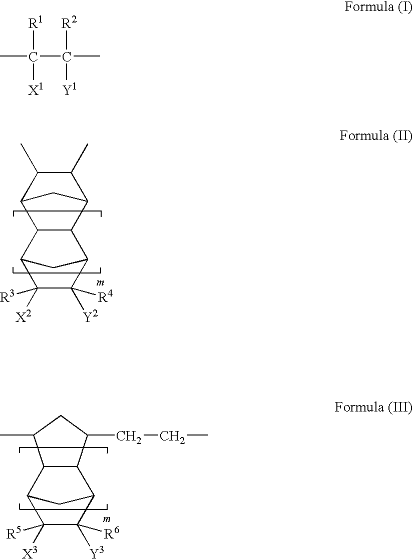

In the formula, m is an integer of 0 to 4. R¹ to R⁶ each is hydrogen atom or a hydrocarbon group having 1 to 10 carbon(s); and X¹ to X³ and Y¹ to Y³ each is hydrogen atom, a hydrocarbon group having 1 to 10 carbon(s), halogen atom, a hydrocarbon group having 1 to 10 carbon(s) substituted with halogen atom, —(CH₂)ₙCOOR¹¹, —(CH₂), OCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ, —(CH₂)ₙW or is (—CO)₂O and (—CO)₂NR¹⁵ constituted from X² and Y² or from X³ and Y³. R¹¹, R¹², R¹³, R¹⁴ and R¹⁵ each is hydrogen atom or a hydrocarbon group having 1 to 20 carbon(s); Z is a hydrocarbon group or a hydrocarbon group substituted with halogen; W is SiR¹⁶ₚD₃₋ₚ (R¹⁶ is a hydrocarbon group having 1 to 10 carbon(s), D is halogen atom, —OCOR¹⁶ or —OR¹⁶ and p is an integer of 0 to 3); and n is an integer of 0 to 10.

When a functional group having a big polarizing property is introduced into the substituents X¹ to X³ and Y¹ to Y³, it is now possible to increase the retardation in the thickness direction (Rth) of an optical film and to increase the developing property of the in-plane retardation (Re) thereof. A film having a big Re developing property is able to make the Re value big when it is stretched during the film manufacturing process.

An addition (co)polymer of a norbornene type is disclosed, for example, in each of Japanese Patent Laid-Open Nos. 10/007,732 A and 2002/504,184 A, U.S. Patent No. 2004/229,157 A1 and WO 2004/070,463 A1. It is able to be produced by an addition polymerization of polycyclic unsaturated compounds of a norbornene type each other. If necessary, it is also possible to conduct an addition polymerization of a polycyclic unsaturated compound of a norbornene type with a conjugated diene such as ethylene, propylene, butane, butadiene and isoprene, a non-conjugated diene such as ethylidene norbornene or a linear diene compound such as acrylonitrile, acrylic acid, methacrylic acid, maleic acid anhydride, acrylate, methacrylate, maleimide, vinyl acetate and vinyl chloride. The addition (co)polymer of a norbornene type as such is sold from Mitsui Chemicals, Inc. in a trade name of Apel and there are several grades where glass transition temperature (Tg) is different such as APL 8008 T (Tg: 70° C.), APL 6013 T (Tg: 125° C.) and APL 6015 T (Tg: 145° C.). Pellets are sold from Polyplastic K. K. with trade names such as TOPAS 8007, TOPAS 6013 and TOPAS 6015. Moreover, Appear 3000 is sold from Ferrania.

As disclosed in each of Japanese Patent Laid-Open Nos. 01/240,517 A, 07/196,736 A, 60/026,024 A, 62/019,801 A, 2003/158,767 A, 2004/309,979 A, etc., a hydrogenated product of polymer of a norbornene type is produced by hydrogenation after a polycyclic unsaturated compound is subjected to an addition polymerization or a metathesis ring-opening polymerization. In the polymer of a norbornene type used in the present invention, R⁵ to R⁶ each is preferably hydrogen atom or —CH₃, X³ and Y³ each is preferably hydrogen atom, Cl or —COOCH₃ and other groups may be appropriately selected. The norbornene type resin as such is sold from JSR. K. K. in a trade name of Arton G or Arton F and from Nippon Zeon K. K. in a trade name of Zeonor ZF 14, ZF 16, Zeonex 250 or Zeonex 280 and it is also possible to use them.

The optical film of the present invention is characterized in satisfying the following formulae (A) to (D).

0.1<Re(450)/Re(550)<0.95 (A)

1.03<Re(650)/Re(550)<1.93 (B)

0.4<Re/Rth(450))/(Re/Rth(550))<0.95 (C)

1.05<(Re/Rth(650)/(Re/Rth(550))<1.9 (D)

(In the formulae, Re (λ) is an in-plane retardation value of said film to the light of λ nm wavelength, Rth (λ) is a retardation value in the thickness direction of said film to the light of λwavelength and Re/Rth (λ) is a ratio of an in-plane retardation value to a retardation value in the thickness direction of said film to the light of λ wavelength (unit: nm).)

In the present invention, an optically compensatory film having the above optical characteristics is used whereby it is now possible to conduct an optical compensation by different slow axis and retardation for each wavelength. As a result, viewing angle contrast in black display is significantly improved as compared with conventional liquid crystal display device and, in addition, coloring in an oblique direction in the black display is significantly reduced as well. Here, as to the wavelength of R, G and B, 650 nm wavelength, 550 nm wavelength and 450 nm wavelength were used for R, G and B, respectively, in the present specification. Although the wavelengths of R, G and B are not always represented by those wavelengths, they are believed to be the appropriate wavelengths for stipulating the optical characteristics achieving the advantages of the present invention.

A cellulose acylate film which is preferably used in the present invention is able to be produced by using a solution where the above-mentioned specific cellulose acylate and an additive, if necessary, are dissolved in an organic solvent is made into a film.

Examples of the additives which are able to be used in the above-mentioned cellulose acylate solution in the present invention are plasticizer, ultraviolet absorber, deterioration preventer, retardation (optical anisotropy) developer, retardation (optical anisotropy) decreasing agent, wavelength dispersion adjusting agent, dye, fine particles, peeling promoter and infrared absorber. In the present invention, it is preferred to use a retardation developer. It is also preferred to use at least one of plasticizer, ultraviolet absorber and peeling promoter.

They may be either solid or oily. In other words, there is no particular limitation for melting points and boiling points thereof. For example, it is possible that ultraviolet absorbers having not higher than 20° C. and not lower than 20° C. are mixed and used or that a plasticizer is mixed and used similarly and that is mentioned, for example, in Japanese Patent Laid-Open No. 2001/151,901 A.

### [Deterioration Preventer]

The deterioration preventer is able to prevent deterioration and decomposition of the cellulose triacetate, etc. Examples of the deterioration preventer are butylamine, a hindered amine compound (Japanese Patent Laid-Open No. 08/325,537 A), a guanidine compound (Japanese Patent Laid-Open No. 05/271,471 A), a UV absorber of a benzotriazole type (Japanese Patent Laid-Open No. 06/235,819 A) and a UV absorber of a benzophenone type (Japanese Patent Laid-Open No. 06/118,233 A).

### [Plasticizer]

With regard to a plasticizer, it is preferred to be a phosphate or a carboxylate. Examples of the plasticizer of a phosphate type are triphenyl phosphate (TPP), tricresyl phosphate (TCP), cresyl diphenyl phosphate, octyl diphenyl phosphate, biphenyl diphenyl phosphate, trioctyl phosphate and tributyl phosphate; examples of the plasticizer of a carboxylate type are dimethyl phthalate, diethyl phthalate (DEP), dibutyl phthalate (DBP), dioctyl phthalate (DOP), diphenyl phthalate (DPP), diethylhexyl phthalate (DEHP), triethyl O-acetylcitrate (OACTE), tributyl O-acetylcitrate (OACTB), acetyl triethyl citrate, acetyl tributyl citrate, butyl oleate, methyl acetyl ricinolate, ethyl phthalyl sebacate, triacetine, tributyrine, butyl phthalylbutyl glycolate, ethyl phthalylethyl glycolate, methyl phthalylethyl glycolate and butyl phthalylbutyl glycolate and the plasticizer used in the present invention is more preferred to be selected from the exemplified ones as such. It is further preferred that the above plasticizer is a (di)pentaerythritol ester, a glycerol ester or a diglycerol ester.

### [Peeling Promoter]

With regard to the peeling promoter, ethyl citrate is exemplified.

[Infrared Absorber]

Infrared absorber is mentioned, for example, in Japanese Patent Laid-Open No. 2001/194,522 A.

### [Time for Addition, Etc.]

With regard to time for addition of those additives, they may be added at any time during the steps for the preparation of the dope and a step of adding the additives to prepare may be added to the final preparing step for the dope preparing steps. There is no particular limitation for the adding amount of each material so far as the function is developed.

When the cellulose acylate film is in multi-layers, type and adding amount of the additives in each layer may be different. That is mentioned, for example, in Japanese Patent Laid-Open No. 2001/151,902 A and that is an art which has been known already.

As a result of selection of type and adding amount of the additive as such, it is preferred that glass transition point Tg as measured by a dynamic viscoelasticity measuring machine “Vibron DVA-225” (manufactured by IT Keisoku Seigyo K. K.) for cellulose acylate film is made 70 to 150° C. and that elasticity as measured by a tensile tester “Strograph-R2” (manufactured by K. K. Toyo Seiki Seisakusho) is made 1,500 to 4,000 MPa. More preferably, the glass transition point Tg is 80 to 135° C. and the elasticity is 1,500 to 3,000 MPa. Thus, it is preferred in view of step adaptability in processing of a polarizing plate and in assembling of a liquid crystal display device that glass transition point Tg and elasticity of the cellulose acylate film which are preferably used in the present invention are made within the above-mentioned ranges.

In addition, with regard to the additives, those which are mentioned in detail in Journal of Technical Disclosure, page 16 and thereafter of No. 2001/1745 (published on Mar. 16, 2001 by the JIII) may be appropriately used as well.

### (Log P Value)

In the manufacture of a cellulose acylate film having a low optical anisotropy, a compound where a partition coefficient (log P value) between octanol and water is 0 to 7 is preferred among the compounds which suppress the alignment of the cellulose acylate in the film to in-plane and in the thickness direction so as to lower the optical anisotropy as mentioned above. When the log P value of the compound is 7 or lower, it is preferred since miscibility with cellulose acylate is good and inconveniences such as turbidity of the film and generation of powder are hardly resulted.

When the log P value of the compound is 0 or higher, it is preferred since hydrophilicity does not become too high and water resistance of the cellulose acylate film is not deteriorated. Still more preferred range of the log P value is 1 to 6 and the particularly preferred range is 1.5 to 5.

Measurement of the octanol-water partition coefficient (log P value) is able to be carried out by a flask permeation method mentioned in JIS Z-7260-107 (2000). It is also possible that the octanol-water partition coefficient (log P value) is estimated by a chemical calculation means or by an empirical method in place of the actual measurement.

With regard to the calculating method, Crippen's fragmentation method (J. Chem. Inf. Comput. Sci., volume 27, page 21 (1987)), Viswanadhan's fragmentation method (J. Chem. Inf. Comput. Sci., volume 29, page 163 (1989)), Broto's fragmentation method (Eur. J. Med. Chem.-Chim. Theor., volume 19, page 71 (1984)), etc. may be preferably used and Crippen's fragmentation method (J. Chem. Inf. Comput. Sci., volume 27, page 21 (1987)) is more preferred.

When the log P values for a compound vary depending upon a measuring method or a calculating method, it is preferred to judge whether said compound is within the above-mentioned range by means of a Crippen's fragmentation method.

### [Dye]

In the present invention, a dye may be used for adjustment of the hue. Amount of the dye in terms of mass ratio to cellulose acylate is preferably 10 to 1,000 ppm and, more preferably, 50 to 500 ppm. When the dye is contained as such, a light piping of the cellulose acylate film can be reduced and yellow hue can be improved. Such a compound may be added together with cellulose acylate and solvent in the preparation of a cellulose acylate solution or may be added during the preparation or after that. It is also possible to add to the ultraviolet absorber solution which is in-line inputted. Dyes mentioned in Japanese Patent Laid-Open No. 05/034,858 A may be used as well.

### [Fine Particle of Matting Agent]

It is preferred to add fine particles as a matting agent to the cellulose acylate film preferably used in the present invention. Examples of the fine particles used in the present invention are silicon dioxide, titanium dioxide, aluminum oxide, zirconium oxide, calcium carbonate, talc, clay, sintered kaolin, sintered calcium silicate, hydrated calcium silicate, aluminum silicate, magnesium silicate and calcium phosphate. With regard to the fine particles, those having silicon are preferred since turbidity becomes low and silicon dioxide is particularly preferred.

With regard to the fine particles of silicon dioxide, those where a primary average particle size is not more than 20 nm and an apparent specific gravity is not less than 70 g/L are preferred. Those where an average particle size of the primary particles is as small as 5 to 16 nm is more preferred since they are able to lower the haze of the film. The apparent specific gravity is preferably not less than 90 to 200 g/L and, more preferably, not less than 100 to 200 g/L. When the apparent specific gravity is big, it is preferred since preparation of a dispersion of high concentrations is possible and haze and aggregates become good.

When fine particles of silicon dioxide are used as a matting agent, the using amount to 100 parts by mass of the polymer components including cellulose acylate is preferred to be 0.01 to 0.3 part by mass.

Although those fine particles form secondary particles usually having an average particle size of 0.1 to 3.0 μm, they are present in the film as aggregates of the primary particles and form an unevenness of 0.1 to 3.0 μm on the film surface. The average particle size of the secondary particles is preferably 0.2 μm to 1.5 μm, more preferably 0.4 μm to 1.2 μm and, most preferably, 0.6 μm to 1.1 μm. It is preferred that the average particle size is not more than 1.5 μm since the haze does not become too strong and that it is not less than 0.2 μm since a squeaking prevention effect is fully achieved.

With regard to the primary and the secondary particle sizes of fine particles, the particle in the film is observed under a scanning electron microscope and diameter of circle circumscribed the particle is defined as the particle size. Two hundred particles in various places are observed and the mean value thereof is adopted as an average particle size.

With regard to the fine particles of silicon dioxide, commercially available products such as Aerosil R972, R972V, R974, R812, 200, 200V, 300, R202, OX50 and TT600 (all manufactured by Nippon Aerosil K. K.) may be used. Fine particles of zirconium oxide are commercially available, for example, in the trade names of Aerosil R976 and R811 (both manufactured by Nippon Aerosil K. K.) and they may be used.

Among them, Aerosil 200V and Aerosil R972V are particularly preferred since they are fine particles of silicon dioxide where the primary average particle size is not more than 20 nm and the apparent specific gravity is not less than 70 g/L.

In order to prepare a cellulose acylate film containing particles where the secondary average particle size is small in the present invention, various means may be available in the preparation of a dispersion of the fine particles. For example, there is a method where a fine particle dispersion in which solvent and fine particles are stirred and mixed is previously prepared, the fine particle dispersion is added to and mixed with a separately prepared small amount of cellulose acylate solution to dissolve and the resulting solution is further mixed with the main cellulose acylate dope liquid. This is a preferable preparation method in such a respect that dispersing property of the fine particles of silicon dioxide is good and the silicone dioxide fine particles are hardly re-aggregated further. There is another method where small amount of a cellulose ester is added to a solvent and dissolved with stirring, fine particles are added to disperse using a dispersing machine and the resulting solution to which the fine particles are added is well mixed with a dope liquid using an in-line mixer. Although the present invention is not limited to those methods, concentration of silicon dioxide in mixing the silicon dioxide fine particles with a solvent or the like followed by dispersing is preferably 5 to 30% by mass, more preferably 10 to 25% by mass and, most preferably, 15 to 20% by mass.

It is preferred that the dispersed concentration is higher since liquid turbidity to the adding amount is lower and haze and aggregates become better. The final adding amount of the matting agent to a dope liquid of cellulose acylate is preferably 0.01 to 1.0 g/m², more preferably 0.03 to 0.3 g/m² and, most preferably, 0.08 to 0.16 g/m².

With regard to the solvent used, methyl alcohol, ethyl alcohol, propyl alcohol, isopropyl alcohol, butyl alcohol, etc. may be exemplified as a lower alcohol. Although there is no particular limitation for the solvent other than lower alcohol, it is preferred to use a solvent used for producing the film of cellulose ester.

Now, the above-mentioned organic solvent which is preferably used in the present invention for dissolving the cellulose acylate will be illustrated.

In the present invention, any of a chlorine-type solvent where chlorine-type organic solvent is a main solvent and a non-chlorine-type solvent where no chlorine-type organic solvent is contained may be used as an organic solvent.

### [Chlorine-Type Solvent]

In the preparation of a cellulose acylate solution which is preferably used in the present invention, a chlorine-type organic solvent is preferably used as a main solvent. In the present invention, there is no particular limitation for the type of said chlorine-type organic solvent so far as the object is achieved within such an extent that the cellulose acetate is dissolved therein whereby casting and film formation are possible. In the chlorine-type organic solvent as such, preferred ones are dichloromethane and chloroform. There is also no problem to mix an organic solvent which is other than the chlorine-type organic solvent. In that case, it is preferred that dichloromethane is used in an amount of at least 50% by mass in the total amount of the organic solvent.

Other organic solvent which is used together with a chlorine-type organic solvent in the present invention will be illustrated as follows.

Thus, with regard to other organic solvent as such, a solvent selected from C₃₋₁₂ ester, ketone, ether, alcohol, hydrocarbon, etc. is preferred. The ester, ketone, ether and alcohol may have a cyclic structure. A compound having two or more of any of functional groups for ester, ketone and ether (i.e., —O—, —CO— and —COO—) may be also used as a solvent. For example, other functional group such as an alcoholic hydroxyl group may be contained at the same time. In the case of a solvent having two or more kinds of functional groups, the carbon numbers thereof may be within a stipulated range of a compound having any functional group. Examples of the ester having 3 to 12 carbons are ethyl formate, propyl formate, pentyl formate, methyl acetate, ethyl acetate and pentyl acetate. Examples of the ketone having 3 to 12 carbons are acetone, methyl ethyl ketone, diethyl ketone, diisobutyl ketone, cyclopentanone, cyclohexanone and methylcyclohexanone. Examples of the ether having 3 to 12 carbons are diisopropyl ether, dimethoxymethane, dimethoxyethane, 1,4-dioxane, 1,3-dioxorane, tetrahydrofuran, anisole and phenetole. Examples of the organic solvent having two or more kinds of functional groups are 2-ethoxyethyl acetate, 2-methoxyethanol and 2-butoxyethanol.

With regard to the alcohol which is used together with the chlorine-type organic solvent, it may be preferably a linear or branched or cyclic and, among that, a saturated aliphatic hydrocarbon is preferred. Hydroxyl group of the alcohol may be any of primary, secondary and tertiary ones. Examples of the alcohol include methanol, ethanol, 1-propanol, 2-propanol, 1-butanol, 2-butanol, tert-butanol, 1-pentanol, 2-methyl-2-butanol and cyclohexanol. As to the alcohol, a fluorine-type alcohol may be also used. For example, 2-fluoroethanol, 2,2,2-trifluoroethanol and 2,2,3,3-tetrafluoro-1-propanol may be listed. The hydrocarbon may be linear or branched or cyclic. Any of aromatic and aliphatic hydrocarbons may be used. The aliphatic hydrocarbon may be saturated or unsaturated. Examples of the hydrocarbon include cyclohexane, hexane, benzene, toluene and xylene.

As examples of combination of the chlorine-type organic solvent with other organic solvent, the following compositions may be listed although they are non-limitative.

Dichloromethane/methanol/ethanol/butanol=80/10/5/5 (parts by mass)

Dichloromethane/acetone/methanol/propanol=80/10/5/5 (parts by mass)

Dichloromethane/methanol/butanol/cyclohexane=80/10/5/5 (parts by mass)

Dichloromethane/methyl ethyl ketone/methanol/butanol=80/10/5/5 (parts by mass)

Dichloromethane/acetone/methyl ethyl ketone/ethanol/isopropanol=75/81/515/7 (parts by mass)

Dichloromethane/cyclopentanone/methanol/isopropanol=80/7/5/8 (parts by mass)

Dichloromethane/methyl acetate/butanol=80/10/10 (parts by mass)

Dichloromethane/cyclohexanone/methanol/hexane=70/20/5/5 (parts by mass)

Dichloromethane/methyl ethyl ketone/acetone/methanol/ethanol=50/20/20/5/5 (parts by mass)

Dichloromethane/1,3-dioxorane/methanol/ethanol=70/20/5/5 (parts by mass)

Dichloromethane/dioxane/acetone/methanol/ethanol=60/20/10/5/5 (parts by mass)

Dichloromethane/acetone/cyclopentanone/ethanol/isobutanol/cyclohexane=65/10/10/5/5/5 (parts by mass)

Dichloromethane/methyl ethyl ketone/acetone/methanol/ethanol=70/10/5/5 (parts by mass)

Dichloromethane/acetone/ethyl acetate/ethanol/butanol/hexane=65/10/10/5/5/5 (parts by mass)

Dichloromethane/methyl acetoacetate/methanol/ethanol=65/20/10/5 (parts by mass)

Dichloromethane/cyclopentanone/ethanol/butanol=65/20/10/5 (parts by mass)

### [Non-Chlorine-Type Solvent]

Now, a non-chlorine-type solvent preferably used in the preparation of a cellulose acylate solution which is preferably used in the present invention will be illustrated. In the present invention, there is no particular limitation for the non-chlorine-type organic solvent so far as an object is able to be achieved within such an extent that cellulose acylate is able to be dissolved therein and is able to be cast and made into a film. With regard to the non-chlorine-type organic solvent used in the present invention, a solvent selected from C₃₋₁₂ ester, ketone and ether is preferred. The ester, ketone, ether and alcohol may have a cyclic structure. A compound having two or more of any of functional groups for ester, ketone and ether (i.e., —O—, —CO— and —COO—) may be also used as a main solvent. For example, other functional group such as an alcoholic hydroxyl group may be contained at the same time. In the case of a main solvent having two or more kinds of functional groups, the carbon numbers thereof may be within a stipulated range of a compound having any functional group. Examples of the ester having 3 to 12 carbons are ethyl formate, propyl formate, pentyl formate, methyl acetate, ethyl acetate and pentyl acetate. Examples of the ketone having 3 to 12 carbons are acetone, methyl ethyl ketone, diethyl ketone, diisobutyl ketone, cyclopentanone, cyclohexanone, methylcyclohexanone and methyl acetoacetate. Examples of the ether having 3 to 12 carbons are diisopropyl ether, dimethoxymethane, dimethoxyethane, 1,4-dioxane, 1,3-dioxorane, tetrahydrofuran, anisole and phenetole. Examples of the organic solvent having two or more kinds of functional groups are 2-ethoxyethyl acetate, 2-methoxyethanol and 2-butoxyethanol.

With regard to the above non-chlorine-type organic solvent used for cellulose acylate, it may be selected from the above-mentioned various viewpoints and, preferably, it is as follows.

Thus, with regard to a non-chlorine-type solvent, a mixed solvent in which the above-mentioned non-chlorine-type organic solvent is preferred and it is a mixed solvent comprising three or more different types of solvents in which the first solvent is at least one member selected from methyl acetate, ethyl acetate, methyl formate, ethyl formate, acetone, dioxorane and dioxane or a mixed liquid thereof, the second solvent is selected from ketone having 4 to 7 carbons or ethyl acetoacetate and the third solvent is a mixed solvent selected from C₁₋₁₀ alcohol and hydrocarbon or, preferably, a C₁₋₈ alcohol. When the first solvent is a mixture of two or more solvents, the second solvent may be omitted. More preferably, the first solvent is methyl acetate, acetone, methyl formate, ethyl formate or a mixture thereof and the second solvent is methyl ethyl ketone, cyclopentanone, cyclohexanone, methyl acetoacetate or a mixed solvent thereof.

With regard to an alcohol which is the third solvent, its hydrocarbon chain may be linear, straight or cyclic and, among that, a saturated aliphatic hydrocarbon chain is preferred. Hydroxyl group of the alcohol may be any of primary, secondary and tertiary ones. Examples of the alcohol include methanol, ethanol, 1-propanol, 2-propanol, 1-butanol, 2-butanol, tert-butanol, 1-pentanol, 2-methyl-2-butanol and cyclohexanol. As to the alcohol, it is also possible to use a fluorine-type alcohol where a part of or all of the hydrogen(s) of the hydrocarbon chain is/are substituted with fluorine. For example, 2-fluoroethanol, 2,2,2-trifluoroethanol and 2,2,3,3-tetrafluoro-1-propanol may be listed.

The hydrocarbon may be linear or branched or cyclic. Any of aromatic and aliphatic hydrocarbons may be used. The aliphatic hydrocarbon may be saturated or unsaturated. Examples of the hydrocarbon include cyclohexane, hexane, benzene, toluene and xylene.

Each of the alcohol and the hydrocarbon as such which is the third solvent may be used either solely or may be in a mixture of two or more and there is no particular limitation therefor. Preferred specific compounds as the third solvent in the case of an alcohol are methanol, ethanol, 1-propanol, 2-propanol, 1-butanol, 2-butanol and cyclohexanol and, in the case of a hydrocarbon, they are cyclohexane and hexane. Particularly preferred ones are methanol, ethanol, 1-propanol, 2-propanol and 1-butanol.

With regard to the mixing ratio of the three kinds of the solvents to be mixed, it is preferred in the total amount of the mixed solvent that the first solvent is 20 to 95% by mass, the second solvent is 2 to 60% by mass and the third solvent is 2 to 30% by mass; more preferably, the first solvent is 30 to 90% by mass, the second solvent is 3 to 50% by mass and the third solvent is 3 to 25% by mass; and, particularly preferably, the first solvent is 30 to 90% by mass, the second solvent is 3 to 30% by mass and the third solvent is 3 to 15% by mass

With regard to the non-chlorine-type organic solvent used in the present invention as mentioned above, it is mentioned in more detail in Journal of Technical Disclosure, pages 12 to 16 of No. 2001/1745 (published on Mar. 16, 2001 by the JIII).

Preferred combinations of the non-chlorine-type organic solvents according to the present invention are as mentioned below although they are non-limitative. Thus, the followings may be exemplified.

Methyl acetate/acetone/methanol/ethanol/butanol=75/10/5/5/5 (parts by mass)

Methyl acetate/acetone/methanol/propanol=75/10/5/5 (parts by mass)

Methyl acetate/acetone/methanol/butanol/cyclohexane=75/10/5/5/5 (parts by mass)

Methyl acetate/acetone/ethanol/butanol=81/8/7/4 (parts by mass)

Methyl acetate/acetone/ethanol/butanol=82/10/4/4 (parts by mass)

Methyl acetate/acetone/ethanol/butanol=80/10/4/6 (parts by mass)

Methyl acetate/methyl ethyl ketone/methanol/butanol=80/10/5/5 (parts by mass)

Methyl acetate/acetone/methyl ethyl ketone/ethanol/isopropanol=75/8/5/5/7 (parts by mass)

Methyl acetate/cyclopentanone/methanol/isopropanol=80/7/5/8 (parts by mass)

Methyl acetate/acetone/butanol=85/10/5 (parts by mass)

Methyl acetate/cyclopentanone/acetone/methanol/butanol=60/15/14/5/6 (parts by mass)

Methyl acetate/cyclohexanone/methanol/hexane=70/20/5/5 (parts by mass)

Methyl acetate/methyl ethyl ketone/acetone/methanol/ethanol=50/20/20/5/5 (parts by mass)

Methyl acetate/1,3-dioxorane/methanol/ethanol=70/20/5/5 (parts by mass)

Methyl acetate/dioxane/acetone/methanol/ethanol=60/20/10/5/5 (parts by mass)

Methyl acetate/acetone/cyclopetanone/ethanol/butanol/cyclohexane=65/10/10/5/5/5 (parts by mass)

Methyl formate/methyl ethyl ketone/acetone/methanol/ethanol=50/20/5/5 (parts by mass)

Methyl formate/acetone/ethyl acetate/ethanol/butanol/hexane=65/10/10/5/5/5 (parts by mass)

Acetone/methyl acetoacetate/methanol/ethanol=65/20/10/5 (parts by mass)

Acetone/cyclopentanone/ethanol/butanol=65/20/10/5 (parts by mass)

Acetone/1,3-dioxorane/ethanol/butanol=65/20/10/5 (parts by mass)

1,3-Dioxorane/cyclohexanone/methyl ethyl ketone/methanol/butanol=55/20/10/5/5/5 (parts by mass)

It is also possible to use cellulose acylate solutions prepared by the following methods.

A method where a cellulose acylate solution is prepared from methyl acetate/acetone/ethanol/butanol=81/8/7/4 (parts by mass), filtered and concentrated and then 2 parts by mass of butanol is additionally added thereto.

A method where a cellulose acylate solution is prepared from methyl acetate/acetone/ethanol/butanol=84/10/4/2 (parts by mass), filtered and concentrated and then 4 parts by mass of butanol is additionally added thereto.

A method where a cellulose acylate solution is prepared from methyl acetate/acetone/ethanol=84/10/6 (parts by mass), filtered and concentrated and then 5 parts by mass of butanol is additionally added thereto.

In the dope used in the present invention, it is also possible that dichloromethane in an amount of not more than 10% by mass of all of the organic solvents used in the present invention is contained therein in addition to the above-mentioned non-chlorine-type organic solvent type of the present invention.

### [Characteristic of the Cellulose Acylate Solution]

A cellulose acylate solution is a solution where cellulose acylate is dissolved in the above-mentioned organic solvent and its concentration is preferably within a range of 10 to 30% by mass in view of adaptability as casting for film formation, more preferably 13 to 27% by mass and, particularly preferably, 15 to 25% by mass.

With regard to a method for making the cellulose acylate solution within such a concentration range, it is possible to make into a predetermined concentration at the dissolving stage or to firstly made into a low concentration (such as 9 to 14% by mass) followed by making into a predetermined high concentration in the concentrating step which will be mentioned later. It is also possible that a cellulose acylate solution in a high concentration is prepared and then various kinds of additives are added to give a cellulose acylate solution of a predetermined low concentration. In any of those methods, there is no particular problem provided that it is carried out so as to give the concentration of a cellulose acylate solution which is preferably used in the present invention.

Now, in the present invention, it is preferred in view of solubility in a solvent that, when a cellulose acylate solution is made 0.1 to 5% by mass in an organic solvent of the same composition, molecular weight of associate of cellulose acylate in the diluting solvent is 150,000 to 15,000,000. The associate molecular weight is more preferred to be 180,000 to 9,000,000. The associate molecular weight is able to be determined by a static light scattering method. In that case, it is preferred to dissolve so as to make the inertial radius calculated at the same time 10 to 200 nm. More preferred inertial radius is 20 to 200 nm. It is also preferred to dissolve so as to make the secondary virial coefficient −2×10⁻⁴ to +4×10⁻⁴ and, more preferably, the secondary virial coefficient is −12×10⁻⁴ to +2×10⁻⁴.

Now definitions for associate molecular weight, inertial radius and secondary virial coefficient in the present invention will be illustrated. They are measured using a static light scattering method according to the following methods. Although the measurement is carried out in a diluted region in view of the apparatus, such measured values reflect the behavior of the dope in high concentration regions of the present invention.

Firstly, cellulose acylate is dissolved in a solvent used for the dope to prepare solutions of 0.1% by mass, 0.2% by mass, 0.3% by mass and 0.4% by mass. In weighing, cellulose acylate which is dried at 120° C. for 2 hours is used and weighing is conducted at 25° C. and 10% RH in order to prevent absorption of moisture. Dissolving method is conducted according to the method used for dissolving the dope (a method for dissolving at ambient temperature, a method for dissolving with cooling or a method for dissolving at high temperature). After that, the solution and the solvent are filtered through a filter made of Teflon (registered trade mark) of 0.2 μm. Static light scattering of the filtered solution is measured by a light scattering measuring apparatus “DLS-700” (manufactured by Otsuka Denshi K. K.) at 25° C. and at 30° C. to 140° C. with intervals of 10° C. The resulting data are analyzed by a Berry blotting method. Incidentally, with regard to the refractive index necessary for this analysis, the value of the solvent measured by Abbe's refractive system is used and concentration gradient (dn/dc) of refractive index is measured by a differential refractometer “DRM-1021” (manufactured by Otsuka Denshi K. K.) using the solvent and the solution used for the measurement of light scattering.

### [Preparation of Dope]

Now, preparation of a solution (dope) for casting and film formation of cellulose acylate will be illustrated.

There is no particular limitation for a method of dissolving the cellulose acylate and it may be carried out by a method by dissolving at room temperature, a method by dissolving with cooling, a method by dissolving at high temperature or a combination thereof. They are mentioned, for example, in Japanese Patent Laid-Open Nos. 05/163,031 A, 61/106,628 A, 58/127,737 A, 09/95,544 A, 10/095,854 A, 10/04,950 A, 2000/053,784 A, 11/322,946 A, 11/322,947 A, 02/276,830 A, 2000/273,239 A, 11/071,463 A, 04/259,511 A, 2000/273,184 A, 11/323,017 A and 11/302,388 A as a method for preparation of a cellulose acylate solution.

With regard to the methods for dissolving the cellulose acylate in an organic solvent mentioned in the above-mentioned patents, the art thereof may also be applied to the present invention so far as they are appropriately within a scope of the present invention. Details thereof and particularly for a non-chlorine-type solvent system are mentioned in Journal of Technical Disclosure, pages 22 to 25 of No. 2001/1745 (published on Mar. 16, 2001 by the JIII) in detail and it is possible to conduct according to such methods. Further, with regard to a dope solution of cellulose acylate which is preferably used in the present invention, it is similarly mentioned in Journal of Technical Disclosure, page 25 of No. 2001/1745 (published on Mar. 16, 2001 by the JIII) in detail. When dissolving is carried out at high temperature, it is mostly carried out at the temperature which is not lower than the boiling point of the organic solvent used and, in that case, it is carried out under a pressurized state.

When viscosity and dynamic storage elastic modulus of a cellulose acylate solution are within the range which will be mentioned below, the solution is apt to be cast and that is preferred. Their values are measured using 1 mL of a sample solution by a rheometer “CLS 500” with a “Steel Cone” having 4 cm diameter/2′ (both manufactured by TA Instruments). Condition for the measurement is within a range of 40° C. to −10° C. being varied at 2° C./minute in terms of oscillation step/temperature ramp and a static non-Newtonian viscosity n* (Pa·s) at 40° C. and a storage dynamic elastic modulus G′ (Pa) are determined. Incidentally, the sample solution is previously kept at the temperature for starting the measurement until the liquid temperature becomes constant and then measurement is started.

In the present invention, it is preferred when viscosity at 40° C. is 1 to 400 Pa·s and dynamic storage elastic modulus at 15° C. is not less than 500 Pa and is more preferred when viscosity at 40° C. is 10 to 200 Pa·s and dynamic storage elastic modulus at 15° C. is 100 to 1,000,000 Pa. Further, the more the dynamic storage elastic modulus at low temperature, the better. For example, when the cast support is at −5° C., dynamic storage elastic modulus is preferred to be 10,000 to 1,000,000 Pa and, when the support is at −50° C., dynamic storage elastic modulus at −50° C. is preferred to be 10,000 to 5,000,000 Pa.

Since the above-mentioned specific cellulose acylate is used in the present invention, it is characteristic that dope of high concentrations is able to be produced. Thus, it is now possible to give a cellulose acylate solution in high concentrations and with good stability even when a means of concentration is not used. It is also possible that, after dissolving at low concentrations, concentrating is conducted by means of concentrating in order to dissolve more easily. Although there is no particular limitation for a concentrating method, it is able to be conducted by, for example, a method where a solution of low concentration is introduced between a tube and a rotating locus of outer surface of rotary vane which rotates in the circumferential direction of its inner area and, at the same time, temperature difference is applied between the solution whereby a solution of high concentration is produced by evaporation of the solvent (refer, for example, to Japanese Patent Laid-Open No. 04/259,511 A), a method where a heated solution of low concentration is sprayed from a nozzle into a container, the solvent is subjected to a flash evaporation during the solution hits the inner wall of the container from the nozzle and, at the same time, the solvent vapor is taken out from the container and a solution of high concentration is taken out from the bottom of the container (refer, for example, to U.S. Pat. Nos. 2,541,012, 2,858,229, 4,414,341 and 4,504,355), etc.

It is preferred that, before casting, foreign matters such as un-dissolved things, dust and impurities in the dope solution are removed by filtration using an appropriate filtering material such as wire gauze or flannel. In filtration of a cellulose acylate solution, it is preferred to use a filter where an absolute filtering precision is 0.1 to 100 μm and, more preferred, to use a filter where an absolute filtering precision is 0.5 to 25 μm. Thickness of the filter is preferably 0.1 to 10 mm and, more preferably, 0.2 to 2 mm. In that case, filtering pressure is preferably not higher than 1.6 MPa, more preferably not higher than 1.2 MPa, still more preferably not higher than 1.0 MPa and, particularly preferably, not higher than 0.2 MPa. With regard to a filtering material, conventionally known materials such as glass filter, cellulose filter, filter paper and fluorine resin (e.g., ethylene tetrafluoride resin) may be preferably used and ceramic, metal, etc. are used particularly preferably. Viscosity of the cellulose acylate solution before the manufacture of film may be within such a range that casting is possible at the stage of the manufacture of the film and it is usually preferably to adjust within a range of 10 Pa·s to 2,000 Pa·s, more preferably 30 Pa·s to 1,000 Pa·s and, still more preferably, 40 Pa·s to 1,000 Pa·s. Although there is no particular limitation for the temperature provided that it is temperature at the casting stage, it is preferably −5 to +70° C. and, more preferably, −5 to +55° C.

### [Manufacture of Film]

A cellulose acylate film which is preferably used in the present invention is able to be prepared by manufacturing a film using the above-mentioned cellulose acylate solution (dope). With regard to a method and an apparatus for the manufacture of film, a solution casting film manufacturing method and a solution casting film manufacturing apparatus which have been used for the manufacture of cellulose triacetate film are used. A dope (a cellulose acylate solution) which is prepared in a dissolving machine (container) is stored in a storing container to remove the foams contained in the dope whereby the final preparation is conducted. The dope is then sent from an outlet for the dope to a pressurizing die through, for example, a quantifying gear pump of a pressurizing type which is able to send a liquid in a predetermined amount with high precision by means of revolution numbers so that the dope is uniformly cast from a cap (slit) of the pressurizing die onto a metal support of the casting part which runs endlessly and, at the peeling point when the metal support almost goes round, the semi-dried dope film (may also be called as a web) is peeled off from the metal support. Both ends of the resulting web are fastened with clips, dried by conveying using a tenter where the width is maintained, then conveyed using a roll group of a drying machine to finish the drying and wound in a predetermined length using a winding machine. Combinations of the tenter with the drying machine of a roll group vary depending upon the object. In a method for manufacturing the film by casting the solution used for a functional protective film for electronic display, there are many cases where an applying apparatus is further added for a surface treatment of the film such as undercoating layer, antistatic layer, halation-preventing layer and protective layer in addition to a manufacturing apparatus for the film by casting the solution. Each of the manufacturing steps will be briefly illustrated as follows although they are non-limitative.

In the manufacture of a cellulose acylate film by a solvent cast method, the cellulose acylate solution (dope) prepared as above is firstly cast on a drum or a band to evaporate the solvent to form a film. It is preferred that concentration of the dope before casting is adjusted so as to make the solid content 5 to 40% by mass. Surface of the drum or the band is preferred to be finished in a state of a mirror plate. A method where the dope is cast on the drum or the band where the surface temperature is not higher than 30° C. is preferably adopted and it is particularly preferred that the temperature of the metal support is within a range of −10 to 20° C. In the present invention, it is also possible to use the methods mentioned in Japanese Patent Laid-Open Nos. 2000/301,555 A, 2000/301,558 A, 07/032,391 A, 03/193,316 A, 05/086,212 A, 62/037,113 A, 02/276,607 A, 55/014,201 A, 02/115,511 A and 02/208,650 A.

### [Layered Casting]

The cellulose acylate solution may be cast as a single layer liquid on a flat band or drum as a metal support or cellulose acylate solutions in two or more layers may be cast. When plural cellulose acylate solutions are cast, it is possible that each solution containing cellulose acylate is cast from plural casting openings installed with intervals in the moving direction of the metal support so that a film is formed by means of layering and the methods mentioned, for example, in Japanese Patent Laid-Open Nos. 51/158,414 A, 01/122,419 A and 11/198,285 A may be adopted. It is also possible that a cellulose acylate solution is cast from two casting openings to make into a film and the methods mentioned, for example, in Japanese Patent Laid-Open Nos. 60/027,562 A, 61/094,724 A, 61/947,245 A, 61/104,813 A, 61/158,413 A and 06/134,933 A may be adopted. It is further possible to conduct a cellulose acylate casting method where a flow of the highly viscous cellulose acylate solution is enclosed in a lowly viscous cellulose acylate solution and said highly and lowly viscous cellulose acylate solutions are extruded at the same time as mentioned in Japanese Patent Laid-Open No. 56/162,617 A. It is also a preferred embodiment that, as mentioned in Japanese Patent Laid-Open Nos. 61/094,724 A and 61/094,725 A, the solution in the outside contains more alcohol component which is a poor solvent than the inner side solution. It is also possible to conduct a method where, using two casting openings, a film formed on a metal support by the first casting opening is peeled off and then the second casting is carried out on the side which contacts to the metal support side of the film whereupon a film in plural layers is produced and a method mentioned in Japanese Patent Laid-Open No. 44/020,235 A may be exemplified. The cellulose acylate solutions may be the same or may be different cellulose acylate solution and there is no particular limitation therefor. In order to bestow functions on the plural cellulose acylate layers, a cellulose acylate solution corresponding to the function may be extruded from each casting opening. It is also possible that the cellulose acylate solution is cast together with other functional layers such as adhesive layer, dye layer, antistatic layer, anti-halation layer, UV absorptive layer and polarizing layer.

In the conventional single-layer solution, it is necessary to extrude a cellulose solution of high concentration and high viscosity for achieving the necessary film thickness and, in that case, there are often many problems such as that stability of the cellulose acylate solution is apt to become bad to generate solids causing troubles due to particles or making the flatness of the product poor. As a means for solving the above, plural cellulose acylate solutions are cast from plural casting openings relatively little by little whereby it is now possible to extrude highly viscous solution onto a metal support at the same time whereupon the outcome is not only that flatness is improved to give film with an excellent surface is able to be produced but also that, as a result of the use of a concentrated cellulose acylate solution, reduction in a drying load is able to be achieved and production speed of the film is able to be enhanced.

Although there is no particular limitation for the thickness of the inside and the outside in the case of a co-casting, it is preferred that the thickness of the outside is 1 to 50% of the total film thickness and, more preferably, it is 2 to 30%. In the case of a co-casting for three or more layers, the total film thickness of the layer contacting to the metal support and the layer contacting to the air is defined as the thickness of the outside. In the case of a co-casting, it is also possible that cellulose acylate solutions in which the concentrations of the additives such as above-mentioned plasticizer, ultraviolet absorptive agent and matting agent are different are subjected to a co-casting whereupon a cellulose acylate film in a layered structure is prepared. For example, a cellulose acylate film in a constitution of (skin layer)/(core layer)/(skin layer) is able to be prepared. For example, a matting agent is placed in much amount in the skin layer or in the skin layer only. Plasticizer and ultraviolet absorptive agent may be placed into a core layer in more amount than in a skin layer or may be placed in a core layer only. It is also possible that type of the plasticizer and the ultraviolet absorptive agent may be changed between the core layer and the skin layer. Thus, for example, at least any of a lowly volatile plasticizer and ultraviolet absorptive agent is contained in a skin layer while a plasticizer having a good plasticizing property or an ultraviolet absorptive agent having a good ultraviolet absorptive property is added to a core layer. It is also a preferred embodiment that a peeling promoter is contained only in a skin layer of the metal support side. It is also preferred that an alcohol which is a poor solvent is added in more amount to a skin layer than to a core layer so that a metal support is cooled in a cooling drum method to make the solution into gel. Tg of the skin layer may be different from that of the core layer and it is preferred that Tg of the core layer is lower than that of the skin layer. Further, viscosity of a solution containing cellulose acylate upon casting may be different between the skin layer and the core layer and, although it is preferred that viscosity of the skin layer is lower than that of the core layer, viscosity of the core layer may be lower than that of the skin layer.

### [Casting Method]

With regard to a casting method of the solution, there are a method where the prepared dope is uniformly extruded from a pressurizing die onto a metal support, a method using a doctor blade where the dope which was once cast onto the metal support is subjected to adjustment of film thickness by a blade, a method using a reverse roll coater being adjusted by a reversely rotating roll, etc. and a method using a pressurizing die is preferred. There are a coat hanger type, a T die type, etc. in a pressurizing die and any of them may be preferably used. Besides the above-mentioned methods, it is also possible to conduct various methods such as conventionally known where a cellulose triacetate solution is cast to make a film and, when each condition is set by taking the difference in boiling point of the solvent used, etc. into consideration, the same effect as that mentioned in each patent is able to be achieved.

With regard to a metal support which runs endlessly used for the manufacture of a cellulose acylate film preferably used in the present invention, a drum where the surface is made into a mirror plate by means of a chromium plating or a stainless belt (may be also called as a band) made into a mirror plate by a surface abrasion is used. The pressurizing die used therein may be set one or more on the upper side of a metal support. Preferably, one or two die(s). When two or more are installed, amount of the dope to be cast may be provided in various rates for each die or each dope in a predetermined amount is sent to each die from each of plural precisely quantifying gear pumps. Temperature of the cellulose acylate used for casting is preferably −10 to 55° C. and, more preferably, 25 to 50° C. In that case, temperature of the solution in all steps may be same or may be different for each step. When it is different, that may be a predetermined temperature immediately before the casting.

### [Drying]

Drying of a dope on a metal support concerning the manufacture of a cellulose acylate film is usually carried out by a method where hot air is applied to the front surface of the metal support (drum or belt) or, in other words, to the surface of a web on the metal support, a back-side liquid heated transfer method where a liquid in which the temperature is controlled is contacted to the back which is an opposite side of the casting side of the dope of the belt or drum and the surface temperature is controlled by heat transfer, etc. and, among them, a back-side liquid heat transfer method is preferred. Surface temperature of the metal support before being cast may be free provided that it is not higher than the boiling point of the solvent used for the dope. However, in order to promote the drying and also to eliminate the fluidity on the metal support, it is preferred to set at the temperature which is lower, to an extent of 1 to 10° C., than the boiling point of the solvent having the lowest boiling point among the solvents used. Incidentally, the above is not applied to the case where the cast dope is cooled and peeled off without drying.

In order to suppress the leakage of the light when the above polarizing plate is seen from an oblique side, it is necessary that a transmitting axis of polarizer and an in-plane slow axis of cellulose acylate film are aligned in parallel. A transmitting axis of a polarizer in a form of roll film manufactured continuously is usually parallel to the width direction of the roll film and, therefore, it is necessary that the in-plane slow axis of protective film in a form of roll film is parallel to the width direction of the film for such an object that the above polarizer in a form of roll film is continuously adhered to the protective film comprising cellulose acylate film in a form of roll film. Accordingly, it is preferred to stretch much more in the width direction. The stretching treatment may be carried out during the film manufacturing step or may be carried out in such a manner that the original sheet which was filmed and rolled is subjected to a stretching treatment. In the former case, the stretching may be carried out under the state where a residual solvent is still contained or the stretching may be preferably carried out when the residual solvent amount is 2 to 30% by mass.

Film thickness of the cellulose acylate film prepared after drying preferably used in the present invention varies depending upon the object of use. Usually, it is preferably within a range of 5 to 500 μm, more preferably within a range of 20 to 300 μm and, particularly preferably, within a range of 30 to 150 μm. In the case of optical use and particularly for a VA liquid crystal display device, it is preferred to be 40 to 110 μm. Adjustment of the film thickness is carried out by adjusting the solid concentration contained in a dope, the slit gap of the cap of the die, the extruding pressure from the die, the speed of the metal support, etc. so as to give a desired thickness.

### [Stretching Treatment]

It is preferred that the optical film of the present invention is prepared by a stretching treatment. As a result of the stretching treatment, alignment of the retardation developer is able to be effectively controlled and a desired retardation is able to be bestowed on the film. With regard to the stretching direction of the film, any of the width direction and longitudinal direction is preferred.

A method for stretching in the width direction is mentioned, for example, in Japanese Patent Laid-Open Nos. 62/115,035 A, 04/152,125 A, 04/184,211 A, 04/298,310 A and 11/048,271 A.

Temperature for stretching the film is preferably from (Tg+10° C.) to (Tg+60° C.) and, more preferably, from (Tg+10° C.) to (Tg+40° C.).

When the retardation developer is a liquid crystal compound, it is preferred that stretching is carried out at the temperature which is not lower than the transition temperature between crystal and liquid crystal of the retardation developer and the film is kept at a predetermined stretching magnification until the temperature becomes the transition temperature between liquid crystal and crystal so that stress applied to the film is maintained. When the film is stretched under the above-mentioned condition, it is now possible to enhance the degree of alignment of the retardation developer and to achieve a high retardation developing efficiency.

In the case of stretching in a longitudinal direction, the film is able to be stretched when, for example, speed of the conveying roller of the film is adjusted so that the winding speed of the film is made quicker than the peeling speed of the film. In the case of stretching in a width direction, it is also possible to stretch the film when conveyance is conducted where width of the film is held by a tenter and the width of the tenter is gradually made broad. It is further possible that stretching is conducted using a stretching machine after drying of the film (preferably by a uniaxial stretching using a long stretching machine).

In the present invention, a method for the manufacture of a cellulose acylate which is characterized in containing a stretching step where the film is stretched in a conveying direction and a shrinking step where the film is shrunk in holding the film in a width direction of the film or a method for the manufacture of a cellulose acylate which is characterized in containing a stretching step where the stretching is carried out in a width direction of the film and then a shrinking step where shrinking is carried out in a conveying direction of the film is used particularly preferably.

Firstly, a method for the manufacture of a cellulose acylate which is characterized in containing a stretching step where the film is stretched in a conveying direction and a shrinking step where the film is shrunk in holding the film in a width direction of the film will be illustrated.

In that case, the film is stretched in the conveying direction of the film and, with regard to a method for stretching in the conveying direction of the film, a method where speed of the conveying roller for the film is adjusted so that a winding speed of the film is made quicker than a peeling speed of the film is preferably used.

In that case, width of the film is held by a tenter and conveyance is conducted and the width of the tenter is gradually made narrow whereupon it is possible that the film is shrunk nearly in a crossed state to the stretching direction of the film.

To be more specific, holding by a tenter of a chain type, a screw type, a pantograph type, a linear motor type, etc. is conducted and, together with stretching in the conveying direction, width of the tenter is gradually made narrow whereupon the film is able to be stretched and is also able to be shrunk at the same time in an orthogonal direction.

On the other hand, in a method for the manufacture of cellulose acylate which is characterized in containing a stretching step where stretching is conducted in a width direction of film and a shrinking step where shrinking is conducted in a conveying direction of film, the film is able to be shrunk by means of holding using a chain type, a screw type, a pantograph type, a linear motor type, etc. and, at the same time, by stretching in a conveying direction so that width of tenter is gradually made narrow.

In the above-mentioned methods, the outcome is that at least a part of the stretching step and the shrinking step are carried out at the same time.

With regard to a stretching apparatus in which any of the longitudinal direction and the width direction of the film is stretched together with shrinking of another is carried out and, at the same time, a stretching step where thickness of the film is increased are specifically conducted as mentioned above, an FITZ machine manufactured by Ichikane Kogyo, etc. may be preferably used. The apparatus is mentioned in Japanese Patent Laid-Open No. 2001/038,802 A.

With regard to a stretching rate in the stretching step and a shrinking rate in the shrinking step, although appropriate values may be freely selected depending upon the values of an in-plane retardation Re and of a retardation in the film thickness direction Rth, it is preferred to conduct in such a manner that the stretching rate in the stretching step is made not less than 10% and the shrinking rate in the shrinking step is made not less than 5%.

In the present invention, a stretching rate means a rate of elongation of film length after the stretching in a stretched direction to film length before the stretching and a shrinking rate means a rate of shrunk length of film after the shrinking in a shrinking direction to film length before the shrinking.

The stretching rate is preferably 3 to 200%, more preferably 10 to 100% and, particularly preferably, 15 to 45%. On the other hand, the shrinking rate is preferably 5 to 40% and, particularly preferably, 10 to 30%.

A treating temperature is temperature of the film surface measured by an infrared thermometer of a non-contacting type.

It is also possible to stretch using a stretching machine after drying the film (preferably a uniaxial stretching using a long stretching machine). The stretching may be carried out either in one stage or in multiple stages. When it is conducted in multiple stages, the product of the stretching powders is to be made within the above-mentioned range.

A stretching speed is preferably 5% per minute to 1,000% per minute and, more preferably, 10% per minute to 500% per minute. It is preferred that the stretching is carried out by a heat roll and/or radiated heat source (such as an IR heater) or hot air. In order to enhance the uniformity of the temperature, a constant-temperature vessel may be installed. When a uniaxial stretching is carried out by a roll stretching, L/W which is a ratio of the distance (L) between rolls to the width of film (W) is preferred to be from 2.0 to 5.0.

Width of the cellulose acylate film prepared as above is preferably 0.5 to 3 m, more preferably 0.6 to 2.5 m and, still more preferably, 0.8 to 2.2 m. With regard to the length, it is preferred to wind at 100 to 10,000 m per roll, more preferably 500 to 7,000 m per roll and, still more preferably, 1,000 to 6,000 m per roll. In winding, it is preferred to give a knurling at least on one side and width of the knurling is preferably 3 mm to 50 mm and, more preferably, 5 mm to 30 mm while its height is preferably 0.5 to 500 μm and, more preferably, 1 to 200 μm. It may be either a one-side pushing or a both-side pushing.

Deviation of Re (590) values in the width direction of film is preferably ±5 nm and, more preferably, ±3 nm. Deviation of Rth 590 values in the width direction is preferably ±10 nm and, more preferably, ±5 nm. Deviations of Re value and Rth value in the longitudinal direction are also preferred to be within that in the width direction.

### [Optical Characteristics of Cellulose Acylate Film]

In the present specification, Reλ and Rthλ stand for an in-plane retardation and a retardation in the thickness direction, respectively at the wavelength λ. Reλ is measured using an automatic double refractometer such as Kobra 21ADH (manufactured by Oji Keisoku Kiki K. K.) by incidence of light of λ nm wavelength into a normal line direction of the film. Rthλ is calculated by an automatic double refractometer such as Kobra 21 ADH on the basis of a retardation value measured in three directions in total, i.e. the above-mentioned Reλ, a retardation value measured by incidence of light of wavelength of λ nm from the direction inclined at +40° to the normal line direction of the film using a slow axis (judged by an automatic double refractometer such as Kobra 21 ADH) as an inclination axis (rotation axis) and a retardation value measured by incidence of light of wavelength of λ nm from the direction inclined at −40° to the normal line direction of the film using a slow axis as an inclination axis (rotation axis).

Here, with regard the presumed value for average refractive index, data in “Polymer Handbook” (John Wiley & Sons, Inc.) and catalogs of various optical films may be used. In case data of average refractive index have not been known, measurement by Abbe's refractometer may be carried out. Data of average refractive index for main optical films will be exemplified as follows.

Thus, cellulose acylate (1.48), cycloolefin polymer (1.52), polycarbonate (1.59), polymethyl methacrylate (1.49) and polystyrene (1.59).

When the presumed value of the average refractive index as such and film thickness are inputted, nₓ (refractive index in the direction of film production), n_{y} (refractive index in the width direction) and n_{z} (refractive index in the thickness direction) are calculated by an automatic double refractometer such as Kobra 21 ADH. In addition, an automatic double refractometer such as Kobra 21 ADH also calculates the angle β to a normal line direction of a film where retardation value becomes smallest to the light transmitting in the film when an in-plane slow axis is an inclining angle.

The cellulose acylate film of the present invention is used as a protective film for a polarizing plate and is able to be particularly preferably used as a phase contrast film corresponding to various liquid crystal modes.

When the cellulose acylate film of the present invention is used as a phase contrast film, the preferred optical characteristics of the cellulose acylate film vary depending upon the liquid crystal mode.

For an OCB mode, Re is preferably 10 to 100 and, more preferably, 20 to 70. Rth is preferably 50 to 300 and, more preferably, 100 to 250.

For a VA mode, Re is preferably 20 to 150 and, more preferably, 30 to 120. Rth is preferably 50 to 300 and, more preferably, 120 to 250.

For a TN mode, Re is preferably 0 to 50 and, more preferably, 2 to 30. Rth is preferably 10 to 200 and, more preferably, 30 to 150.

For an IPS mode, Re is preferably 0 to 50 and, more preferably, 0 to 2. Rth is preferably −20 to 20 and, more preferably, −10 to 10.

In a mode for OCB a mode for TN, an optically anisotropic layer is applied on the cellulose acylate film having the above-mentioned retardation values and the resulting one is used as an optically compensatory film.

Double refractive index (Δn: nx−ny) of the cellulose acylate film is preferred to be within a range of 0.00 to 0.002 μm. Double refractive index {(nx+ny)/2−nz} of the support film and the opposing film is preferably within a range of 0.00 to 0.04.

When the cellulose acylate film which is preferably used in the present invention is used for a VA mode, there are two ways where one is a form in which each one sheet is used on both sides of the cell or two sheets in total (two-sheet type) and another is a form in which the film is used only on one of the upper or lower side of the cell (one-sheet type).

In the case of a two-sheet type, Re₅₉₀ is preferably 20 to 100 nm and, more preferably, 30 to 70 nm while Rth₅₉₀ is preferably 70 to 300 nm and, more preferably, 100 to 200 nm.

In the case of a one-sheet type, Re₅₉₀ is preferably 30 to 150 nm and, more preferably, 40 to 100 nm while Rth₅₉₀ is preferably 100 to 300 nm and, more preferably, 150 to 250 nm.

Deviation of in-plane slow axis angles of the cellulose acylate film which is preferably used in the present invention to the standard direction of a roll film is preferably within a range of −2° to +2°, more preferably within a range of −1° to +1° and, most preferably, within a range of −0.5° to +0.5°. The term of standard angle used here means a longitudinal direction of a roll film when the cellulose acylate film is subjected to a longitudinal stretching and means a width direction when subjected to a transverse direction.

In the cellulose acylate film which is preferably used in the present invention, it is preferred in reducing the tint of a liquid crystal display device with lapse of time when the difference (=Re_{10%}−Re_{80%}) between Re value at 25° C. and 10% RH and Re value at 25° C. and 80% RH is made 0 to 10 nm and the difference (=Rth_{10%}−Rth_{80%}) between Rth value at 25° C. and 10% RH and Rth value at 25° C. and 80% RH is made 0 to 30 nm.

It is also preferred in reducing the tint of a liquid crystal display device with lapse of time when an equilibrated water content of the cellulose acylate film which is preferably used in the present invention at 25° C. and 80% RH is not more than 3.2%.

Measurement of water content is conducted by a Karl-Fischer method of a cellulose acylate sample (7 mm×35 mm) using a water content measuring machine and a sample drying apparatus (CA-03 and VA-05, both manufactured by Mitsubishi Chemical). Calculation is conducted by dividing the water amount (g) by mass of the sample (g).

It is also preferred in reducing the tint of a liquid crystal display device with lapse of time when a moisture permeability of the cellulose acylate film which is preferably used in the present invention at 60° C. and 95% RH for 24 hours (on the basis of film thickness of 80 μm) is from 400 g/m²·24 hrs to 1,800 g/m²·24 hrs.

With regard to the moisture permeability, it becomes small when the thickness of the cellulose acylate film is thick while it becomes large when the film thickness is thin. Therefore, it is necessary to set a standard film thickness and to calculate for samples of any film thickness. In the present invention, film thickness is calculated according to the following formula (13) where film thickness to be used as a standard is set at 80 μm.

Moisture permeability calculated on the basis of 80 μm=(Actually measured moisture permeability)×(Actually measured film thickness in μm)/80 μm Formula (13)

With regard to a method for the measurement of moisture permeability, a method mentioned in “Properties of Polymers. II” (Experiments of Polymers-4, published by Kyoritsu Shuppan), pages 285 to 294, Measurement of Permeated Amount of Vapor (mass method, thermometer method, vapor pressure method and adsorptive amount method) may be adopted.

Measurement of glass transition temperature is conducted in such a manner that, after the cellulose acylate film sample (un-stretched) (5 mm×30 mm) is moisturized at 25° C. and 60% RH for not shorter than 2 hour, measurement is done using a dynamic viscoelasticity measuring apparatus (Vibron DVA-225 manufactured by IT Keisoku Seigyo K. K.) under the condition where length between grips was 20 mm, raising speed of temperature was 2° C./minute, measuring temperature range was 30° C. to 200° C. and frequency was 1 Hz and, when a storage elastic modulus is shown by a logarithmic axis in an ordinate while temperature (° C.) is shown by a linear axis in an abscissa, the temperature where a sudden reduction in storage elastic modulus is shown being noted in the case of transition of storage elastic modulus from a solid region to a glass transition region is defined as a glass transition temperature Tg. To be more specific, when a line 1 is drawn in the solid region while a line 2 is drawn in the glass transition region in the resulting chart, a crossing point of the line 1 and the line 2 is the temperature where the storage elastic modulus upon raising the temperature suddenly decreases and the film is started to become soft and also the temperature where transfer to the glass transition temperature begins and, accordingly, that is defined as a glass transition temperature Tg (dynamic viscoelasticity).

Measurement of elastic modulus is carried out in such a manner that, after the cellulose acylate film sample (10 mm×150 mm) is moisturized at 25° C. and 60% RH for not shorter than 2 hours, it is subjected to a tensile tester “Strograph-R2” (manufactured by K. K. Toyo Seiki Seisakusho) under the condition where distance between chucks is 100 mm, temperature is 25° C. and stretching speed is 10 mm/minute.

With regard to measurement of expansion coefficient upon moisturization, it is determined by the following formula (14) from the value L_{80%} which is a value measured by a pin gauge of film size after being allowed to stand for not shorter than 2 hours at 25° C. and 80% RH and the value L_{10%} which is a value measured by a pin gauge of film size after being allowed to stand for not shorter than 2 hours at 25° C. and 10% RH.

(L_{80%}−L_{10%})/(80% RH−10% RH)×10⁶ Formula (14)

With regard to the cellulose acylate film which is preferably used in the present invention, its haze is preferred to be within a range of 0.01 to 2%. The haze is able to be measured as follow.

Thus, haze is measured according to JIS K-6714 using a cellulose acylate film sample (40 mm×80 mm) by a haze meter “HGM-2DP” (manufactured by Suga Shikenki K. K.) at 25° C. and 60% RH.

With regard to the cellulose acylate film which is preferably used in the present invention, it is also preferred that changes in mass when allowed to stand under the condition of 80° C. and 90% RH for 48 hours are within a range of 0 to 5% by mass.

With regard to the cellulose acylate film which is preferably used in the present invention, it is also preferred that changes in the size when allowed to stand under the condition of 60° C. and 95% RH for 24 hours and under the condition of 90% and 5% RH for 24 hours are within a range of 0 to 5% for both cases.

With regard to an optically elastic coefficient, it is preferred to be not more than 50×10⁻¹³ cm²/dyn (50×10⁻⁸ cm²/N) so that the changes in tint with lapse of time of a liquid crystal display device are made small.

As to a specific measuring method, there is used a method where a cellulose acylate film sample (10 mm×100 mm) is subjected to a tensile stress in the long-axis direction, the retardation at that time is measured by an ellipsometer such as “M 150” (manufactured by Nippon Bunko K. K.) and an optical elastic coefficient is calculated from the changes in retardation by the stress.

### [Melt Film Formation]

A method for the manufacture of the optical film of the present invention may be conducted by a melt film formation. Materials such as additives may be heated to melt followed by making into film by means of an extrusion injection molding or materials may be sandwiched between two heated plates followed by making into film by means of a press working.

There is no particular limitation for the temperature of heating to melt so far as it is temperature at which all of the starting polymers are uniformly melted. To be more specific, heating is conducted at the temperature which is not lower than melting point or softening point. In order to prepare a uniform film, it is preferred to melt by heating at the temperature which is higher than melting point of the material polymer, more preferably at the temperature which is higher than the melting point to an extent of 5 to 40° C. and, particularly preferably, at the temperature which is higher than the melting point to an extent of 8 to 30° C.

### [Oriented Film]

In an optically compensatory film, there may be an oriented film between the cellulose acylate film of the present invention and the optically anisotropic layer. It is also possible that an oriented film is used only when an optically anisotropic layer is prepared and, after an optically anisotropic layer is prepared on the oriented film, only said optically anisotropic layer may be transferred onto the cellulose acylate film of the present invention.

In the present invention, the above-mentioned oriented film is a layer comprising a cross-linked polymer. With regard to the polymer used for the oriented film, any of a polymer which is able to be cross-linked by itself and a polymer which is cross-linked by a cross-linking agent may be used. The above-mentioned oriented film may be formed either by such a manner that a polymer having a functional group or a polymer into which a functional group is introduced is made to react among the polymers as such by light, heat or pH change or by such a manner that a bonding group derived from a cross-linking agent is introduced among polymers using a cross-linking agent which is a compound having a high reactivity and cross-linking is conducted among the polymers.

An oriented film comprising a cross-linked polymer is usually able to be formed by applying a solution containing the above-mentioned polymer or a mixture of a polymer and a cross-linking agent onto a support followed by, for example, heating. In order to suppress the generation of dust from an oriented film in the rubbing step which will be mentioned later, it is preferred to raise the cross-linking degree. When a value where a ratio (Ma/Mb) of the amount (Ma) of a cross-linking agent remained after cross-linking to the amount (Mb) of a cross-linking agent added to the above applying solution to is deducted from 1 (1−(Ma/Mb)) is defined as a cross-linking degree, the cross-linking is preferably 50% to 100%, more preferably 65% to 100% and, most preferably, 75% to 100%.

With regard to the polymer used in the above-mentioned oriented film in the present invention, any of a polymer which is able to be cross-linked by itself and a polymer which is cross-linked by a cross-linking agent may be used. It is of course possible to use a polymer having both functions. Examples of the above-mentioned polymer are polymers such as polymethyl methacrylate, acrylic acid/methacrylic acid copolymer, styrene-maleinimide copolymer, polyvinyl alcohol and modified polyvinyl alcohol, poly(N-methyolacrylamide), styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethyl cellulose, gelatin, polyethylene, polypropylene and polycarbonate and compounds such as a silane coupling agent. Examples of preferred polymers are water-soluble polymers such as poly(N-methylolacrylamide), carboxymethyl cellulose, gelatin, polyvinyl alcohol and modified polyvinyl alcohol, more preferred ones are gelatin, polyvinyl alcohol and modified polyvinyl alcohol and the particularly preferred ones are polyvinyl alcohol and modified polyvinyl alcohol.

When polyvinyl alcohol and modified polyvinyl alcohol are directly applied to the cellulose acylate film of the present invention, a method where a hydrophilic undercoating layer is formed or a saponifying treatment is conducted is preferably used.

Among the above-mentioned polymers, polyvinyl alcohol or modified polyvinyl alcohol is preferred.

With regard to polyvinyl alcohol, that where degree of saponification is 70 to 100% is exemplified. Usually, that where degree of saponification is 80 to 100% is preferred and that where degree of saponification is 82 to 98% is more preferred. With regard to degree of polymerization, that within a range of 100 to 3,000 is preferred.

With regard to modified polyvinyl alcohol, modified polyvinyl alcohol such as that which is modified by copolymerization (COONa, Si(OX)₃, N(CH₃)₃.Cl, C₉H₁₉COO, SO₃Na, C₁₂H₂₅, etc. are introduced as a modifying group), that which is modified by chain transfer (COONa, SH, SC₁₂H₂₅, etc. are introduced as a modifying group) and that which is modified by block polymerization (COOH, CONH₂, COOR, etc. (R is an alkyl group having 12 or less carbons) is introduced as a modifying group) are exemplified. With regard to degree of polymerization, that within a range of 100 to 3,000 is preferred. Among them, unmodified or modified polyvinyl alcohol where degree of saponification is 80 to 100% is preferred and more preferred one is unmodified or alkylthio-modified polyvinyl alcohol where degree of saponification is 85 to 95%.

In order to bestow a close adhesion of the cellulose acylate film with an optically anisotropic layer, it is preferred to introduce a cross-linking and polymerization-activating group into said polyvinyl alcohol and its preferred example is mentioned in detail in Japanese Patent Laid-Open No. 08,338,913 A.

When a hydrophilic polymer such as polyvinyl alcohol is used as an oriented film, it is preferred to control the water content in view of degree of hard film. It is preferably 0.4% to 2.5% and, more preferably, 0.6% to 1.6%. Water content is able to be measured by a commercially available water content measuring machine by Karl-Fischer method.

The oriented film is preferred to be in a thickness of not more than 10 microns.

Re(550) and Rth(550) of the cellulose acylate film of the present invention are preferred to be with a range of 20 to 100 nm and 100 to 300 nm, respectively.

Particularly when it is used as an optically compensatory film in a liquid crystal display device for VA and when only one sheet is used for compensation on one side of liquid crystal cell, it is preferred that Re(550) is within a range of 40 to 100 nm and Rth(550) is within a range of 160 to 300 nm and, more preferably, Re(550) is within a range of 45 to 80 nm and Rth(550) is within a range of 170 to 250 nm.

On the contrary, when it is used on both sides of liquid crystal cell as an optically compensatory film of a liquid crystal display device for VA and compensation is conducted by two sheets, it is preferred that Re(550) is within a range of 20 to 100 nm and Rth(550) is within a range of 100 to 200 nm and, more preferably, Re(550) is within a range of 25 to 80 nm and Rth(550) is within a range of 100 to 150 nm.

With regard to the cellulose acylate film of the present invention, that which satisfied the following formulae (I) to (III) is preferred.

0.4<{Re(450)/Rth(450)}/(Re(550)/Rth(550))}<0.95 and 1.05<{Re(650)/Rth(650)}/(Re(550)/Rth(550))}<1.9; Formula (I)

0.1<(Re(450)/(Re(550))<0.95; and Formula (II)

1.03<(Re(650)/(Re(550))<1.93. Formula (III)

More preferably,

0.5<{Re(450)/Rth(450)}/(Re(550)/Rth(550))}<0.9 and 1.1<{Re(650)/Rth(650)}/(Re(550)/Rth(550))}<1.7; Formula (I)

0.2<(Re(450)/(Re(550))<0.9; and Formula (II)

1.1<(Re(650)/(Re(550))<1.7. Formula (III)

### [Polarizing Plate]

The present invention provides a polarizing plate comprising a polarization film and a pair of protective films sandwiching said polarization film where at least one sheet of the above protective films contains the above-mentioned cellulose acylate film. For example, it is possible to use a polarizing plate which is prepared in such a manner that a polarization film comprising polyvinyl alcohol, etc. is stained with iodine and stretched and both sides thereof are layered with a protective film. Said polarizing plate is aligned outside the liquid crystal cell. It is preferred that a pair of polarizing plates comprising a polarization film and a pair of protective films sandwiching said polarization film are aligned in sandwiching a liquid crystal cell. Incidentally, a protective film which is aligned to the liquid crystal cell side is preferred to be the optically compensatory film or the cellulose acylate film of the present invention.

### <<Adhesive>>

Although there is no particular limitation for the adhesive used for polarization film with the protective film, there may be exemplified PVA resin (including PVA modified by acetoacetyl group, sulfonic acid group, carboxyl group, oxyalkylene group, etc.) and an aqueous solution of boronated compound and, among them, PVA resin is preferred. Thickness of the adhesive layer after drying is preferably 0.01 to 10 micron(s) and, particularly preferably, 0.05 to 5 micron(s).

### <<Integrated Manufacturing Step for Polarization Film and Protective Film>>

The polarizing plate which is able to be used in the present invention is able to be manufactured by conducting a drying step where volatile matter rate is lowered by shrinking after a film for polarization film is stretched and it is preferred that, after drying or during drying, a protective film is adhered at least to one side and then a heating step is conducted. Examples of the specific method for adhesion are a method where, during the drying step of the film, a protective film is adhered to a polarization film using an adhesive in such a state that both ends are held and, after that, both ends are cut off and a method where, after drying, a film for polarization film is released from the held part at both ends, both ends of the film are cut off and a protective film is adhered. With regard to a method for cutting off, common art such as a method where cutting is done by a cutter such as a knife and a method where laser is used may be used. It is preferred to heat after adhesion so as to dry the adhesive and to make a polarizing property good. Although the condition for the heating varies depending upon the adhesive, it is preferred in the case of an aqueous system to heat at not lower than 30° C., more preferably 40° C. to 100° C. and, still more preferably, 50° C. to 90° C. It is more preferred in view of property and production efficiency to manufacture where those steps are carried out in an integrated line.

### <<Property of Polarizing Plate>>

It is preferred that optical property and durability (preservability for short and long terms) of the polarizing plate of the present invention are the same as or even better than the commercially available super high contrast products (such as HLC2-5618 manufactured by K. K. Sunritz). To be more specific, it is preferred that transmittance of visible light is not lower than 42.5%, polarization degree {(Tp−Tc)/(Tp+Tc)}½>0.9995 (in which Tp is parallel transmittance and Tc is orthogonal transmittance), changes in light transmittance before and after being allowed to stand in an atmosphere of 60° C. temperature and 90% RH for 500 hours and in a dry atmosphere of 80° C. for 500 hours on the basis of absolute values are preferably not more than 3% or, preferably, not more than 1% and changing rate of polarization degree on the basis of absolute values are preferably not more than 1% or, more preferably, not more than 0.1%.

### [Surface Treatment of Cellulose Acylate Film]

When the cellulose acylate film which is preferably used in the present invention is subjected a surface treatment if necessary, it is possible to achieve an improvement in adhesive property between the cellulose acylate film and each of functional layers (such as an undercoating layer and back layer). With regard to the surface treatment, it is possible to use, for example, a glow discharge treatment, an ultraviolet irradiation treatment, a corona treatment, a flame treatment and a treatment with acid or alkali. In the case of a glow discharge treatment, a low-temperature plasma taking place under a low gas pressure of 10⁻³ to 20 Torr may be used and a plasma treatment under atmospheric pressure is also preferred. A plasma exciting gas is gas which is subjected to plasma excitation under the above condition and its examples are argon, helium, neon, krypton, xenon, nitrogen, carbon dioxide and fluorinated hydrocarbon such as tetrafluoromethane as well as a mixture thereof. They are mentioned in detail in Journal of Technical Disclosure, 2001-1745 (published on Mar. 15, 2001 by the JIII), pages 30 to 32. In a plasma treatment at atmospheric pressure which has been recently receiving public attention, irradiation energy of 20 to 500 kGy under 10 to 1,000 keV is used for example and, more preferably, irradiation energy of 20 to 300 kGy under 30 to 500 keV is used. Among them, the particularly preferred one is a saponifying treatment with alkali and it is quite useful as a surface treatment of a cellulose acylate film.

[Saponifying Treatment with Alkali]

A saponifying treatment with alkali is preferred to be carried out by a method where a cellulose acylate film is directly dipped in a vessel of a saponifying solution or by a method where a saponifying liquid is applied to a cellulose acylate film. Examples of the method for application are a dip coating method, a curtain coating method, an extrusion coating method, a bar coating method and an E-type application method. Since a saponifying liquid is applied to a cellulose acylate film, a solvent of an applying solution for a saponifying treatment with alkali is preferred to have a good wetting property and to keep the surface state good without formation of unevenness on the cellulose acylate film surface by the solvent for saponifying liquid. To be more specific, an alcohol-type solvent is preferred and isopropyl alcohol is particularly preferred. It is also possible to use an aqueous solution of a surfactant as a solvent. With regard to the alkali for the applying liquid for alkali saponification, an alkali which is soluble in the above solvent is preferred and KOH and NaOH are more preferred. The pH after application of a saponifying liquid is preferably not lower than 10 and, more preferably, not lower than 12. Reaction condition for the alkali saponification is preferably at room temperature for 1 second to 5 minutes, more preferably for 5 seconds to 5 minutes and, particularly preferably, 20 seconds to 3 minutes. After the saponifying reaction with alkali, it is preferred that the surface to which the saponifying liquid is applied is washed with water or with acid followed by washing with water.

The polarizing plate concerning the present invention is preferred to be installed with an optically anisotropic layer on a protective layer.

In the optically anisotropic layer, there is no limitation for a material therefor and its examples are a liquid crystal compound, a non-liquid crystal compound, an inorganic compound and an organic/inorganic complex compound. With regard to a liquid crystal compound, that where a low-molecular compound having a polymerizing group is aligned and the alignment is fixed by light, heat or polymerization and that where a liquid crystal polymer is heated to align and cooled so that the alignment is fixed in a glass state may be used. With regard to a liquid crystal compound, that having a discotic structure, that having a rod-shaped structure and that having a structure which shows an optically biaxial property may be used. With regard to a non-liquid crystal compound, polymer having an aromatic ring such as polyimide and polyester may be used.

With regard to a method for the formation of an optically anisotropic layer, various means such as application, vapor deposition and sputtering are able to be used.

When an optically anisotropic layer is formed on a protective layer of the polarizing plate, an adhesive layer is formed on the further outer side of said optically anisotropic layer from the side of the polarizer.

Moreover, it is preferred that the polarizing plate of the present invention is installed with at least one of hard coat layer, anti-glare and antireflection layer on the surface of the protective layer at least on one side of the polarizing plate. Thus, in actual use of the polarizing plate for a liquid crystal display device, it is preferred to install a functional film such as a antireflection layer on a protective film aligned on the opposite side to the liquid crystal cell and, with regard to such a functional film, it is preferred to install at least one of hard coat layer, anti-glare layer and antireflection layer. Each of the layers is not always to be installed as a separate layer and, for example, an anti-glare function is bestowed on the antireflection layer or the hard coat layer whereby that is functioned as an anti-glare reflective preventive layer instead of installing two layers of a reflective preventive layer and anti-glare layer.

### [Antireflection Layer]

In the present invention, an antireflection layer in which at least a light scattering layer and a low-refractive index layer are layered in this order on a protective film of the polarizing plate or an antireflection layer in which medium-refractive index layer, high refractive index layer and low-refractive index layer are layered in this order on a protective film is preferably placed. Preferred examples thereof will be mentioned hereunder. Incidentally, in the former constitution, mirror plane reflectivity is usually not less than 1% and it is called a low reflection (LR) film. In the latter constitution, a product where not more than 0.5% of mirror plate reflectivity is able to be achieved and it is called anti-reflection (AR) film.

### [LR Film]

Preferred examples of a antireflection layer (LR film) where light-scattering layer and low-refractive index layer are formed on a protective layer of a polarizing plate will be mentioned.

It is preferred that matting particles are dispersed in a light scattering layer, that the refractive index of material of the part other than matting particles in the light scattering layer is within a range of 1.50 to 2.00 and that the refractive index of the low-refractive index layer is within a range of 1.20 to 1.49. In the present invention, the light scattering layer has both anti-glare property and hard coat property and it may be either in a single layer or in plural layers being constituted from, for example, two to four layers.

With regard to an uneven shape of the surface in the antireflection layer, it is preferred to design in such a manner that average roughness of central line Ra is 0.08 to 0.40 μm, average roughness of ten points Rz is not more than 10-fold of Ra, average distance between concaves and convexes Sm is 1 to 100 μm, standard deviation from deepest point of uneven area to height of convex part is not more than 0.5 μm, standard deviation of average distance between concaves and convexes Sm where central line is a standard is not more than 20 μm and surface having an inclined angle of 0 to 5° is not less than 10% because a sufficient anti-glare property and a uniform matting feel by naked eye are able to be achieved thereby.

When tint of reflected light under a C light source (CIE standard average daylight type C) in terms of *a*b*c chromaticity coordinate space is that the a* value is −1 to 2, the b* value is −3 to 3 and ratio of minimum value to maximum value of reflectivity within a range of 380 to 780 nm is from 0.5 to 0.99, that is preferred because tint of the reflected light becomes neutral. Further, when the b* value of transmitted light under the C light source is made 0 to 3, that is preferred because yellowish color of white display upon applying to a display device is reduced. Further, when a lattice of 120 μm×40 μm is inserted between the plane light source and the antireflection layer and standard deviation of luminance distribution upon measurement of luminance distribution on a film is not more than 20, that is preferred because glare upon application of the polarizing plate of the present invention to the highly precise panel is reduced.

When optical characteristics of the antireflection layer which is able to be used in the present invention are that the mirror plane reflectivity is not more than 2.5%, the transmittance is not less than 90% and the degree of glossiness is not more than 70%, that is preferred because reflection of light from outside is able to be suppressed and visual property is enhanced. Particularly with regard to the mirror plane reflectivity, it is more preferably not more than 1% and, most preferably, not more than 0.5%. When haze is made 20% to 50%, ratio of inner haze to total haze is made 0.3 to 1, reduction of haze value from the haze value to a light scattering layer to haze value after formation of a low-refractive index layer is made not more than 15%, clearness degree of transmitted image in case comb width is 0.5 mm is 20% to 50% and a transmittance ratio of the vertically transmitted light to the light in the direction of 2° from vertical line is made 1.5 to 5.0, that is preferred because prevention of glittering and reduction of blur of letters, etc. are achieved on a highly precise LCD panel.

### (Low-Refractive Index Layer)

Refractive index of the low-refractive index layer which is able to be used in the present invention is preferably within a range of 1.20 to 1.49 and, more preferably, 1.30 to 1.44. When the low-refractive index layer also satisfies the following formula (19), it is preferred in view of making the reflecting rate low.

(m/4)λ×0.7<n_{L}d_{L}<(m/4)λ×1.3 Formula (19)

In the formula, m is a positive odd number, n_{L} is refractive index of the low-refractive index layer and d_{L} is film thickness (nm) of the low-refractive index layer. Further, λ is wavelength and is within a value of 500 to 550 mm.

Materials which constitute the low-refractive index layer will be illustrated as follows.

The low-refractive index layer is preferred to contain a fluorine-containing polymer as a low-refractive binder.

With regard to a fluorine-containing polymer, that where dynamic friction coefficient is 0.03 to 0.20, angle of contact to water is 90 to 120° and slipping-down angle of pure water is not more than 70° and that which is cross-linked by heat or ionizing radiation is preferred. When the polarizing plate according to the present invention is installed in an image display device, it is preferred that a peeling force by a commercially available adhesive tape is low because seal or memo which is adhered is apt to be peeled off. When measurement is conducted by a tensile tester, said peeling force is preferably not more than 500 gf (4.9 N), more preferably not more than 300 gf (3.96 N) and, most preferably, not more than 100 gf (0.98 N). When the surface hardness measured by a micro hardness tester is higher, scratch is less formed and said surface hardness is preferably not less than 0.3 GPa and, more preferably, not less than 0.5 GPa.

Examples of the fluorine-containing polymer used for the low-refractive index layer are a hydrolysate and a dehydrated condensate of a silane compound containing a perfluoroalkyl group (such as (heptadecafluoro-1,1,2,2-tetrahydrodecyl)-triethoxysilane) and a fluorine-containing copolymer in which a fluorine-containing monomer unit and a constituting unit for bestowing a cross-linking property are constituting components.

Specific examples of the fluorine-containing monomer are a fluoroolefin (such as fluoroethylene, vinylidene fluoride, tetrafluoroethylene, perfluorooctylethylene, hexafluoropropylene and perfluoro-2,2-dimethyl-1,3-dioxol), a partially or completely fluorinated alkyl ester derivative of (meth)acrylic acid [such as “Biscoat 6FM” (manufactured by Osaka Yuki Kagaku Kogyo K. K.) and “M-2020 (manufactured by Daikin Industries, Ltd.)] and a completely or partially fluorinated vinyl ether. Preferred one is a perfluoroolefin and the particularly preferred one in view of refractive index, solubility, transparency and easy availability is hexafluoropropylene.

Examples of the constituting unit for bestowing a cross-linking property are a constituting unit prepared by polymerization of a monomer previously having a self-cross-linking functional group in a molecule such as glycidyl (meth)acrylate and glycidyl vinyl ether, a constituting unit prepared by polymerization of a monomer having carboxyl group, hydroxyl group, amino group, sulfo group, etc. (such as (meth)acrylic acid, methylol (meth)acrylate, hydroxyalkyl (meth)acrylate, allyl acrylate, hydroxyethyl vinyl ether, hydroxybutyl vinyl ether, maleic acid and crotonic acid) and a constituting unit prepared by introduction of a cross-linking reactive group such as (meth)acryloyl group into such a constituting unit by a polymer reaction (for example, introduction is able to be conducted by a means such as action of acrylic acid chloride to hydroxyl group).

Besides the above-mentioned fluorine-containing monomer unit and the constituting unit for bestowing a cross-linking reactivity, it is also possible that a monomer having no fluorine atom is appropriately copolymerized in view of solubility in a solvent, transparency of the film, etc. There is no particular limitation for the monomer unit which is able to be used together and its examples are olefin (such as ethylene, propylene, isoprene, vinyl chloride and vinylidene chloride), acrylate (such as methyl acrylate, ethyl acrylate and 2-ethylhexyl acrylate), methacrylate (such as methyl methacrylate, ethyl methacrylate, butyl methacrylate, and ethylene glycol dimethacrylate), styrene derivative (such as styrene, divinylbenzene, vinyltoluene and α-methylstyrene), vinyl ether (such as methyl vinyl ether, ethyl vinyl ether and cyclohexyl vinyl ether), vinyl ester (such as vinyl acetate, vinyl propionate and vinyl cinnamate), acrylamide (such as N-tert-butylacrylamide and N-cyclohexylacrylamide), methacrylamide and acrylonitrile derivative.

A hardener may be appropriately used together with the above-mentioned polymer as mentioned in Japanese Patent Laid-Open Nos. 10/025,388 A and 10/147,739 A.

### (Light Scattering Layer)

A light scattering layer is formed with an object of bestowing a light diffusing property by at least one of surface scattering and inner scattering and a hard coat property for enhancing the anti-scratching property of the film on the film. Accordingly, it is formed by containing a binder for bestowing a hard coat property, matting particles for bestowing a light diffusing property and, if necessary, an inorganic filler for bestowing a high refractive index, preventing a cross-linking shrinkage and making the strength high. Moreover, as a result of formation of such a light scattering layer, said light scattering layer also functions as an anti-glare layer whereby the polarizing plate has an anti-glare layer.

Thickness of the light scattering layer is preferably 1 to 10 μm and, more preferably, 1.2 to 6 μm with an object of bestowing a hard coat property. When the thickness of the light scattering layer is not lower than said lower limit, problems such as insufficient hard property are hardly resulted while, when it is not higher than said upper limit, inconveniences such as insufficient processing adaptability due to worsening of curl and fragility are hardly resulted whereby that is preferred.

A binder for the light scattering layer is preferably a polymer having a saturated hydrocarbon chain or a polyether chain as a main chain and, more preferably, it is a polymer having a saturated hydrocarbon chain as a main chain. The binder polymer is preferred to have a cross-linking structure. With regard to a binder polymer having a saturated hydrocarbon chain as a main chain, a polymer of an ethylenic unsaturated monomer is preferred. With regard to a binder polymer having a saturated hydrocarbon chain as a main chain and also having a cross-linking structure, a (co)polymer of a monomer having two or more ethylenic unsaturated groups is preferred. For making the binder polymer highly refractive, it is also possible to select a substance in which an aromatic ring and at least one atom selected from halogen atom other than fluorine, sulfur atom, phosphorus atom and nitrogen atom are contained.

Examples of the monomer having two or more ethylenic unsaturated groups are ester of polyhydric alcohol with (meth)acrylic acid [such as ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate and polyester polyacrylate], a modified product of the above with ethylene oxide, vinylbenzene and derivatives thereof (such as 1,4-divinylbenzene, 2-acryloylethyl 4-vinylbenzoate and 1,4-divinylcyclohexanone), vinylsulfone (such as divinylsulfone), acrylamide (such as methylenebisacrylamide) and methacrylamide. Two or more of those monomers may be used together.

Specific examples of the high-refractive monomer are bis(4-methacryloylthiophenyl)sulfide, vinylnaphthalene, vinylphenyl sulfide and 4-methacryloxyphenyl 4′-methoxyphenyl thioether. Two or more of those monomers may be used together as well.

Polymerization of the monomer having an ethylenic unsaturated group as such is able to be carried out by irradiation of ionizing radiation or by heat in the presence of a light radical initiator or a heat radical initiator. Accordingly, an applying liquid containing a monomer having an ethylenic unsaturated group, a light radical initiator or a heat radical initiator, matting particles and an inorganic filler is prepared, said applying liquid is applied on a protective film and hardening is carried out by ionizing radiation or by heat whereby a antireflection layer is able to be formed. With regard to the light radical initiator, etc., known ones may be used.

With regard to a polymer having polyether as a main chain, a ring-opening polymer of a multi-functional epoxy compound is preferred. Ring-opening polymerization of a multi-functional compound is able to be carried out by irradiation or ionizing radiation or by heat in the presence of a light acid generator or a heat acid generator. Therefore, an applying liquid containing a multi-functional epoxy compound, a light acid generator or a heat acid generator, matting particles and an inorganic filler is prepared and said applying liquid is applied on a protective film and hardening by polymerization using ionizing radiation or heat is conducted whereupon a antireflection layer is able to be formed.

It is also possible that, in place of or in addition to a monomer having two or more ethylenic unsaturated groups, a monomer having a cross-linking functional group is used to introduce the cross-linking function group into a polymer and a cross-linking structure is introduced into a binder polymer by the reaction of the cross-linking functional group.

Examples of the cross-linking functional group include isocyanate group, epoxy group, aziridine group, oxazoline group, aldehyde group, carbonyl group, hydrazine group, carboxyl group, methylol group and active methylene group. Vinylsulfonic acid, acid anhydride, cyanoacrylate derivative, melamine, etherified methylol, ester, urethane and metal alkoxide such as tetramethoxysilane are also able to be utilized as a monomer for introducing a cross-linking structure. It is also possible to use a functional group showing a cross-linking property as a result of decomposition reaction such as a blocked isocyanate group. Thus, in the present invention, the cross-linking functional group may not be that which immediately reacts but may be that which shows reactivity as a result of decomposition.

With an object of bestowing an anti-glare property, the light scattering layer contains matting particles such as particles of an inorganic compound or resin particles which are large than filler particles where an average particle size is 1 to 10 μm and, preferably, 1.5 to 7.0 μm. Specific examples of the preferred matting particles are particles of an inorganic compound such as silica particles and TiO₂ particles; and resin particles such as acrylate particles, cross-linked acrylate particles, polystyrene particles, cross-linked polystyrene particles, melamine resin particles and benzoguanamine resin particles. With regard to the shape of the matting particles, any of spherical and amorphous shapes may be used.

It is also possible to use two or more kinds of matting particles having different particles size together. It is possible that matting particles having bigger particle size bestow anti-glare property while matting particles having smaller particle size bestow other optical characteristic.

With regard to a particle size distribution of the above-mentioned matting particles, it is most preferred to be a mono-dispersed one and, with regard to particle size of each particle, the nearer the same, the better. For example, when a particle which is bigger to an extent of 20% or more as compared with the average particle size is defined as a coarse particle, rate of coarse particles as such is preferably not more than 1% of total particle numbers, more preferably not more than 0.1% and, still more preferably, not more than 0.01%. The matting particles having such a particle size distribution are able to be prepared by means of classification after a common synthetic reaction and, when frequency of the classification is increased or the degree thereof is made high, it is now possible to prepare a matting agent with more preferred distribution.

The above-mentioned matting particles are contained in a light scattering layer in an amount of preferably 10 to 1,000 mg/m² or, more preferably, 100 to 700 mg/m².

Particle size distribution of the matting particles is measured by a Coulter counter method and the measured distribution is converted into a particle number distribution.

It is preferred that, in addition to the above-mentioned matting particles, the light scattering layer contains an inorganic filler comprising at least one kind of oxide of metal selected from titanium, zirconium, aluminum, indium, zinc, tin and antimony having an average particle size of not larger than 0.2 μm, preferably not large than 0.1 μm and, still more preferably, not large than 0.06 μm in order to enhance the refractive index of the layer.

On the contrary, it is also preferred that, in a light scattering layer using high-refractive matting particles, silicon oxide is used in order to enhance the difference in refractive index from the matting particles. Preferred particle size thereof is the same as that in the above-mentioned inorganic filler.

Specific examples of the inorganic filler used in the light scattering layer are TiO₂, ZrO₂, Al₂O₃, In₂O₃, ZnO, SnO₂, Sb₂O₃, ITO and SiO₂. TiO₂ and ZrO₂ are particularly preferred in view of making the refractive index high. It is also preferred that surface of said inorganic filler is subjected to a silane coupling treatment or a titanium coupling treatment and a surface treating agent having a functional group which is able to react with a binder species on the filler surface is preferably used.

Adding amount of such an inorganic filler to the total mass of the light scattering layer is preferably 10 to 90%, more preferably 20 to 80% and, particularly preferably, 30 to 75%.

Incidentally, such a filler has a particle size which is well smaller than the wavelength of light and, therefore, no scattering is resulted and a dispersion in which said filler is dispersed in the binder polymer acts as an optically uniform substance.

Refractive index of a mixture of the binder and the inorganic filler in a light scattering layer is preferably 1.50 to 2.00 and, more preferably, 1.51 to 1.80. In order to make the refractive index within the above-mentioned range, type and amount ratio of the binder and the inorganic filler are to be appropriately selected. How to select them is able to be empirically known previously and easily.

In order to particularly ensure the in-plane homogeneity such as uneven application, uneven drying and point defect in the light scattering layer, an applying composition for formation of the light scattering layer contains one of or both of surfactants of a fluorine type and a silicone type. The surfactant of a fluorine type is used particularly preferably since it gives an effect of improving a surficial trouble of a antireflection layer which is preferably used in the present invention such as uneven application, uneven drying and point deficiency in less adding amount. An object is that in-plane uniformity is enhanced and, at the same time, a high-speed applying adaptability is bestowed whereby productivity is enhanced.

### [AR Film]

Now, a antireflection layer (AR film) where medium-refractive index layer, high refractive index layer and low-refractive index layer are layered in this order on the protective film will be illustrated.

The antireflection layer where at least medium-refractive index layer, high refractive index layer and low-refractive index layer (the outermost layer) are layered in this order on the protective film is designed to have refractive indexes satisfying the following relations.

Refractive index of high refractive index layer>Refractive index of medium-refractive index layer>Refractive index of protective film>Refractive index of low-refractive index layer

It is also possible to install a hard coat layer between the protective film and the medium-refractive index layer. It is further possible to be composed of medium-refractive index layer, hard coat layer, high refractive index layer and low-refractive index layer and the antireflection layer mentioned, for example, in Japanese Patent Laid-Open Nos. 08/122,504 A, 08/110,401 A, 10/300,902 A, 2002/243,906 A and 2000/111,706 A may be listed.

Moreover, other function may be also bestowed on each layer. For example, an anti-staining low-refractive index layer and an antistatic high refractive index layer (refer, for example, to Japanese Patent Laid-Open Nos. 10/206,603 A and 2002/243,906 A) may be listed.

Haze of the antireflection layer is preferably not more than 5% and, more preferably, not more than 3%. Surficial strength of the film by the pencil harness test according to JIS K-5400 is preferably not softer than H. more preferably not softer than 2H and, most preferably, not softer than 3H.

### (High Refractive Index Layer and Medium-Refractive Index Layer)

A layer having a high refractive index of the antireflection layer comprises a hardening layer containing at least a matrix binder and fine particles of inorganic compound with a high refractive index where an average particle size is not larger than 100 nm.

With regard to fine particles of inorganic compound having a high refractive index, an example is an inorganic compound where a refractive index is not lower than 1.65 and, preferably, a refractive index is not lower than 1.9. Examples are oxides of Ti, Zn, Sb, Sb, Zr, Ce, Ta, La, In, etc. and a compounded oxide containing such a metal atom.

In order to prepare such fine particles, there are several means such as that particle surface is treated with a surficial treating agent (e.g., a silane coupling agent, etc. mentioned in Japanese Patent Laid-Open Nos. 11/295,503 A, 11/153,703 A and 2000/009,908 A; and anionic compound or organometallic coupling agent mentioned in Japanese Patent Laid-Open No. 01/310,432 A), that a core-shell structure where high-refractive particles are used for the core (mentioned in Japanese Patent Laid-Open No. 2001/166,104 A) and that a specific dispersing agent is used together (refer, for example, to Japanese Patent Laid-Open No. 11/153,703 A, U.S. Pat. No. 6,210,858 and Japanese Patent Laid-Open No. 2002/277,609 A).

With regard to a material which forms a matrix, conventionally known thermoplastic resin, hardening resin film, etc. may be exemplified.

More preferred material is at least one kind of composition selected from a group consisting of a composition containing a multi-functional compound having two or more polymerizing groups being at least any of radically polymerizing and cationically polymerizing groups, a composition containing an organometallic compound having a hydrolysable group and a composition containing a partial condensate thereof and, for example, compounds mentioned in Japanese Patent Laid-Open No. 2000/047,004 A, 2001/315,242 A, 2001/031,871 A and 2001/296,401 A may be listed.

A hardening film prepared from a metal alkoxide composition and a colloidal metal oxide prepared from a hydrolyzed condensate of metal alkoxide is preferred as well. That is mentioned, for example, in Japanese Patent Laid-Open No. 2001/293,818 A.

Refractive index of a high refractive index layer is preferably 1.70 to 2.20. Thickness of a high refractive index layer is preferably 5 nm to 10 μm and, more preferably, 10 nm to 1 μm.

Refractive index of a medium-refractive index layer is adjusted so as to make its value between refractive index of a low-refractive index layer and refractive index of a high refractive index layer. Refractive index of a medium-refractive index layer is preferred to be 1.50 to 1.70. Thickness is preferably 5 nm to 10 μm and, more preferably, 10 nm to 1 μm.

### (Low-Refractive Index Layer)

A low-refractive index layer is successively layered on a high refractive index layer. Refractive index of the low-refractive index layer is preferably 1.20 to 1.55 and, more preferably, 1.30 to 1.50.

A low-refractive index layer is preferred to be constructed as the outermost layer having anti-scratching and anti-staining properties. As a means for making the anti-scratching property significantly high, bestowing of the sliding property on the surface is effective and conventionally known means for introduction of silicone, introduction of fluorine, etc. may be applied therefor.

With regard to a fluorine-containing compound, a compound containing a cross-linking or polymerizing functional group and containing fluorine atom within a range of 35 to 80% by mass is preferred and the compounds mentioned, for example, in paragraphs [0018] to [0026] of Japanese Patent Laid-Open No. 09/222,503 A, in paragraphs [0019] to [0030] of Japanese Patent Laid-Open No. 11/038,202 A, in paragraphs [0027] to [0028] of Japanese Patent Laid-Open No. 2001/040,284 A and in Japanese Patent Laid-Open No. 2000/284,102 A may be listed.

Refractive index of the fluorine-containing compound is preferably 1.35 to 1.50 and, more preferably, 1.36 to 1.47.

With regard to a silicone compound, that which is a compound having a polysiloxane structure and containing a hardening functional group or a polymerizing functional group in a polymer chain so as to give a cross-linked structure in a film is preferred. Its examples are reactive silicone (such as Silaplane manufactured by Chisso) and polysiloxane containing silanol groups at both ends (Japanese Patent Laid-Open No. 11/258,403 A, etc.).

It is preferred that at least any of cross-linking and polymerizing reactions of siloxane polymer and fluorine-containing polymer having cross-linking or polymerizing group forms a low-refractive index layer by ionizing radiation or by heat together with or after application of an applying composition for forming the outermost layer containing a polymerization initiator, a sensitizer, etc.

A sol/gel hardening film where an organometallic compound such as a silane coupling agent and a silane coupling agent which contains a specific fluorine-containing hydrocarbon group are hardened by a condensation reaction in the presence of a catalyst is also preferred.

Its examples are a silane compound containing a polyfluoroalkyl group or a partially hydrolyzed condensate thereof (compounds mentioned, for example, in Japanese Patent Laid-Open Nos. 58/142,958 A, 58/147,483 A, 58/147,484 A, 09/157,582 A and 11/106,704 A) and a silyl compound containing a poly(perfluoroalkyl ether) group which is a fluorine-containing long chain group (compounds mentioned, for example, in Japanese Patent Laid-Open Nos. 2000/117,902 A, 2001/048,590 A and 2002/053,804 A).

As an additive other than the above-mentioned ones, the low-refractive index layer may also contain a filler [for example, a low-refractive inorganic compound having a primary average particle size of 1 to 150 nm such as silicon dioxide (silica) and fluorine-containing particles (such as magnesium fluoride, calcium fluoride and barium fluoride) and organic fine particles mentioned in paragraphs [0020] to [0038] of Japanese Patent Laid-Open No. 11/003,820 A], a silane coupling agent, a slipping agent, surfactant, etc.

When a low-refractive index layer is positioned at the lower layer of the outermost layer, the low-refractive index layer may be formed by a gas phase method (such as a vapor deposition method, a sputtering method, an ion plating method and a plasma CVD method). In view of being able to be manufactured at a low cost, an applying method is preferred.

Thickness of the low-refractive index layer is preferably 30 to 200 nm, more preferably 50 to 150 nm and, most preferably, 60 to 120 nm.

### (Hard Coat Layer)

A hard coat layer is formed on the surface of a protective layer for bestowing a physical strength on the protective film equipped with a antireflection layer. It is particularly preferred to be formed between the protective layer and the above-mentioned high refractive index layer. The hard coat is preferred to be formed by a cross-linking reaction of a hardening compound by light and/or heat or by a polymerization reaction. As a hardening functional group in the hardening compound, an optically polymerizing functional group is preferred. Organic alkoxysilyl compound and organometallic compound containing a hydrolyzing functional group are also preferred.

Specific examples of such a compound are the same as those exemplified for the high refractive index layer.

Specific constitutional compositions for the hard coat layer are, for example, those mentioned in Japanese Patent Laid-Open Nos. 2002/144,913 A and 2000/009,908 A and WO 00/46617.

A high refractive index layer is able to be served as a hard coat layer as well. In that case, it is preferred to form in such a manner that fine particles are finely dispersed using a means mentioned for a high refractive index layer and are contained in a hard coat layer.

A hard coat layer is able to be served as an anti-glare layer as well by making the particles of average particle size of 0.2 to 10 μm contained therein and bestowing an anti-glare function.

Thickness of the hard coat layer is able to be appropriately designed depending upon the use. Thickness of the hard coat layer is preferably 0.2 to 10 μm and, more preferably, 0.5 to 7 μm.

Surface hardness of the hard coat layer by a pencil hardness test according to JIS K-5400 is preferably not softer than H, more preferably not softer than 2H and, most preferably, not softer than 3H. Further, in a Taber's test according to JIS K-5400, the less the abrasion amount of the test piece before and after the test, the better.

### (Other Layers in the Antireflection Layer)

A forward scattering layer, a primer layer, an antistatic layer, an undercoating layer, a protective layer, etc. may be also installed.

### (Antistatic Layer)

In installing an antistatic layer, it is preferred to bestow electric conductivity where volume resistivity is not more than 10⁻⁸ (Ωcm⁻³). Although it is possible to bestow the volume resistivity of 10⁻⁸ (Ωcm⁻³) using a moisturizing substance, a water-soluble inorganic salt and some kinds of surfactant, cationic polymer, colloidal silica, etc., there is a problem that dependency on humidity and temperature is big and no sufficient electric conductivity is able to be ensured at low humidity. Therefore, a metal oxide is preferred as a material for an electrically conductive layer. Some metal oxides are colored in blue and, when such metal oxides are used as a material for the electrically conductive layer, whole film is colored and that is not preferred. Examples of the metal which forms a metal oxide without coloration are Zn, Ti, Sn, Al, In, Si, Mg, Ba, Mo, W and V and it is preferred to use a metal oxide where the above is a main component.

Specific examples of the above-mentioned metal oxide are preferably ZnO, TiO₂, SnO₂, Al₂O₃, In₂O₃, SiO₂, MgO, BaO, MoO₃, WO₃ and V₂O₅ as well as a compounded oxide thereof and, particularly preferably, ZnO, TiO₂ and SnO₂. As examples where other atom is contained, addition of Al, In, etc. to ZnO, addition of Sb, Nb, halogen element, etc. to SnO₂ and addition of Nb, Ta, etc. to TiO₂ are effective.

It is also possible to use a material in which the above-mentioned metal oxide is adhered to other crystalline metal particles or fibrous substance (such as titanium oxide) as mentioned in Japanese Patent Publication No. 59/006,235 B. Although volume resistance and surface resistance are different physical values and are unable to be simply compared, it is sufficient for ensuring the electric conductivity of not more than 10⁻⁸ (Ωcm⁻³) in terms of volume resistance that the antistatic layer has a surface resistance of not more than about 10⁻¹⁰ (Ω/) and, more preferably, 1-8 (Ω/). It is necessary that the surface resistance of the antistatic layer is measured as a value when the antistatic layer is the outermost layer and the measurement is able to be conducted in the stage during the formation of a layered film.

### [Liquid Crystal Display Device]

The above-mentioned cellulose acylate film or a polarized plate prepared by adhesion of the cellulose acylate film with polarization film is advantageously used in a liquid crystal display device and, particularly, in a transmission liquid crystal display device.

A transmission liquid crystal display device comprises liquid crystal cell and two polarizing plates aligned on both sides thereof. A polarizing plate comprises a polarization film and two transparent protective films aligned on both sides thereof. A liquid crystal cell carries liquid crystal between two electrode substrates.

With regard to the polarizing plate of the present invention, one plate is aligned on one side of the liquid cell or two plates are aligned on both sides of the liquid cell.

The liquid crystal cell is preferred to be in a VA mode, an OCB mode, an IPS mode or a TN mode.

In a liquid cell in a VA mode, rod-shaped liquid crystal molecules are aligned substantially vertically when no voltage is applied.

In addition to (1) a liquid crystal cell in a VA mode in a narrow sense where rod-shaped liquid crystal molecules are aligned substantially vertically when no voltage is applied (mentioned in Japanese Patent Laid-Open No. 02/186,625 A), a liquid crystal cell in a VA mode also covers (2) a liquid crystal cell (in an MVA mode) where a VA mode is made into a multi-domain type for expanding the viewing angle (mentioned in SID 97, Digest of Technical Papers (previous printing), 28 (1997), page 845), (3) a liquid crystal cell (in n-ASM mode) where rod-shaped liquid crystal molecules are aligned substantially vertically when no voltage is applied and, upon application of voltage, they are subjected to a multi-domain alignment (mentioned in previous printing of Japanese Symposium on Liquid Crystals, pages 58 to 59 (1998)) and (4) a liquid crystal cell in a survival mode (reported at the LCD International 98).

When only one polarizing plate of the present invention is used in the case of a liquid crystal display device in a VA mode, it is preferred to be used in the backlight side.

A liquid crystal cell in an OCB mode is a liquid crystal cell in a bend-aligned mode where rod-shaped liquid crystal molecules are aligned substantially in reverse directions (symmetrically) on upper and lower parts of the liquid crystal cell. A liquid crystal display device using a liquid crystal cell in a bend-aligned mode is disclosed in U.S. Pat. Nos. 4,583,825 and 5,410,422. Since the rod-shaped liquid crystal molecules are symmetrically aligned in upper and lower parts of the liquid crystal cell, the liquid crystal cell in a bend-aligned mode has a self-optically compensation function.

Therefore, this liquid crystal mode is also called an OCB (optically compensatory bend) liquid crystal mode. A liquid crystal display device of a bend-aligned mode has an advantage that its response speed is high.

In a liquid crystal cell in a TN mode, rod-shaped liquid crystal molecules are aligned substantially horizontally when no voltage is applied and, further, they are in a twisted alignment in 60 to 120°.

A liquid crystal cell in a TN mode has been most frequently utilized as a color TFT liquid crystal display device and is mentioned in many documents.

### EMBODIMENT

### Example 1

### Production of Cellulose Acylate Film

### Example 1-1

### Production of Cellulose Acylate Film (CAF-1)

[Preparation of Cellulose Acylate Solution]

The following mixture was poured into a mixing tank and the components were dissolved by stirring to prepare a cellulose acylate solution.

(Composition of cellulose acylate solution)

| | | |
|---|---|---|
| Cellulose acetate (CA-1) | 100.0 | parts by mass |
| (degree of acetylation: 2.87) | | |
| Plasticizer: triphenyl phosphate | 8.0 | parts by mass |
| Plasticizer: biphenyl phosphate | 4.0 | parts by mass |
| Methylene chloride (the first solvent) | 402.0 | parts by mass |
| Methanol (the second solvent) | 60.0 | parts by mass |

### [Preparation of Retardation Developer Solution]

The following composition was poured into a mixing tank and stirred with heating to dissolve the components whereupon a retardation developer solution was prepared.

(Composition of retardation developer solution)

| | |
|---|---|
| Retardation developer (A-1) | 5.0 parts by mass |
| Methylene chloride (the first solvent) | 71.5 parts by mass |
| Methanol (the second solvent) | 10.7 parts by mass |
| Cellulose acylate solution | 12.8 parts by mass |

Retardation Developer A-1

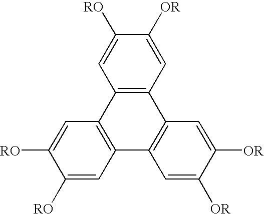

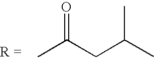

Each of 93.3 parts by mass of above-mentioned cellulose acylate solution and 6.7 parts by mass of the above-mentioned retardation developer solution was filtered, mixed, cast at 30° C. using a band casting machine, peeled off and dried to give a film having 94μ thickness. After that, the resulting film is subjected to a transverse stretching at a stretching speed of 30%/minute until a starched magnification of 15% using a tenter under the condition of 180° C., applied with cold wind where the width direction of the film was maintained so that surface temperature of the film was cooled down to 40° C. or lower and rolled. Thickness of the resulting cellulose acylate film was 82 μm.

### Examples 1-2 to 1-5 and Comparative Examples 2-1 to 2-5

### Production of Cellulose Acylate Films (CAF-2 to 5 and CFAR-1 to 5)

The same operation as Example 1-1 was conducted except that type of the polymer, type and amount of the retardation developer, stretching temperature and stretching magnification were changed as shown in Table 1 whereupon cellulose acylate films (CAF-2 to 5 and CAFR-1 to 6) were produced.

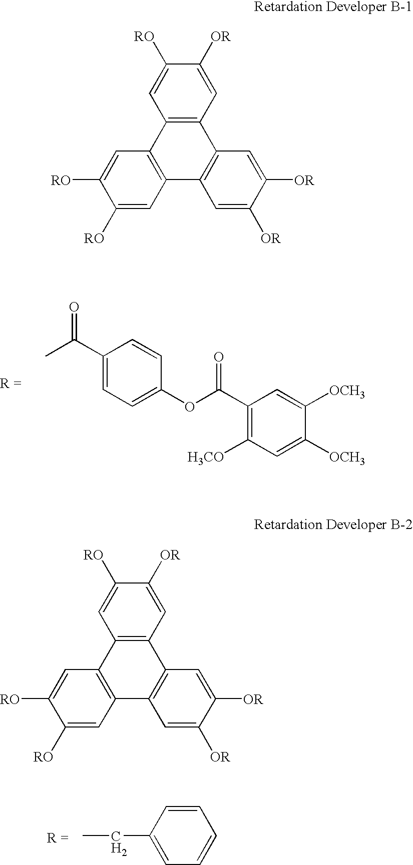

### [Measurement of ΔTg]

In order to measure ΔTg for the above-mentioned CAF-1 to 5 and CAFR-1 to 5, the corresponding retardation developer to the polymer used for the production of each film was firstly added and the maximum adding amount a (% by mass) of the retardation developer within such a range that haze did not exceed 1.0 was determined.

To be more specific, a film in which amount of the corresponding retardation developer to each polymer film was increased every 0.5% by mass was produced and the haze of each film was measured by the following method.

Here, the maximum adding amount within such a range that the haze value did not exceed 1.0 was defined a (% by mass) and the film to which a (% by mass) was added was subjected to the following Tg measurement.

[Measurement of Haze]

A film sample (40 mm×80 mm) was subjected to a measurement according to JIS K-6714 using a haze meter (HGM-2DP, Suga Test Machine) at 25° C. and 60% RH.

[Measurement of Tg]

Measurement of glass transition temperature (Tg) was carried out by a measuring apparatus for dynamic viscoelasticity (Vibron DVA-225 (manufactured by IT Keisoku Seigyo K. K.). Film sample (5 mm×30 mm) was subjected to a moisture adjustment for not shorter than 2 hours at 25° C. and 60% relative humidity and measurement was carried out under the condition where length between grips was 20 mm, raising speed of temperature was 2° C./minute, measuring temperature range was 30° C. to 200° C. and frequency was 1 Hz. A graph where storage elasticity in logarithmic axis was in the ordinate while temperature (° C.) in linear axis was in the abscissa was prepared from the resulting data, a straight line 1 was drawn in a solid region for a quick decrease in storage elasticity noted upon transfer of the storage elasticity from a solid region to a glass transition region while a straight line 2 was drawn in a glass transition region and temperature of the crossing point of the straight line 1 to the straight line 2 was read to determine the Tg.

[Measurement of Solubility of Retardation Developer with Respect to an Additive Other than the Retardation Developer]

Predetermined amounts of the retardation developer and the additive other than the retardation developer were dissolved in a solvent such as methylene chloride, dropped onto a glass dry plate and allowed to stand for 1 hour in an atmosphere of 40° C., the solvent was evaporated therefrom and separation of crystals of the retardation developer was checked to judge the solubility of the retardation developer in said concentration.

In that case, amount of the retardation developer to be added was gradually increased and the above operation was conducted for each of them and solubility was calculated based on the mass of the retardation developer immediately before the separation of the crystals was observed.

[Solubility of Retardation Developer in a Solvent in which a Polymer is Dissolved]

In each of the above-mentioned CAF-1 to 5 and CAFR-1 to 5, a mixed solvent of methylene chloride/methanol in 87/13 was used as a solvent in which the polymer is to be dissolved.

Accordingly, with regard to solubility of the retardation developer in a solvent in which a polymer is to be dissolved, solubility of the retardation developer in a mixed solvent of methylene chloride/methanol in 87/13 was determined. To be more specific, the solubility was determined by the above-mentioned method 1 for measurement of the solubility.

### [Confirmation of Production of Fine Particles of Organic Compound]

Presence or absence of organic fine particles in the slices of the film was observed under a transmission electron microscope.

### [Measurement of Optical Characteristics of Film]

Re and Rth at 589 nm wavelength at 25° C. and 60% RH were measured using Kobra-WR (manufactured by Oji Keisoku Kiki K. K.) which is an automatic double refraction meter. The result is shown in Table 2. To be more precise, the description reading “% by weight” in Table 1 stands for “% by mass”.

TABLE 1

| | | | | Stretching |
|---|---|---|---|---|
| Sample | | Retardation Developer | | Temp |
| Nos. | Polymer | Type | Amount ^{a)} | (° C.) |
| CAF-1 | Cellulose acetate (deg of | A-1 | 2.0 | 180 |
| | acetylation: 2.87) | | | |
| CAF-2 | Cellulose acetate (deg of | A-1 | 2.0 | 180 |
| | acetylation: 2.78) | | | |
| CAF-3 | Cellulose acetate (deg of | A-1 | 2.0 | 140 |
| | acetylation: 2.78) | | | |
| CAF-4 | Cellulose acetate (deg of | A-1 | 3.5 | 165 |
| | acetylation: 2.78) | | | |
| CAF-5 | Cellulose acetate (deg of | A-1 | 5.0 | 170 |
| | acetylation: 2.78) | | | |
| CAFR-1 | Cellulose acetate (deg of | Compound (I)-2 of JP | 2.0 | 180 |
| | acetylation: 2.87) | 2003/344,655 A | | |
| CAFR-2 | Cellulose acetate (deg of | Compound (I)-2 of JP | 2.0 | 140 |
| | acetylation: 2.87) | 2003/344,655 A | | |
| CAFR-3 | Cellulose acetate (deg of | A-1 | 2.0 | 180 |
| | acetylation: 2.78) | | | |
| CAFR-4 | Cellulose acetate (deg of | B-1 | 2.0 | 180 |
| | acetylation: 2.78) | | | |
| CAFR-5 | Cellulose acetate (deg of | B-2 | 2.0 | 180 |
| | acetylation: 2.78) | | | |

| | Stretching | | | | | |
|---|---|---|---|---|---|---|
| Sample | magnification | Tg | ΔTg | | | |
| Nos. | (%) | (° C.) | (° C.) | Solubility ^{b)} | Solubility ^{c)} | Remarks |
| CAF-1 | 15 | 152 | ≦0.1 | <10 wt % | ≧5 wt % | this invention |
| CAF-2 | 15 | 152 | ≦0.1 | <10 wt % | ≧5 wt % | this invention |
| CAF-3 | 15 | 152 | ≦0.1 | <10 wt % | ≧5 wt % | this invention |
| CAF-4 | 25 | 152 | ≦0.1 | <10 wt % | ≧5 wt % | this invention |
| CAF-5 | 50 | 152 | ≦0.1 | <10 wt % | ≧5 wt % | this invention |
| CAFR-1 | 15 | 149 | 1.6 | ≧40 wt % | ≧5 wt % | comparative |
| | | | | | | example |
| CAFR-2 | 15 | 149 | 1.6 | ≧40 wt % | ≧5 wt % | comparative |
| | | | | | | example |
| CAFR-3 | 15 | 152 | 1.6 | ≧40 wt % | ≧5 wt % | comparative |
| | | | | | | example |
| CAFR-4 | 15 | * | * | <10 wt % | <5 wt % | comparative |
| | | | | | | example |
| CAFR-5 | 15 | 152 | ≦0.1 | ≧40 wt % | ≧5 wt % | comparative |
| | | | | | | example |

^{a)} in % by weight to the polymer
^{b)} Solubility of additive other than retardation developer (solubility at 25° C. in triphenyl phosphate/biphenyl phosphate = 2/1 (ratio by weight)
^{c)} Solubility in a solvent in which polymer is dissolved (solubility at 25° C. in methylene chloride/methanol = 2/1 (ratio by weight)
* measurement was impossible

TABLE 2

| | | | Org Fine | |
|---|---|---|---|---|
| Sample Nos. | Re (nm) | Rth (nm) | Particles | Remarks |
| CAF-1 | 6 | 102 | present | this invention |
| CAF-2 | 11 | 135 | present | this invention |
| CAF-3 | 12 | 112 | present | this invention |
| CAF-4 | 36 | 202 | present | this invention |
| CAF-5 | 50 | 255 | present | this invention |
| CAFR-1 | 14 | 102 | absent | comparative example |
| CAFR-2 | 20 | 122 | absent | comparative example |
| CAFR-3 | 24 | 86 | absent | comparative example |
| CAFR-4 | Since film was turbid, | | | comparative example |
| | measurement was impossible | | | |
| CAFR-5 | 12 | 80 | absent | comparative example |

From the result of Table 2, it is apparent that, as compared with the polymer films CAFR-1 to 5 manufactured by the method of comparative examples, the polymer films CAF-1 to 5 produced by the manufacturing method of the present invention are preferred where only development of only Rth was enhanced. In addition, although not mentioned in Table 2, there was no trouble such as bleeding on the film surface of the polymer films CAF-1 to 5 but a good surficial property was ensured.

### Example 2

### Production of Polarizing Plate

[Saponifying Treatment of Cellulose Acylate Film]

The cellulose acylate film (CAF-5) produced in the above-mentioned Example 1-5 was dipped in a 1.3 mol/L aqueous solution of sodium hydroxide at 55° C. for 2 minutes, then washed in a vessel filled with washing water bath of room temperature, neutralized with 0.05 mol/L sulfuric acid at 30° C., washed in the washing water bath of room temperature once again and dried with hot air of 100° C. As such, surface of the cellulose acylate film (CAF-5) was saponified.

Further, commercially available cellulose triacetate film “Fujitac TD80UF” (manufactured by Fuji Photo Film) was saponified under the same condition and subjected to the production of the following polarizing plate.

### [Production of Polarizer]

Iodine was adsorbed with the stretched PVA film to produce a polarizer and a cellulose acetate film (CAF-5) produced in Example 1-5 was adhered on one side of the polarizer using an adhesive of a polyvinyl alcohol type. Transmitting axis of the polarizer and slow axis of the cellulose acylate film were aligned so as to make them parallel.

Further, “Fujitac TD80UF” subjected to a saponifying treatment as above was adhered to another side of the polarizer using an adhesive of a polyvinyl alcohol type. As such, a polarizing plate (P1-5) was produced.

### Example 3

### Production of VA Liquid Crystal Display Device and Evaluation Thereof

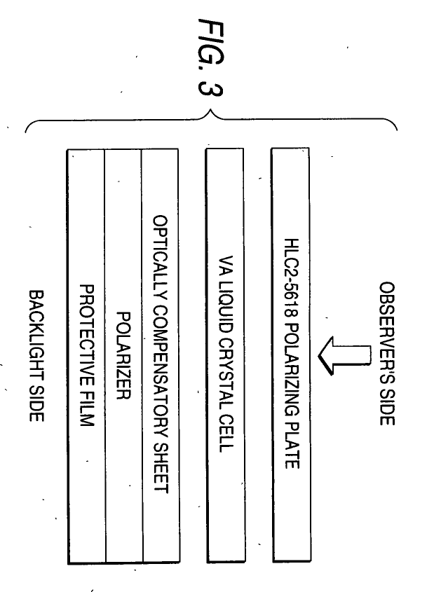

The liquid crystal display device of FIG. 3 was produced. Thus, an upper polarizing plate, liquid crystal of VA mode (upper substrate, liquid crystal layer and lower substrate) and lower polarizing plate were layered from the observing direction (upper side) and then a light source for backlight was aligned. In the following example, a commercially available polarizing plate “HLC2-5618” (manufactured by K. K. Sunritz) was used as the upper polarizing plate and the polarizing plate of the present invention was used as the lower polarizing plate.

### [Production of Liquid Crystal Cell]

Liquid crystal cell was produced in such a manner that the cell gap between the substrates was made 3.6 μm and a liquid crystal material having a negative dielectric anisotropy (“MLC 6608” manufactured by Merck) was dropped and injected between the substrates followed by sealing so that a liquid crystal layer was formed between the substrates. Retardation of the liquid crystal layer (or, in other words, a product (Δn·d) of thickness d (μm) of said liquid crystal layer and refractive anisotropy Δn) was made 300 nm. Incidentally, the liquid crystal material was aligned so as to give a vertical alignment.

Each one sheet of a commercially available super high contrast product “HLC 2-5618” (manufactured by Sunritz) and a polarizing plate (P1-5) produced in Example 3-1 was adhered to the observer side and the backlight side of the VA mode cell 31 via an adhesive on the upper polarizing plate 30 of the liquid crystal display device (FIG. 3) using the above-mentioned liquid crystal cell of a vertically aligned type and on the lower polarizing plate 32, respectively so that the cellulose acylate film (CAF 5) of the present invention was on the liquid crystal cell side. The product was made in cross nicol alignment where a transmittance axis of the polarized plate of the observer side was in an up-and-down direction while a transmittance axis of the polarized plate of the backlight side was in a left-and-right direction. As such, the liquid crystal display device of the present invention was produced.

The liquid crystal display device of the present invention produced as above was found to be favorable since changes in contrast and tint depending upon visual angle were little.

### Example 4

### Production of Polarized Plate

(Production of Optically Compensatory Sheet)

(Saponifying Treatment of Cellulose Acylate Film)

A liquid of the following composition was applied in an amount of 5.2 mL/m² onto a cellulose acylate film (CAF-4) produced in Example 1-4 and dried at 60° C. for 10 seconds. Surface of the film was washed with running water for 10 seconds and was dried by spraying of air of 25° C.

(Composition of saponifying liquid)

| | |
|---|---|
| Isopropyl alcohol | 818 parts by mass |
| Water | 167 pasts by mass |
| Propylene glycol | 187 parts by mass |
| “Emalex” manufactured by Nippon Emulsion K.K. | 10 parts by mass |
| Potassium hydroxide | 67 parts by mass |

### [Formation of Oriented Film]

An applying liquid of the following composition was applied in an amount of 24 mL/m using a wire bar coater of #14 on a cellulose acylate film (CAF-4) subjected to a saponifying treatment. It was dried with hot air of 60° C. for 60 seconds and further with hot air of 90° C. for 150 seconds.

After that, a rubbing treatment was conducted on the resulted membrane in the direction of 45° from the stretched direction (nearly the same as a slow axis) of the cellulose acylate film (CAF-4).

(Composition of applying liquid for oriented film)

| | | |
|---|---|---|
| Alcohol of the following structure | 20 | parts by mass |
| Water | 350 | parts by mass |
| Methanol | 120 | parts by mass |
| Glutaraldehyde (cross-linking agent) | 1.0 | part by mass |

Modified Polyvinyl Alcohol

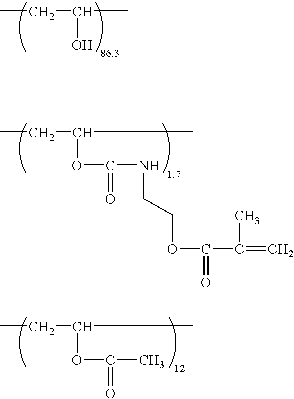

### (Formation of Optically Anisotropic Layer)

An applying liquid where 91 parts by mass of a discotic compound of the following structure, 9 parts by mass of V #360 which is trimethylolpropane triacrylate modified by ethylene oxide (manufactured by Osaka Yuki Kagaku K. K.), 1.5 parts by mass of CAB 531-1 which is cellulose acetate butyrate (manufactured by Eastman Chemical) and 3 parts by mass of Kayacure DETX which is a sensitizing agent (manufactured by Nippon Kayaku K. K.) were dissolved in 214.2 parts by mass of methyl ethyl ketone was applied in an amount of 5.2 mL/m² onto an oriented film using a wire bar coater of #3. That was adhered to a metal frame and heated in a constant-temperature vessel of 130° C. for 2 minutes so that the discotic compound was aligned. Then UV was irradiated at 90° C. for 1 minute using a 120 W/cm high-voltage mercury lamp so that the discotic compound was polymerized. After that, it was cooled down to room temperature. As such, an optically anisotropic layer was formed to give an optically compensatory sheet (WV1).

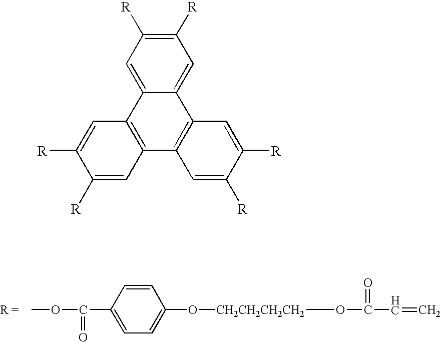

### (Saponifying Treatment of Optically Compensatory Sheet)

A saponifying treatment was carried out by the same manner as in Example 3-1.

### [Production of Polarizing Plate]

Iodine was adsorbed with the stretched polyvinyl alcohol film to produce a polarizer. After that, the cellulose acylate film (CAF-4) side of the produced optically compensatory sheet (WV1) was adhered to one side of the polarizer using an adhesive of a polyvinyl alcohol type. The alignment was done in such a manner that a slow axis of cellulose acylate film (CAF-4) and a transmittance axis of the polarizer became parallel.

A commercially available cellulose triacetate film “Fujitac TD80UF” (manufactured by Fuji Photo Film) was subjected to the same saponifying treatment as in Example 3-1 and adhered to the opposite side (to which no optically compensatory sheet was adhered) of the polarizer using an adhesive of a polyvinyl alcohol type. As such, an elliptic polarizing plate (P2-1) was produced.

### Example 5

### Production of Liquid Crystal Display Device

[Production of Bend Aligned Liquid Crystal Cell]

Polyimide membrane was formed as an oriented film on a glass substrate equipped with ITO electrodes and the oriented film was subjected to a rubbing treatment. The resulting two sheets of a glass substrate were made in an alignment of face-to-face where rubbing directions became parallel and cell gap was set at 5.7 μm. A liquid crystal compound “ZLI 1132” (manufactured by Merck) where Δn was 0.139 was injected into the cell gap to produce a bend aligned liquid crystal cell.

### [Production of Liquid Crystal Display Device]

Two sheets of elliptic polarizing plate (P2-1) were adhered so as to sandwich the produced bend aligned cell. An alignment was done in such a manner that an optically anisotropic layer of a polarizing plate faces the cell substrate and a rubbing direction of the liquid cell and a rubbing direction of the optically anisotropic layer being opposite thereof became reversely parallel.

When a black image was displayed on the produced liquid crystal display device, the liquid crystal display device using the polarizing plate of the present invention was found to be preferred because of changes in contrast and tint due to visual angle were small.

Now the present invention will be further illustrated by way of the following Examples and Comparative Examples although the present invention is not limited to the following examples only.

### Example 6

### Manufacture of Cellulose Acylate Film

(1) Cellulose Acylate

Sulfuric acid was added as a catalyst to the material cellulose and acylation reaction was conducted by addition of carboxylic acid anhydride which is a material for an acyl substituent followed by neutralizing and aging by saponification to prepare a product. When amount of the catalyst, type and amount of the carboxylic acid anhydride, adding amount of a neutralizing agent, adding amount of water, reaction temperature and aging temperature at adjusted at that time, cellulose acylates in which type of acyl group, degree of substitution, bulk specific gravity and degree of polymerization were different were prepared. Low-molecular components in the resulting cellulose acylate were removed by washing with acetone.

Among the cellulose acylates prepared as above, the following dope preparation was conducted using a cellulose acylate in which degree of substitution with acetyl group was 2.79 and DS6/(DS2+DS3+DS6) was 0.322.

(2) Preparation of Dope

<1-1> Cellulose Acylate Solution

The following composition was poured into a mixing tank, stirred to dissolve the components, heated at 90° C. for about 10 minutes and filtered through a filter paper where an average pore size was 34 μm and a sintered metal filter where an average pore size was 10 μm.

Cellulose Acylate Solution

| | | |
|---|---|---|
| Cellulose acylate | 100.0 | parts by mass |
| Triphenyl phosphate | 4.0 | parts by mass |
| Biphenyl diphenyl phosphate | 4.0 | parts by mass |
| Ethyl phthalylethyl glycolate | 4.0 | parts by mass |
| Methylene chloride | 403.0 | parts by mass |
| Methanol | 60.2 | parts by mass |

<1-2> Dispersion of Matting Agent

The following composition containing the cellulose acylate solution prepared by the above method was then poured into a dispersing machine to prepare a dispersion of a matting agent.

Dispersion of Matting Agent

| | |
|---|---|
| Silica particles of av. particle size of 16 nm | 2.0 parts by mass |
| (Aerosil R 972 manufd. by Nippon Aerosil K.K.) | |
| Methylene chloride | 72.4 parts by mass |
| Methanol | 10.8 parts by mass |
| Cellulose acylate solution | 10.3 parts by mass |

<1-3> Retardation Developer Solution

The following composition containing the cellulose acylate solution prepared above was poured into a mixing tank and dissolved with stirring under heating to prepare a retardation developer solution A.

Retardation Developer Solution

| | |
|---|---|
| Exemplified compound II-(16) | 14.0 parts by mass |
| Exemplified compound (III-1) | 7.8 parts by mass |
| Methylene chloride | 63.5 parts by mass |
| Methanol | 9.5 parts by mass |
| Cellulose acylate solution | 14.0 parts by mass |

A retardation developer solution comprising 100 parts by mass of the above cellulose acylate solution, 1.35 parts by mass a matting agent dispersion and a retardation developer solution in such an amount that 3.5 parts by mass of the exemplified compound II-(16) and 2.0 parts by mass of the exemplified compound (III-1) in terms of quantities in cellulose acylate film per 100 parts by mass of cellulose acylate was mixed to prepare a dope for making a film.

The exemplified compound II-(16) showed a nematic liquid crystal phase within a temperature range of 120° C. to 170° C.

### (Casting)

The above dope was cast using a glass plate casting apparatus. Drying was conducted for 6 minutes with hot air where air-supplying temperature was 70° C. and a film peeled off from the glass plate was fixed with a frame and dried for 10 minutes with hot air where air-supplying temperature was 100° C. and then for 20 minutes with hot air where air-supplying temperature was 140° C. to give a cellulose acylate film with a thickness of 108 μm.

The resulting film was stretched in a transverse direction with a stretching speed of 30% per minute using a tenter at 160° C. until a stretching magnification of 20% and then the film was wound. Thickness of the resulting cellulose acylate film was 92 μm. This film was called film 101.

### (Preparation of Films 102 to 109)

Type and adding amount of the compound were adjusted so that the retardation developer solution of the film 101 was made into a composition as shown in Table 4 and then the same film preparation and stretching as for film 101 were conducted to prepare films 102 to 109.

All of the data of the formula (1) of the Rth raising agent used for those films were as good as not less than 5.0 as shown below.

| | |
|---|---|
| III-1 | 13 |
| II-334 | 28 |
| IV-16 | 18 |
| IV-18 | 24 |
| IV-43 | 22 |
| V-23 | 17 |

### <Re and Rth of the Film at 450, 550 and 650 nm Wavelengths>

Re and Rth of this film at 450, 550 and 650 mm wavelengths were measured by a Kobra 21 ADH double refractometer (manufactured by Oji Keisoku Kiki K. K.) according to the above-mentioned method.

The result is shown in Table 4. It is noted from Table 4 that Re and Rth values at 450, 550 and 650 nm wavelengths of the cellulose acylate film manufactured by the manufacturing method of the present invention satisfy the relation of all of the above-mentioned formulae (A) to (D).

### <Preparation of Polarizing Plate>

Iodine was adsorbed with the stretched polyvinyl alcohol film to prepare a polarization film.

Each of the prepared cellulose acylate films 101 to 109 was adhered on one side of the polarization film using an adhesive of a polyvinyl alcohol type. Saponifying treatment was carried out under the following conditions.

A 1.5 mol/liter aqueous solution of sodium hydroxide was prepared and kept at 55° C. A 0.01 mol/liter aqueous solution of diluted sulfuric acid was prepared and kept at 35° C. The prepared cellulose acylate film was dipped for 2 minutes in the above aqueous solution of sodium hydroxide and then dipped in water so that the aqueous solution of sodium hydroxide was well washed out. After that, the film was dipped for 1 minute in the above aqueous solution of diluted sulfuric acid and dipped in water so that the aqueous solution of diluted sulfuric acid was well washed out. Finally, the sample was well dried at 120° C.

A commercially available cellulose triacylate film (Fujitac TD80UF manufactured by Fuji Photo Film) was subjected to a saponifying treatment, adhered to the opposite side of the polarizer using an adhesive of a polyvinyl alcohol type and dried at 70° C. for not shorter than 10 minutes.

A transmittance axis of the polarization film and a slow axis of the above-prepared cellulose acylate film were aligned to make them parallel. A transmittance axis of the polarization film and a slow axis of the commercially available cellulose triacylate film were aligned to make them orthogonal.

### <Preparation of Liquid Crystal Cell>

A liquid crystal cell was prepared in such a manner that a cell gap between substrates was made 3.6 μm, a liquid crystal material having a negative dielectric anisotropy (“MLC 6608” manufactured by Merck) was dropped and injected into the gap between the substrates and sealed and a liquid crystal layer was formed between the substrates. Retardation of the liquid crystal layer (thus, a product Δn·d of thickness d (μm) of liquid crystal layer and refractive anisotropy Δn) is made 300 nm. Incidentally, the liquid crystal materials were aligned so as to result in a vertical alignment.

### <Installment to VA Panel>

For an upper polarizing plate (observer's side) of a liquid crystal display device using the above-mentioned liquid crystal cell of a vertically aligned type, a commercially available super high contrast product (HLC2-5618 manufactured by K. K. Sunritz) was used. In the polarized plate of the lower side (backlight side), a polarizing plate equipped with any of films 1 to 3 was placed so that said cellulose acylate film became the liquid crystal cell side. The polarizing plate of the upper side and the polarizing plate of the lower side were adhered to the liquid crystal cell by an adhesive. A cross nicol alignment was done so that the transmission axis of the polarizing plate of the upper side was in the up-and-down direction while the transmission axis of the polarizing plate of the lower side was in the right-and-left direction.

Square wave voltage of 55 Hz was applied to the liquid crystal cell. A normally black mode where white display was 5V while black display was 0V was produced. Black display transmittance (%) in viewing angle in the direction where polar angle was 60° and azimuthal angle was 45° in black display and color shift Δx between the cases where azimuthal angle was 45° and polar angle was 60° and where azimuthal angle was 180° and polar angle was 60° were determined.

Moreover, using the ratio of transmittance (white display/black display) as a contrast ratio, viewing angle in eight stages from black display (L1) to white display (L8) (polar angle range in which contrast ratio was not less than 10 and gradation reversal in black side was not available) was measured using a measuring machine (EZ-Contrast 160 D, manufactured by Eldim).

The prepared liquid crystal display device was observed and, as a result, neutral black display was able to be achieved in any of front direction and viewing angle direction.

Viewing angle (polar angle range where contrast ratio is not less than 10 and there was no gradation reversal of black side)

o polar angle was 800 or more in upward, downward, right and left

oΔ polar angle was 80° or more in three of upward, downward, right and left

Δpolar angle was 800 or more in two of upward, downward, right and left

x polar angle was 80° or more in zero to one of upward, downward, right and left

Color shift (Δx) in black display

o less than 0.02

oΔ 0.02 to 0.04

Δ 0.04 to 0.06

x 0.06 or more

TABLE 4

| | | Compound of | | Rth Raising | | | | |
|---|---|---|---|---|---|---|---|---|
| | | Formula (I) | | Agent | | Retardation | | |
| | Film | Type | Adding | Type | Adding | Re (450) | Re (550) | Re (650) |
| | No. | # | Amt *1 | # | Amt *1 | (nm) | (nm) | (nm) |
| This | 101 | (16) | 3.5 | III-1 | 2.0 | 32.4 | 52.7 | 63.1 |
| Invention | | | | | | | | |
| Comp. Ex. | 102 | — | — | — | — | 10.1 | 16.2 | 20.0 |
| Comp. Ex. | 103 | (16) | 3.5 | — | — | 29.2 | 48.4 | 59.0 |
| Comp. Ex. | 104 | — | — | III-1 | 2.0 | 13.3 | 20.5 | 24.1 |
| Comp. Ex. | 105 | — | — | III-334 | 3.5 | 36.6 | 45.9 | 46.1 |
| Comp. Ex. | 106 | — | — | IV-15 | 1.2 | 16.1 | 18.2 | 18.4 |
| | | | | IV-18 | 0.8 | | | |
| Comp. Ex. | 107 | — | — | V-23 | 1.6 | 15.9 | 17.8 | 17.9 |
| | | | | IV-43 | 0.4 | | | |
| This | 108 | (16) | 3.5 | II-334 | 2.0 | 32.2 | 51.8 | 62.8 |
| Invention | | | | IV-15 | 0.6 | | | |
| | | | | IV-18 | 0.4 | | | |
| This | 109 | (16) | 3.5 | II-334 | 2.0 | 33.0 | 37.1 | 38.2 |
| Invention | | | | V-23 | 0.6 | | | |
| | | | | V-43 | 0.4 | | | |

| | Retardation | | | | | | | Evaluation * | |
|---|---|---|---|---|---|---|---|---|---|
| | Rth (450) | Rth (550) | Rth (650) | | | | | Viewing | Color |
| | (nm) | (nm) | (nm) | (A) * | (B) * | (C) * | (D) * | Angle | Shift * |
| This | 171 | 175 | 175 | 0.61 | 1.20 | 0.63 | 1.20 | ∘ | ∘ |
| Invention | | | | | | | | | |
| Comp. Ex. | 89.1 | 93.0 | 101 | 0.62 | 1.23 | 0.65 | 1.14 | x | Δ |
| Comp. Ex. | 105 | 111 | 121 | 0.60 | 1.22 | 0.64 | 1.12 | x | Δ |
| Comp. Ex. | 151 | 155 | 156 | 0.65 | 1.18 | 0.67 | 1.17 | x | Δ |
| Comp. Ex. | 182 | 185 | 189 | 0.80 | 1.00 | 0.81 | 0.98 | Δ | Δ |
| Comp. Ex. | 55.5 | 56.3 | 56.5 | 0.88 | 1.01 | 0.90 | 1.01 | x | x |
| Comp. Ex. | 54.8 | 56.1 | 56.2 | 0.89 | 1.01 | 0.91 | 1.00 | x | x |
| This | 181 | 177 | 177 | 0.62 | 1.21 | 0.61 | 1.21 | ∘ | ∘ |
| Invention | | | | | | | | | |
| This | 181 | 177 | 177 | 0.89 | 1.03 | 0.87 | 1.03 | ∘ | ∘Δ |
| Invention | | | | | | | | | |

# Exemplified compound no.
*1 Value to 100 parts by mass of cellulose acylate
Evaluation * Evaluation upon installing in VA panel
(A) * Value of the formula (A)
(B) * Value of the formula (B)
(C) * Value of the formula (C)
(D) * Value of the formula (D)
** Color shift in black display

In the case of an Rth raising agent only, although it is possible to make Re and Rth at 550 nm big, it is difficult to satisfy all conditions of (A) to (D) in wavelength dispersion characteristics. The formula (1) of the present invention is able to control the wavelength dispersion characteristics of Re to a reverse dispersion where short wavelength is small and, in addition, influence on Rth is very small. Therefore, when it is used together with an Rth raising agent, a wavelength dispersion control in which both Re and Rth are big and appropriate is now possible.

### Example 7

Film 201 was similarly prepared under the preparing condition for the film 101 in Example 6 except that the stretching step was modified as follows.

Thus, four sides were held in a biaxial stretching test apparatus (manufactured by K. K. Toyo Seiki Seisakusho) and stretching and shrinking steps were carried out under the condition of Table 5. As a condition which was common to stretching and shrinking steps, a preliminary heating for 2 minutes with an air-supplying temperature of 180° C. in each example before those steps was conducted and then stretching was conducted in the TD direction while release was conducted in the MD direction at that air-supplying temperature. It was separately confirmed that temperature of the supplied air and temperature of the film were identical. After finishing those steps, cooling by sending the air was conducted for 5 minutes together with holding with a clip. In the table, MD means a casting direction upon casting of glass plate while TD means a width direction which is orthogonal thereto.

Liquid crystal panel was prepared by the same manner as in Example 6 and visual angle and color shift in black display were evaluated whereupon a good result was obtained.

TABLE 5

| | Compd of Formula (I) | | Rth Raising Agent | | Stretching | Shrinking | Retardation | | | | | |
|---|---|---|---|---|---|---|---|---|---|---|---|---|
| | | Added | | Added | Rate to | Rate to | Re | Rth | Value of | Value of | Value of | Value of |
| Film | | Amount | | Amount | Stretching | Shrinking | (550) | (550) | Formula | Formula | Formula | Formula |
| No. | Type | *1 | Type | *1 | Direction | Direction | (nm) | (nm) | (A) | (B) | (C) | (D) |
| 101 | Exemplified | 3.5 | Exemplified | 2.0 | TD: 35% | MD: 35% | 97.1 | 188 | 0.69 | 1.10 | 0.71 | 1.10 |
| | Compound | | Compound | | | | | | | | | |
| | (16) | | III-1 | | | | | | | | | |

*1: Value to 100 parts by mass of cellulose acylate

It is now apparent that, when the stretching step and the releasing step according to the present invention are available, a liquid crystal display device where viewing angle is wide and color shift in black display is small is able to be prepared.

### Example 8

Each of the cellulose acylate films 101 and 108 prepared in Example 6 was applied with a 1.0N solution of potassium hydroxide (solvents: water/isopropyl alcohol/propylene glycol=69.2 parts by mass/15 parts by mass/15.8 parts by mass) in an amount of 10 ml/m² and kept at about 40° C. for 30 seconds, the alkali solution was scraped off, the residue was washed with water and water drops were removed by an air knife. After that, drying was conducted at 100° C. for 15 seconds.

Angle of contact of the alkali-treated surface to pure water was measured and found to be 40°.

### (Formation of Oriented Film)

An applying liquid for oriented film having the following composition was applied on said alkali-treated surface using a #16 wire bar coater in an amount of 28 ml/m². Drying was carried out with hot air of 60° C. for 60 seconds and further with hot air of 90° C. for 150 seconds to form an oriented film.

Composition of Applying Liquid for Oriented film

| | | |
|---|---|---|
| Following modified polyvinyl alcohol | 10 | parts by mass |
| Water | 371 | parts by mass |
| Methanol | 119 | parts by mass |
| Glutaraldehyde (cross-linking agent) | 0.5 | part by mass |
| Citrate (AS3 manufactured by Sankyo | 0.35 | part by mass |
| Kagaku K.K.) | | |

Modified Polyvinyl Alcohol

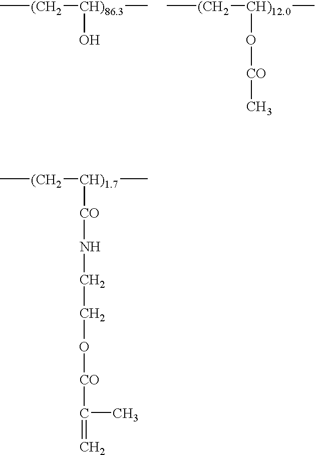

### (Rubbing Treatment)

A transparent support on which an oriented film was formed was conveyed at the rate of 20 m/minute, a rubbing roll (diameter: 300 mm) was set so that a rubbing treatment was able to be conducted in 45° to a longitudinal direction, the roll was rotated at 650 rpm and a rubbing treatment was carried out on the surface of the transparent support to which an oriented film was formed. Setting was conducted to make the contacting length of the rubbing roll to the transparent support 18 mm.

### (Formation of Optically Anisotropic Layer)

A discotic liquid crystalline compound (the following paragraph 40) (40.01 kg), 4.06 kg of trimethylolpropane triacrylate modified with ethylene oxide (V#360 manufactured by Osaka Yuki Kagaku K. K.), 0.35 kg of cellulose acetate butyrate (CAB 531-1 manufactured by Eastman Chemical), 1.31 kg of an optically polymerization initiator (Irgacure 907 manufactured by Ciba-Geigy) and 0.47 kg of a sensitizer (Kayacure DETX manufactured by Nippon Kayaku K. K.) were dissolved in 102 kg of methyl ethyl ketone. To the solution was added 0.1 kg of a copolymer containing a fluoro aliphatic group (Megafac F780 manufactured by Dainippon Ink and Chemicals) to prepare an applying liquid. The applying liquid was continuously applied on the oriented film surface of a transparent support which was conveyed at 20 m/minute by rotating with a #3.2 wire bar in the same direction as the conveying direction of the film at 391 rpm.

Discotic Liquid Crystal Compound

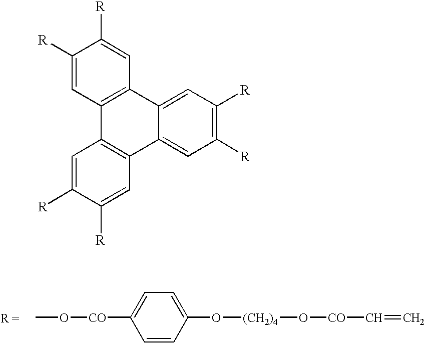

The solvent was evaporated by a continuous drying from room temperature to 100° C. and, after that, heating was conducted in a drying zone of 130° C. for about 90 seconds so that a wind velocity on the film of the discotic optically anisotropic layer was made 2.5 m/sec whereupon a discotic liquid crystal compound was aligned. It was then conveyed to a drying zone of 80° C. and ultraviolet ray of 600 mW energy intensity was irradiated for 4 seconds from an ultraviolet irradiating apparatus (ultraviolet lamp: generating power was 160 W/cm and emission length was 1.6 m) under such a state that surface temperature of the film was about 100° C. so as to proceed the cross-linking reaction whereupon a discotic liquid crystal compound was fixed on that alignment. After that, it was cooled down to room temperature and wound in a cylindrical form to give a roll-shaped form. As such, an optically compensatory film in a roll shape was prepared.

When viscosity of the optically compensatory film was measured at the film temperature of 127° C., it was 695 cp (695 mPa·s). The viscosity is the result when the liquid crystal layer (except the solvent) in the same composition as the optically compensatory film was measured by an E-type viscometer of a heating type.

A part of the prepared roll-shaped optically compensatory film was cut out and was used as a sample for the measurement of optical characteristics. An Re retardation value of the optically anisotropic layer measured at the wavelength of 546 nm was 36 nm. Angle (angle of inclination) of a disc surface of the discotic liquid crystal compound in the optically anisotropic layer to the support surface continuously changed in the depth direction of the layer and was 28° in average. Further, only an optically anisotropic layer was peeled off from the sample and an average direction of the molecular symmetric axis of the optically anisotropic layer was measured and found to be 45° in the longitudinal direction of the optically compensatory film.

(Evaluation of Installment to OCB Panel)

The cellulose acylate film sample as such was processed into a polarizing plate in the same manner as in Example 6.

### <Evaluation of Installment in Liquid Crystal Display Device>

(Preparation of Bend-Aligned Liquid Crystal Cell)

A polyimide film was formed as an oriented film on a glass substrate equipped with ITO electrodes and a rubbing treatment was carried out on the oriented film. The resulting two sheets of glass plates were encountered so as to make the rubbing directions parallel and cell gap was set at 4.7 μm. A liquid crystal compound (ZLI 1131 manufactured by Merck) where Δn was 0.1396 was injected into the cell gap to prepare a bend-aligned liquid cell.

Two sheets of polarizing plates were adhered on the prepared polarizing plate so as to sandwich the prepared bend-aligned cell. Alignment was done in such a manner that a rubbing direction of the liquid cell and the rubbing direction of the optically anisotropic layer encountering thereto are in counter-parallel.

Square voltage of 55 Hz was applied to the liquid crystal cell. A normally white mode wherein white display was 2V and black display was 5V was prepared. Voltage where the transmittance on the front became smallest or, in other words, black voltage was applied and, at that time, black display transmittance (%) in viewing angle in the direction where polar angle was 60° and azimuthal angle was 60° in black display and color shift Δx between the cases where azimuthal angle was 0° and polar angle was 60° and where azimuthal angle was 180° and polar angle was 60° were determined. Moreover, using the ratio of transmittance (white display/black display) as a contrast ratio, viewing angle in eight stages form black display (L1) to white display (L8) was measured using a measuring machine (EZ-Contrast 160 D, manufactured by Eldim). Both visual angle and color shift during black display showed good properties.

### INDUSTRIAL APPLICABILITY

In accordance with the present invention, it is now possible to provide a polymer film having a desired retardation without surficial trouble such as bleeding. Further, when a polarizer using the polarizing plate of the present invention using the polymer film is used in a liquid crystal display device, it is now possible to provide a liquid crystal display device having a wide viewing angle and a high display quality.

In accordance with the present invention, there is provided a cellulose acylate film particularly for VA, IPS and OCB modes wherein a liquid cell is able to be optically compensated precisely and high contrast and color shift depending upon visual angle direction upon black display are improved; a method for manufacturing the same; and polarizing plate using said cellulose acylate film.

The entire disclosure of each and every foreign patent application from which the benefit of foreign priority has been claimed in the present application is incorporated herein by reference, as if fully set forth.

1. A polymer film, which comprises:
organic compound fine particles containing a retardation developer and having an average particle size of from 1 nm to 1,000 nm.

2. The polymer film according to claim 1, which is a cellulose acylate film.

3. A method for producing a polymer film, which comprises:
casting a dope containing a polymer, a solvent for dissolving the polymer, a retardation developer and an additive other than the retardation developer on a support;
peeling off;
drying; and
stretching,
wherein the retardation developer is uniformly dissolved in the dope, and
between the casting and the stretching, organic compound fine particles containing the retardation developer are formed within a film.

4. The method for producing a polymer film according to claim 3,
wherein a solubility of the retardation developer with respect to the additive other than the retardation developer at 25° C. is less than 40% by mass.

5. The method for producing a polymer film according to claim 3,
wherein the retardation developer satisfying formula (2) in which ΔTg is expressed by formula (1) is utilized:
ΔTg=(Glass transition temperature (° C.) of polymer film produced without addition of a retardation developer)−(Glass transition temperature (° C.) of polymer film produced by addition of a (% by mass) of a retardation developer) Formula (1)
ΔTg/a<2 Formula (2)
wherein a (% by mass) is the maximum adding amount of the retardation developer when the retardation developer is added to the polymer film within such an extent that haze does not exceed 1.0.

6. The method for producing a polymer film according to claim 3,
wherein a solubility at 25° C. of the retardation developer in the solvent for dissolving the polymer is not less than 1% by mass.

7. The method for producing a polymer film according to claim 3,
wherein the retardation developer shows a liquid crystallinity.

8. The method for producing a polymer film according to claim 3,
wherein the polymer is a cellulose acylate.

9. The method for producing a polymer film according to claim 3,
wherein the polymer is a cellulose acetate where a degree of acetylation is not more than 2.85.

10. The method for producing a polymer film according to claim 3, which comprises, after peeling-off, subjecting the obtained film to a thermal treatment at a temperature of not lower than Tg.

11. A polymer film, which is produced by a production method according to claim 3.

12. The polymer film according to claim 1, which is produced by a production method for producing a polymer film comprising:
casting a dope containing a polymer, a solvent for dissolving the polymer, a retardation developer and an additive other than the retardation developer on a support;
peeling off;
drying; and
stretching,
wherein the retardation developer is uniformly dissolved in the dope, and between
the casting and stretching, organic compound fine particles containing the retardation developer are formed within a film.

13. A polarizing plate, which comprises:
a polarizer; and
at least two protective films adhered on both sides of the polarizer,
wherein at least one of the at least two protective films is a polymer film according to claim 1.

14. The polarizing plate according to claim 13, which further comprises an optically anisotropic layer at least on one side of the protective film.

15. A liquid crystals display device, which comprises:
a liquid crystal cell; and
at least two polarizing plates located on both sides of the liquid crystal cell,
wherein at least one of the at least two polarizing plates is a polarizing plate according to claim 13.

16. An optical film, which comprises:
at least one compound represented by formula (1); and
at least one Rth raising agent: 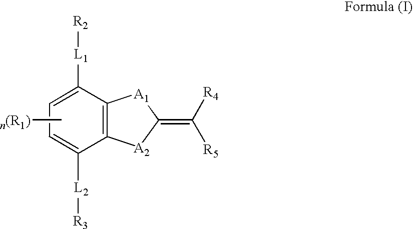
wherein L₁ and L₂ each independently represents a single bond or a divalent connecting group;
A₁ and A₂ each independently represents a group selected from the group consisting consisting of —O—, —NR— in which R represents a hydrogen atom or a substituent, —S— and —CO—;
R₁, R₂, R₃, R₄ and R₅ each independently represents a substituent; and
n represents an integer from 0 to 2.

17. An optical film, which comprises:
at least one compound represented by formula (I); and
at least one compound selected from the group consisting of compounds represented by formulae (II), (III), (IV) and (V): 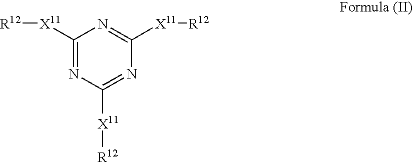
wherein each of R¹²'s independently represents an aromatic ring or a hetero ring having a substituent at least at any of ortho-, meta- and para-positions; and
each of X¹¹'s independently represents a single bond or —NR¹³— in which R¹³ represents a hydrogen atom, a substituted or unsubstituted alkyl group, an alkenyl group, an aryl group or a heterocyclic group: 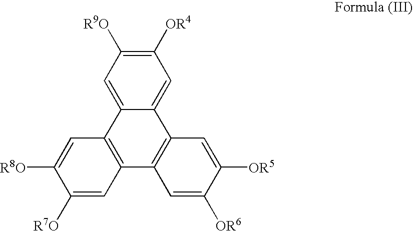
wherein R⁴, R⁵, R⁶, R⁷, R⁸ and R⁹ each independently represents a hydrogen atom or a substituent:
Q⁷¹-Q⁷²-OH Formula (IV)
wherein Q⁷¹ represents a nitrogen-containing aromatic hetero ring; and
Q⁷² represents an aromatic ring: 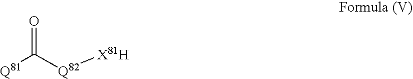
wherein Q⁸¹ and Q⁸² each independently represents an aromatic ring; and
X⁸¹ represents NR⁸¹ in which R⁸¹ represents a hydrogen atom or a substituent, an oxygen atom or a sulfur atom.

18. The optical film according to claim 16,
wherein at least one of the at least one compound represented by formula (1) and the at least one Rth raising agent is a liquid crystal phase at a temperature range of from 100° C. to 300° C.

19. The optical film according to claim 16, which satisfies formulae (A) to (D):
0.1<Re(450)/Re(550)<0.95 (A)
1.03<Re(650)/Re(550)<1.93 (B)
0.4<Re/Rth(450))/(Re/Rth(550))<0.95 (C)
1.05<(Re/Rth(650)/(Re/Rth(550))<1.9 (D)
wherein Re (λ) is an in-plane retardation value of the optical film to a light of λ nm wavelength;
Rth (λ) is a retardation value in a thickness direction of the optical film to a light of λ wavelength; and
Re/Rth (λ) is a ratio of an in-plane retardation value to a retardation value in a thickness direction of the optical film to a light of λ wavelength (unit: nm).

20. The optical film according to claim 16, which is produced by a method comprising a stretching step of stretching a film and a shrinking step of shrinking a film.

21. The optical film according to claim 16, which comprises a cellulose acylate.

22. The optical film according to claim 21,
wherein an acyl substituent substantially comprises only acetyl group, and a total degree of the substitution is 2.56 to 3.00.

23. The optical film according to claim 21, which satisfies formulae (I) and (II):
2.0≦(DS2+DS3+DS6)≦3.0 Formula (I)
DS6/(DS2+DS3+DS6)≧0.315 Formula (II)
wherein DS2 is a degree of substitution of a hydroxyl group at 2-position of a glucose unit of the cellulose acylate with an acyl group;
DS3 is a degree of substitution of a hydroxyl group at 3-position with an acyl group; and
DS6 is a degree of substitution of a hydroxyl group at 6-position with an acyl group.

24. The optical film according to claim 21,
wherein an acyl substituent comprises substantially at least two groups selected from an acetyl group, a propionyl group and a butanoyl group, and a total degree of substitution is 2.50 to 3.00.

25. A method for producing an optical film according to claim 16, which comprises:
a stretching step of stretching a film; and
a shrinking step of shrinking a film.

26. A polarizing plate, which comprises:
a polarization film; and
a pair of protective films sandwiching the polarization film,
wherein at least one of the pair of protective films is an optical film according to claim 16.

27. A liquid crystal display device, which comprises an optical film according to claim 16 or a polarizing plate comprising a polarization film; and a pair of protective films sandwiching the polarization film, wherein at least one of the pair of protective films is an optical film according to claim 16.

28. A liquid crystal display device, which comprises:
a liquid crystal cell; and
a pair of polarizing plates aligned on both sides of the liquid crystal cell,
wherein at least one of the pair of polarizing plates is a polarizing plate according to claim 26, and
the liquid crystal display device is of IPS, OCB or VA mode.

29. A liquid crystal display device, which comprises a polarizing plate according to claim 26 on a backlight side, and is of VA mode.
